(19) United States
(12) Patent Application Publication
(10) Pub. No.: US 2002/0156630 A1
(43) Pub. Date: Oct. 24, 2002

(54) Reading system and information terminal

(76) Inventors: Kazunori Hayashi, Fukuoka (JP); Masaru Mase, Fukuoka (JP)

Correspondence Address: RATNERPRESTIA, P O BOX 980, VALLEY FORGE, PA, 19482-0980, US

(21) Appl. No.: 10/087,421

(22) Filed: Mar. 1, 2002

(30) Foreign Application Priority Data
Mar. 2, 2001 (JP) 2001-57773
Mar. 2, 2001 (JP) 2001-57774

(51) Int. Cl. G10L 13/00

(52) U.S. Cl. 704/258

(57) ABSTRACT

There is provided an information terminal and a reading system that output phonetic sound in natural voice desired by users. The information terminal has a voice synthesizer for synthesizing phonetic sound with phonemic database constructed of human voice taken from a real character. A user can listen to voice of synthesized sound by inserting into the information terminal a memory device provided with voice synthesizer, the phonemic database and synthesis subject data, and replaying it, which activates voice synthesis processing in the terminal device. Or, the user is able put the information terminal in communication with a server device on the network, and select phonemic database and synthesis subject data of his/her choice, so as to listen to reading of the synthesis subject data, e.g., a novel, news release and the like, in voice of his/her favorite character.

### FIELD OF THE INVENTION

The present invention relates to portable information terminal and reading system for converting text data into audible sound.

### BACKGROUND OF THE INVENTION

As apparatuses for reading texts of e-mail and/or word processor, personal computers have hitherto been used in view of plenitude in memory capacity, high level of throughput, completeness of network facilities, and so forth.

On the other hand, however, personal computers are not convenient if one is used while walking, because of the size and weight, and they are not so easy to operate. In addition, they also have problem of poor cost to performance ratio if used only for the function of converting text data into audible sound. As a solution to these problems, Japanese Patent Laid-Open No.6-337774 discloses an IC-card type text reading device, which is easy to attach to and detach from an information processor, mountable into a small information processor (e.g. small personal computer, and the like), small and light to carry around, yet it has a reading function in itself as a single unit. This text reading device contains a RAM into which text data is transferred in advance from a personal computer and the like through an external interface. When this reading device is used singly, it reads out a text data from the RAM, puts the read text data through language-processing to obtain a phonetic symbol string, puts it through a voice synthesizer to convert into phonetic sound data, converts again the phonetic sound data into analog sound signal, and outputs it to an earphone jack. This text reading device is small, light and freely detachable since it is configured into a shape of IC-card.

Besides, it outputs general voice sound like ordinary voice of man or woman. Therefore, it does not always make the user enjoyable to listen because the sound it outputs is often not in tone the user prefers.

Japanese Patent Laid-Open No.7-140999 discloses a voice synthesizing device and a method of voice synthesis capable of generating synthetic sound close to natural human voice. In other words, the disclosed invention outputs synthesized phonetic sound substantially close to human voice in a way that it is provided beforehand with a lexicon containing information on accent command value and/or length of phonemic duration along with information on syllabaries, accent formats, and the like, and generates a parameter string of phonemic segment data using the length of phonemic duration, as well as a pitch pattern based on calculated length of phonemic duration, prosodic information and the accent command value, to synthesize a phonetic wave from the parameter string and the pitch pattern generated as above.

Moreover, Japanese Patent laid-Open No.11-143483 discloses a system which generates synthetic sound using a personal computer, word processor, game machine, special-purpose device, network computer (“NC”), set-top box (“STB”), and the like. In particular, the system enables a user to make freely a selection among a variety of synthetic sounds. That is, the disclosed system receives voice of a person and performs voice recognition, analyzes a result of the recognition, extracts phonemic string information and prosodic information to make a phonemic list, prepares phonetic lexicon (lexicon for phonetic segments) generated from voice of a certain character, and interpolatory links phonetic segments according to the extracted phonemic string to produce the phonemic list.

Although there have been devised such apparatuses, as described above, that output synthetic sound near human voices by using length of phoneme duration, prosodic information and the accent command value, they do not always impress users in a true sense and make them enjoyable when they are used as means to read literature, for instance.

### SUMMARY OF THE INVENTION

Disclosed here is a information terminal and a reading system thereof that is outstanding in portability and easy to carry even while walking without difficulties, yet it is capable of producing phonetic sound in tone desired by user. The information terminal comprises a main terminal device having a voice synthesis processor for processing voice synthesis subject data based on phonemic database containing organized phonemic data, and a memory device, detachable from the main terminal device, for storing the voice synthesis subject data and the phonemic database.

### BRIEF DESCRIPTION OF THE DRAWINGS

FIG. 1 is a configuration diagram showing a communication system including a portable information terminal according to exemplary embodiment 1 of the present invention.

FIG. 2 is a block diagram showing in detail a terminal device and a memory device according to embodiment 1.

FIG. 3 is a flowchart showing operation of the terminal device according to embodiment 1.

FIG. 4 is a configuration diagram showing a communication system including a portable information terminal according to exemplary embodiment 2 of the present invention.

FIG. 5 is a block diagram showing in detail a terminal device and a memory device according to embodiment 1.

FIG. 6 is a flowchart showing operation of the terminal device according to embodiment 1.

FIG. 7 is a configuration diagram showing a communication system including a portable information terminal according to exemplary embodiment 3 of the present invention.

FIG. 8 is a block diagram showing in detail a terminal device and a memory device according to embodiment 3.

FIG. 9 is a flowchart showing operation of the terminal device according to embodiment 3.

FIG. 10 is a configuration diagram showing a communication system including a portable information terminal according to exemplary embodiment 4 of the present invention.

FIG. 11 is a block diagram showing in detail a terminal device and a memory device according to embodiment 4.

FIG. 12 is a flowchart showing operation of the terminal device according to embodiment 4.

FIG. 13 is a configuration diagram showing a communication system including a portable information terminal according to exemplary embodiment 5 of the present invention.

FIG. 14 is a block diagram showing in detail a terminal device and a memory device according to embodiment 5.

FIG. 15 is a flowchart showing operation of the terminal device according to embodiment 5.

FIG. 16 is a configuration diagram showing a communication system including a portable information terminal according to exemplary embodiment 6 of the present invention.

FIG. 17 is a block diagram showing in detail a terminal device and a memory device according to embodiment 6.

FIG. 18 is a flowchart showing operation of the terminal device according to embodiment 6.

FIG. 19 is a configuration diagram showing a communication system including a portable information terminal according to exemplary embodiment 7 of the present invention.

FIG. 20 is a block diagram showing in detail a terminal device and a memory device according to embodiment 7.

FIG. 21 is a flowchart showing operation of the terminal device according to embodiment 7.

FIG. 22 is a configuration diagram showing a communication system including a portable information terminal according to exemplary embodiment 8 of the present invention.

FIG. 23 is a block diagram showing in detail a terminal device and a memory device according to embodiment 8.

FIG. 24 is a flowchart showing operation of the terminal device according to embodiment 8.

FIG. 25 is a configuration diagram showing a communication system including a portable information terminal according to exemplary embodiment 9 of the present invention.

FIG. 26 is a block diagram showing in detail a terminal device and a memory device according to embodiment 9.

FIG. 27 is a configuration diagram showing a communication system including a portable information terminal according to exemplary embodiment 10 of the present invention.

FIG. 28 is a block diagram showing in detail a terminal device and a memory device according to embodiment 10.

FIG. 29 is a configuration diagram showing a communication system including a portable information terminal according to exemplary embodiment 11 of the present invention.

FIG. 30 is a block diagram showing in detail a terminal device and a memory device according to embodiment 11.

FIG. 31 is a flowchart showing operation of the terminal device according to embodiment 11.

FIG. 32 is a block diagram showing in detail a terminal device and a memory device according to exemplary embodiment 12 of the present invention.

FIG. 33 is a flowchart showing a translation process in the portable information terminal according to embodiment 12.

FIG. 34 is a block diagram showing in detail a portable information terminal according to one exemplary embodiment of the present invention.

FIG. 35 is a configuration diagram showing a communication system having a portable information terminal, including a block diagram of a server device according to one exemplary embodiment of this invention.

FIG. 36 is a flowchart showing operation of a server device according to exemplary embodiment 14.

FIG. 37 is a configuration diagram showing a communication system including a portable information terminal according to one exemplary embodiment of the present invention.

FIG. 38 is a block diagram showing in detail a portable terminal device and a memory device according to one exemplary embodiment of the present invention.

FIG. 39 is a flowchart showing operation of the portable terminal device of FIG. 38 according to embodiment 5.

FIG. 40 is a block diagram of a portable information terminal according to one exemplary embodiment of the present invention.

FIG. 41 is a flowchart showing operation of the portable information terminal of FIG. 40 according to exemplary embodiment 16.

FIG. 42 is a flowchart showing operation of a terminal device according to exemplary embodiment 17.

FIG. 43 is a configuration diagram showing a communication system including a portable information terminal according to one exemplary embodiment of the present invention.

FIG. 44 is a block diagram of the portable information terminal depicted in FIG. 43.

FIG. 45 is a flowchart showing operation of a portable terminal device shown in FIG. 44.

FIG. 46 is a configuration diagram showing a communication system including a portable information terminal according to one exemplary embodiment of the present invention.

FIG. 47 is a block diagram of the portable information terminal according to the exemplary embodiment of this invention.

FIG. 48 is a flowchart showing operation of the portable terminal device according to the exemplary embodiment of this invention.

FIG. 49 is a configuration diagram showing a reading system according to one exemplary embodiment of the present invention.

FIG. 50 is a block diagram showing in detail a portable information terminal and a server device according to the exemplary embodiment of this invention.

FIG. 51 is a flowchart showing operation of the reading system according to the exemplary embodiment of this invention.

FIG. 52 is a configuration diagram showing a reading system according to one exemplary embodiment of the present invention.

FIG. 53 is a block diagram showing in detail a portable information terminal and a server device according to the exemplary embodiment of this invention.

FIG. 54 is a flowchart showing operation of the reading system according to the exemplary embodiment of this invention.

FIG. 55 is a configuration diagram showing a reading system according to one exemplary embodiment of the present invention.

FIG. 56 is a block diagram showing in detail a portable information terminal and a server device according to the exemplary embodiment of this invention.

FIG. 57 is a flowchart showing operation of the reading system according to the exemplary embodiment of this invention.

FIG. 58 is a configuration diagram showing a reading system according to one exemplary embodiment of the present invention.

FIG. 59 is a block diagram showing in detail a portable information terminal and a server device according to the exemplary embodiment of this invention.

FIG. 60 is a configuration diagram showing a reading system according to one exemplary embodiment of the present invention.

FIG. 61 is a block diagram showing in detail a portable information terminal and a server device according to the exemplary embodiment of this invention.

FIG. 62 is a flowchart showing operation of the reading system according to the exemplary embodiment of this invention.

FIG. 63 is a configuration diagram showing a reading system according to one exemplary embodiment of the present invention.

FIG. 64 is a block diagram showing in detail a portable information terminal and a server device according to the exemplary embodiment of this invention.

FIG. 65 is a flowchart showing operation of the reading system according to the exemplary embodiment of this invention.

FIG. 66 is a configuration diagram showing a reading system according to one exemplary embodiment of the present invention.

FIG. 67 is a block diagram showing in detail a portable information terminal and a server device according to the exemplary embodiment of this invention.

FIG. 68 is a flowchart showing operation of the reading system according to the exemplary embodiment of this invention.

FIG. 69 is a general expository diagram of a reading system according to one exemplary embodiment of the present invention.

FIG. 70 is a block diagram showing in detail a portable information terminal and a server device according to the exemplary embodiment of this invention.

FIG. 71 is a flowchart showing operation of the reading system according to the exemplary embodiment of this invention.

FIG. 72 is a general expository diagram of a reading system according to one exemplary embodiment of the present invention.

FIG. 73 is a block diagram showing in detail a portable information terminal and a server device according to the exemplary embodiment of this invention.

FIG. 74 is a flowchart showing operation of the reading system according to the exemplary embodiment of this invention.

### DETAILED DESCRIPTION OF THE PREFERRED EMBODIMENTS

### Exemplary Embodiment 1

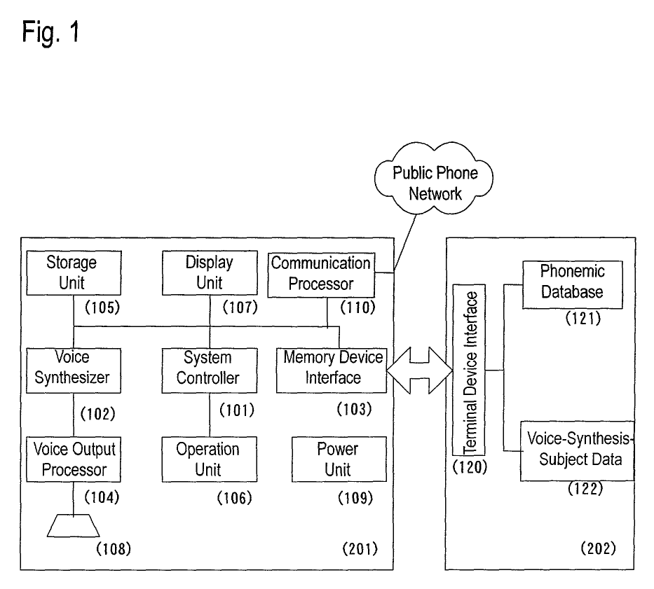

FIG. 1 is a configuration diagram showing a communication system having a portable information terminal according to exemplary embodiment 1 of this invention. In embodiment 1 and the subsequent exemplary embodiments, portable information terminal an apparatus comprising a terminal device and a memory device.

In FIG. 1, terminal device 201 is provided with a display unit, an operation unit, a voice output unit such as a headphone speaker, and the like. Memory device 202 such as a memory card stores voice synthesis subject data 203 like text data and phonemic data 204. Memory device 202 is detachable from terminal device 201. Server device 205 on the Internet provides voice synthesis subject data 203, phonemic data 204, and voice synthesizing program 206. Although shown here is only one server device, there may be cases that the voice synthesis subject data and the phonemic data are provided separately by a plurality of server devices. A user can listen to synthetic voice in voice of his/her favorite character by inserting memory device 202, which stores phonemic data for voice of unique characters and voice synthesis subject data to be read, into terminal device 201 and activating it.

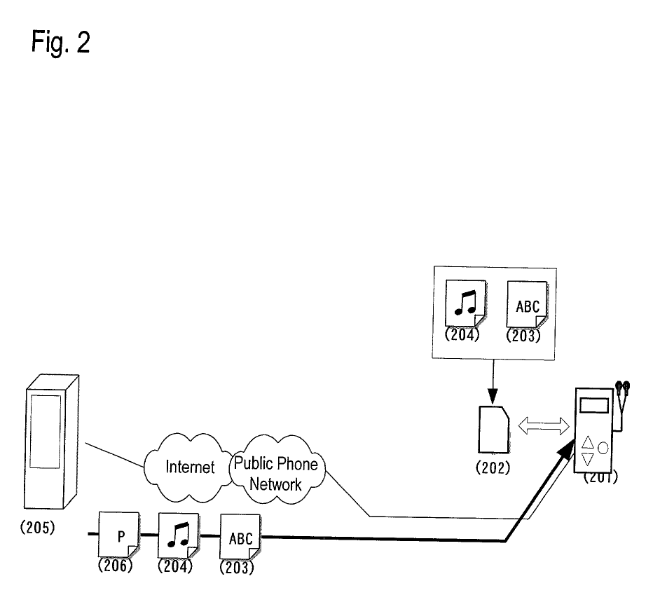

FIG. 2 is a block diagram showing in detail terminal device 201 and memory device 202 of FIG. 1. In FIG. 2, system controller 101 exchanges data with individual processors within device 201, and controls the entire device. Voice synthesizer 102 analyzes the voice synthesis subject data, extracts and links the most appropriate phonemic data to each of the subject data, and converts the data so that it can be passed on to voice output processor 104, which will be described later. Memory device interface (I/F) 103 receives a command from system controller 101, and reads/writes data from/to memory device 202. Voice output processor 104 receives the data from voice synthesizer 102, converts a format of the data, and outputs it to speaker or headphone 108. Storage unit 105 stores a program for controlling terminal device 201, and it is also used as a work space for processing the data.

The user gives his/her command to terminal device 201 through operation unit 106. Display unit 107 displays an operating status and the like of terminal device 201 for the user. Power unit 109 supplies electric power to devices 201 and 202. Communication processor 110 makes connection to a public telephone network, and exchanges data over the Internet. Terminal device interface (I/F) 120 exchanges data with terminal device 201 through memory device interface 103. Phonemic database 121 stores the phonemic data. Voice synthesis subject data memory 122 stores voice synthesis subject data.

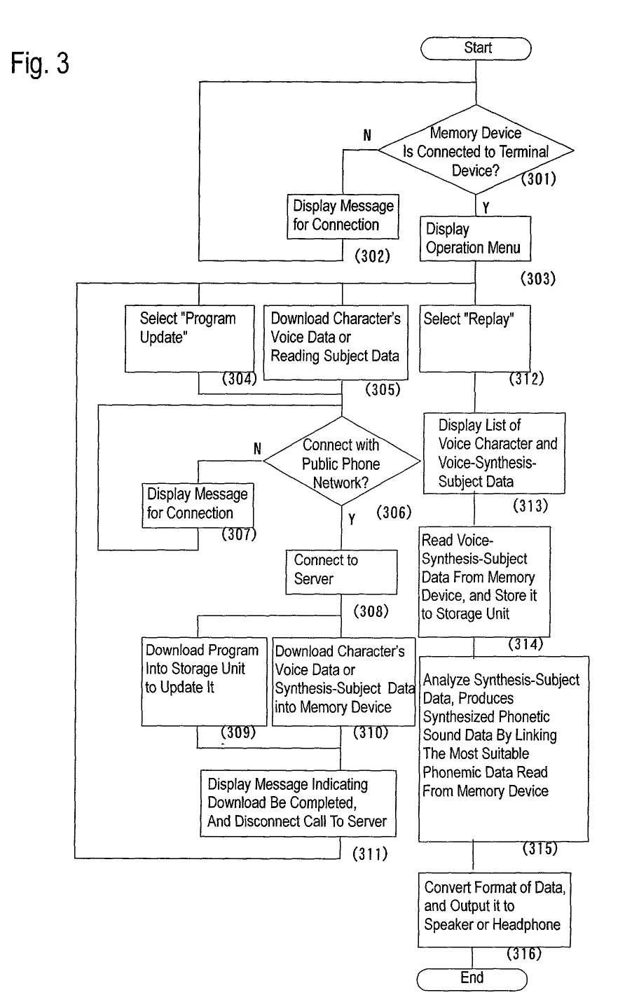

The portable information terminal constructed as above operates in a manner, which will be described hereinafter with reference to FIG. 3. FIG. 3 is a flowchart showing operation of terminal device 201 of FIG. 2.

When the user turns on a power supply to terminal device 201 with operation unit 106, system controller 101 sends a command to memory device interface 103 to verify whether memory device 202 is in connection with terminal device 201 (S1). If not connected, it retrieves a font data from storage unit 105, and displays in display unit 107 a message such as “insert a memory card” to urge the user to connect memory device 202 to terminal device 201 (S2). If memory device 202 is in connection, system controller 101 displays in display unit 107 another message such as “operation menu 1. replay, 2. program update, 3. download reading subject data, 4. download character's voice data, and so on” (S3). When the user makes a selection for program update (S4), system controller 101 verifies whether terminal device 201 is in connection with public telephone network through communication processor 110 (S6). If terminal device 201 is not in connection, system controller 101 displays in display unit 107 a message such as “connect to the network” to urge a connection (S7). If it is in connection, system controller 101 accesses server device 205 (refer to FIG. 1) on the Internet through communication processor 110 (S8).

When the access is completed, system controller 101 of terminal device 201 requests server device 205 to download the latest voice synthesizing program. When the voice synthesizing program is transferred from server device 205, system controller 101 stores and updates the voice synthesizing program in storage unit 105 (S9), displays a message indicating that the download is completed, and disconnects the call to server device 205 (S11).

When any of reading subject data (voice synthesis subject data) and character's voice data (phonemic data) is selected for downloading (S5), the same steps as the aforesaid program update are taken from access to server device 205 to downloading of the data. However, system controller 101 stores the downloaded data into memory device 202 via memory device interface 103 and terminal device interface 120 in the memory device 202 during the step of downloading the reading subject data or the character's voice data (S10). It then displays a message indicating that the download is completed, and disconnects the call to server device 205 (S11).

When the user selects a replay function through operation unit 106 (S12), system controller 101 displays a list of reading subject data and character's voice data in display unit 107 (S13), allowing the user to make selection for a reading subject data and voice data of any character. When the user completes a selection, system controller 101 gives memory device interface 103 a command to read the appropriate voice synthesis subject data stored in memory device 202. Memory device interface 103 then reads the voice synthesis subject data through communication with terminal device interface 120 within memory device 202, and registers it in storage unit 105 provided in terminal device 201 (S14). Next, system controller 101 gives voice synthesizer 102 another command for a start of processing. Voice synthesizer 102 analyzes the voice synthesis subject data while reading it out successively from storage unit 105, produces synthesized phonetic sound data by linking it to the most suitable phonemic data read from memory device 202 (S15), and passes on the synthesized phonetic sound data to voice output processor 104 after converting it into data of a processable format by voice output processor 104. Voice synthesizer 102 repeats the above processes until the user pushes a stop button on operation unit 106, and system controller 101 issues a command to discontinue the processing. Voice output processor 104 converts format of the data received from voice synthesizer 102, and outputs it to speaker or headphone 108 (S16).

According to this exemplary embodiment as described above, terminal device 201 comprises system controller 101 for controlling the entire device, voice synthesizer 102 for voice-synthesizing the voice synthesis subject data with the phonemic data according to the voice synthesizing program, storage unit 105 for storing voice synthesizing program, memory device interface 103 for exchanging data between memory device 202, and communication processor 110 for connection to public telephone network. Memory device 202 comprises phonemic database 121 for storing phonemic data, voice synthesis subject data 122 for storing voice synthesis subject data, and terminal device interface 120 for exchanging the data between the terminal device. Accordingly, the user is able to listen to reading of text data and the like in voice of his/her favorite character.

### Exemplary Embodiment 2

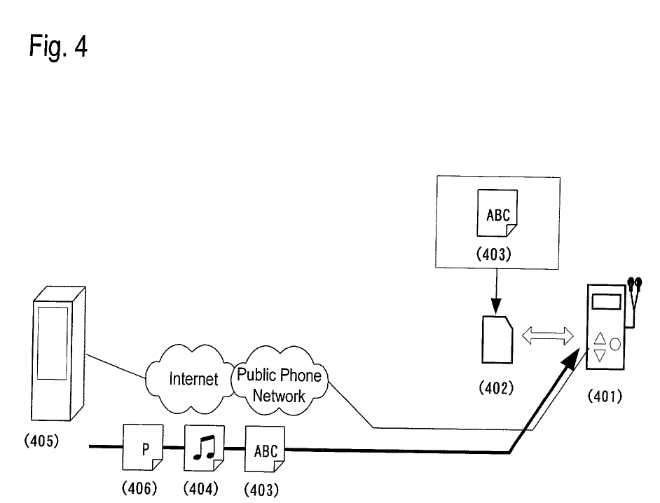

FIG. 4 is a configuration diagram showing a communication system including a portable information terminal of this exemplary embodiment. In FIG. 4, terminal device 401 is provided with a display unit, an operation unit, a voice output unit such as a headphone speaker, and the like. Memory device 402 such as a memory card stores voice synthesis subject data 403 like text data and the like. Memory device 402 is detachable from terminal device 401. Server device 405 on the Internet provides voice synthesis subject data 403, phonemic data 404, and voice synthesizing program 406.

In FIG. 4, phonemic data for voice of unique characters is stored in a storage unit within terminal device 401. A user can download phonemic data for voice of his/her favorite character from server device 405 on the Internet and store it in the storage unit within terminal device 401. He/she can also download the latest version of voice synthesizing program, and update the program stored in the storage unit. The user can listen to synthetic voice in voice of his/her favorite character by inserting memory device 402, which stores voice synthesis subject data to be read, into terminal device 401 and activating it.

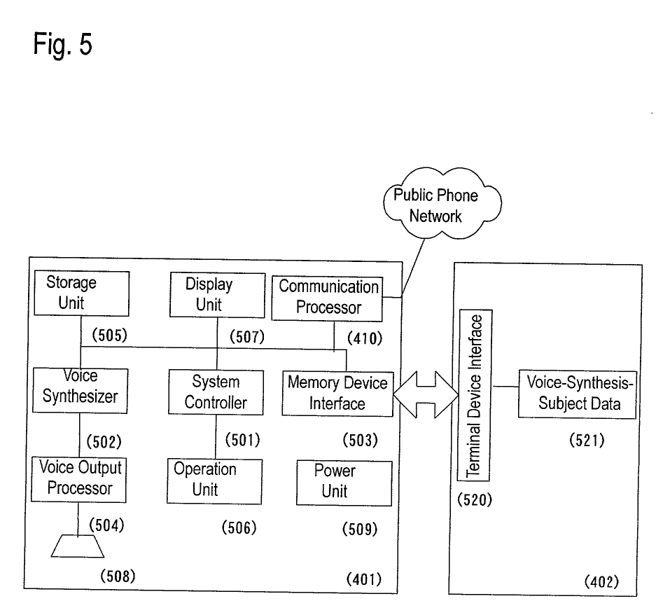

FIG. 5 is a block diagram showing in detail terminal device 401 and memory device 402 of FIG. 4. In FIG. 5, system controller 501 through communication processor 510, terminal device interface 520 and voice synthesis subject data 521 are analogous to system controller 101 through communication processor 110, terminal device interface 120 and voice synthesis subject data 122 of FIG. 2, and their details will therefore be skipped.

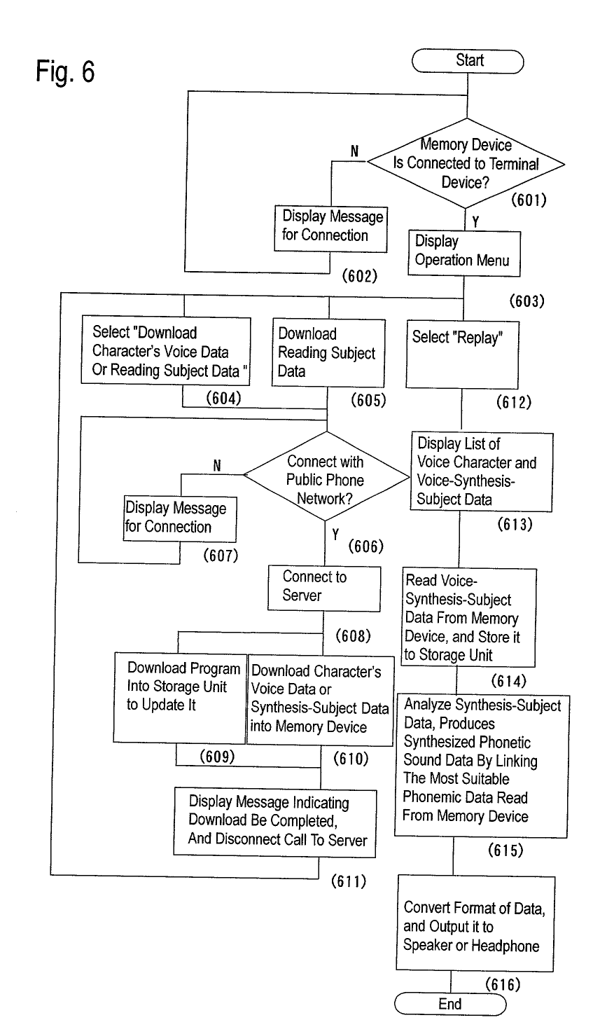

The portable information terminal constructed as above operates in a manner, which will be described hereinafter with reference to FIG. 6. FIG. 6 is a flowchart showing operation of terminal device 401 depicted in FIG. 5.

When the user turns on a power supply to terminal device 401 with operation unit 506, system controller 501 sends a command to memory device interface 503 to verify whether or not memory device 402 is in connection with terminal device 401 (S21). If not connected, system controller 501 retrieves a font data from storage unit 505, and displays in display unit 507 a message such as “insert a memory card” to urge the user to connect memory device 402 to terminal device 401 (S22). If memory device 402 is connected, system controller 501 displays in display unit 507 another message such as “operation menu 1. replay, 2. program update, 3. download reading subject data, 4. download character's voice data, and so on” (S23). When the user makes a selection for any of program update and download of character's voice data (S24), system controller 501 verifies whether terminal device 401 is in connection with public telephone network through communication processor 510 (S26). If it is not connected, system controller 501 displays in display unit 507 a message such as “connect to the network” or the like to urge connection (S27). If it is in connection, system controller 501 accesses server device 405 (refer to FIG. 4) on the Internet through communication processor 510 (S28).

When the access is completed, system controller 501 of terminal device 401 requests server device 405 to download the latest voice synthesizing program or the character's voice data (i.e. appropriate phonemic data). When the voice synthesizing program is transferred from server device 405, system controller 501 stores the voice synthesizing program in storage unit 505 and updates the program (S29). The same step is also taken when the phonemic data is transferred, to store it in storage unit 505 (S29). System controller 501 then displays a message indicating that the download is completed, and disconnects the call to server device 405 (S31).

When reading subject data (i.e. voice synthesis subject data) is selected for downloading (S25), the same steps are taken from getting access to server device 405 and downloading of the data as in the aforesaid case of program update or downloading of the character's voice data. However, system controller 501 stores the downloaded data in memory device 402 via memory device interface 503 and terminal device interface 520 in the memory device 402 during the step of downloading the reading subject data (S30). It then displays a message indicating that the download is completed, and disconnects the call to server device 405 (S31).

When the user selects a replay function through operation unit 506 (S32), system controller 501 displays a list of reading subject data and character's voice data in display unit 507 (S33), allowing the user to make selection of any of the reading subject data and voice data of any character. When the user completes a selection, system controller 501 gives memory device interface 503 a command to read the voice synthesis subject data selected by the user, stored in memory device 402. Memory device interface 503 then reads the voice synthesis subject data through communication with terminal device interface 520 provided within memory device 402, and registers it in storage unit 505 in terminal device 401 (S34).

Next, system controller 501 gives voice synthesizer 502 another command for a start of processing. Voice synthesizer 502 analyzes the voice synthesis subject data while reading it out successively from storage unit 505, produces synthesized phonetic sound data by linking it to the most suitable phonemic data read from storage unit 505 (S35), and passes on the synthesized phonetic sound data to voice output processor 504 after converting it into data of a processable format by voice output processor 504. Voice synthesizer 502 repeats the above processes until the user pushes a stop button on operation unit 506, and system controller 501 issues a command to discontinue the processing. Voice output processor 504 converts a format of the data received from voice synthesizer 502, and outputs it to speaker or headphone 508 (S36).

According to the present exemplary embodiment as described above, terminal device 401 comprises system controller 501 for controlling the entire device, voice synthesizer 502 for voice-synthesizing the voice synthesis subject data with the phonemic data according to the voice synthesizing program, storage unit 505 for storing the voice synthesizing program and the phonemic data, memory device interface 503 for exchanging data between memory device 402, and communication processor 510 for connecting to public telephone network. Memory device 402 comprises voice synthesis subject data 521 for storing voice synthesis subject data, and terminal device interface 520 for exchanging data between the terminal device. Accordingly, the user is able to listen to reading of text data and the like in voice of his/her favorite character.

### Exemplary Embodiment 3

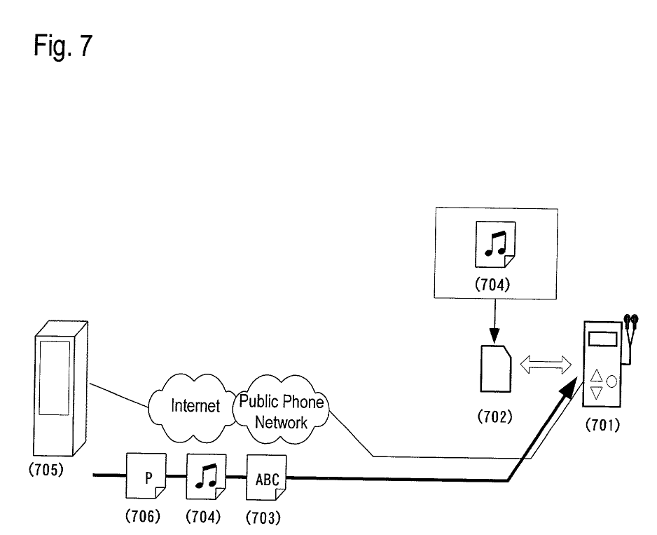

FIG. 7 is a configuration diagram showing a communication system having a portable information terminal of the present exemplary embodiment. In FIG. 7, terminal device 701 is provided with a display unit, an operation unit, a voice output unit such as a headphone speaker, and the like. Memory device 702 such as a memory card stores phonemic data 704 for voice of unique characters. Memory device 702 is detachable from terminal device 701. A reference numeral 705 represents a server device on the Internet for providing voice synthesis subject data 703, i.e. a subject data to be read, phonemic data 704, and voice synthesizing program 706.

In FIG. 7, the voice synthesis subject data defining reading subject data is stored in a storage unit within terminal device 701. A user can download the voice synthesis subject data of his/her choice from server device 705 on the Internet and store it in the storage unit within terminal device 701. He/she can also download the latest version of voice synthesizing program, and update the program stored in the storage unit. The user can listen to synthetic voice in voice of his/her favorite character by inserting memory device 702, which stores phonemic data for voice of the character, into terminal device 701 and activating it.

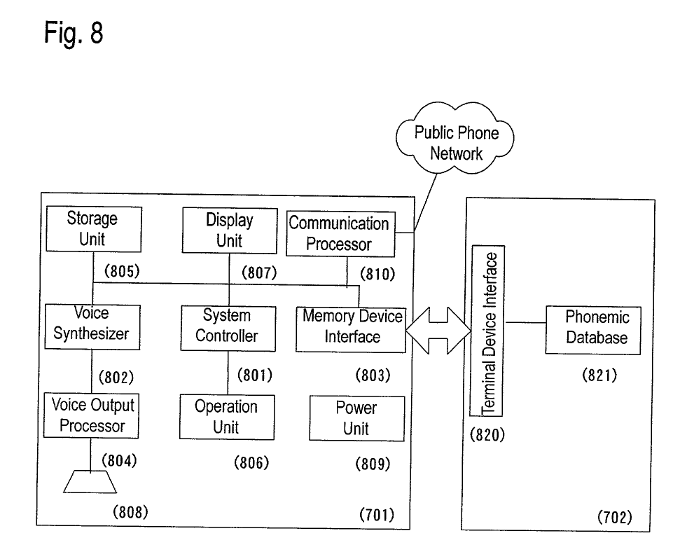

FIG. 8 is a block diagram showing in detail terminal device 701 and memory device 702 of FIG. 7. In FIG. 8, system controller 801 through communication processor 810, terminal device interface 820 and phonemic database 821 are analogous to system controller 101 through communication processor 110, terminal device interface 120 and phonemic database 121 of FIG. 2, and their details will therefore be skipped.

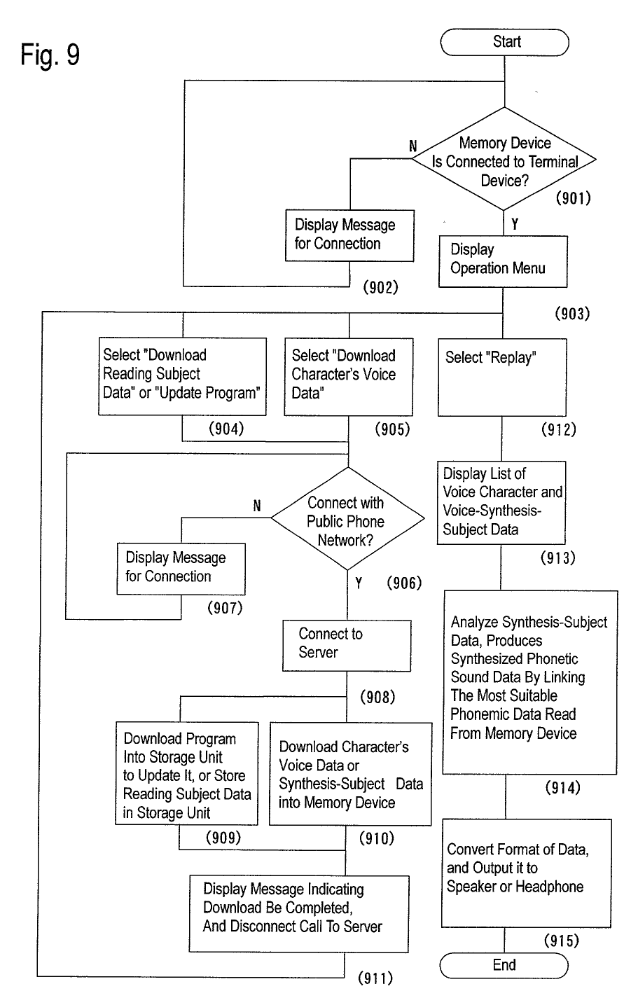

The portable information terminal constructed as above operates in a manner, which will be described hereinafter with reference to FIG. 9. FIG. 9 is a flowchart showing operation of terminal device 701 depicted in FIG. 8.

When the user turns on a power supply to terminal device 701 with operation unit 806, system controller 801 sends a command to memory device interface 803 to verify whether memory device 702 is in connection with terminal device 701 (S41). If it is not connected, system controller 801 retrieves a font data from storage unit 805, and displays in display unit 807 a message such as “insert a memory card” and the like to urge the user to connect memory device 702 to terminal device 701 (S42). If memory device 702 is connected, system controller 801 displays in display unit 807 another message such as “operation menu 1. replay, 2. program update, 3. download reading subject data, 4. download character's voice data, and so on” (S43). When the user makes a selection for program update or downloading of the reading subject data (S44), system controller 801 verifies whether terminal device 701 is in connection with public telephone network through communication processor 810 (S46). If terminal device 701 is not in connection, system controller 801 displays in display unit 807 a message such as “connect to the network” to urge connection (S47). If it is in connection, system controller 801 accesses server device 705 (refer to FIG. 7) on the Internet through communication processor 810 (S38).

When the access is completed, system controller 801 in terminal device 701 requests server device 705 to download any of the latest voice synthesizing program and the reading subject data (i.e. appropriate voice synthesis subject data). When the voice synthesizing program is forwarded from server device 705, system controller 801 stores the voice synthesizing program in storage unit 805 and updates the program (S49). The same step is also taken when the voice synthesis subject data is forwarded, to store it in storage unit 805 (S49). System controller 801 then displays a message indicating that the download is completed, and it disconnects the call to server device 705 (S51).

When selection is made for downloading of character's voice data (i.e. appropriate phonemic data) (S45), the same steps are taken also from getting access to server device 705, to downloading of the data as in the aforesaid case of program update or downloading of the reading subject data. However, during the step of downloading the character's voice data, system controller 801 stores the downloaded data in memory device 702 via memory device interface 803 and terminal device interface 820 within the memory device 702 (S50). It then displays a message indicating that the download is completed, and disconnects the call to server device 705 (S51).

When the user selects a replay function through operation unit 806 (S52), system controller 801 displays a list of the reading subject data and the character's voice data in display unit 807 (S53), allowing the user to make selection of a reading subject data and voice data of any character. When the user made his/her selection, system controller 801 gives voice synthesizer 802 a command for a start of processing. Voice synthesizer 802 analyzes the voice synthesis subject data while reading it out successively from storage unit 805, produces synthesized phonetic sound data by linking it to the most suitable phonemic data read from memory device 702 (S54), and passes on the synthesized phonetic sound data to voice output processor 804 after converting it into data of a processable format by voice output processor 804. Voice synthesizer 802 repeats the above processes until the user pushes a stop button on operation unit 806, and system controller 801 issues a command to discontinue the processing. Voice output processor 804 converts the format of the data received from voice synthesizer 802, and outputs it to speaker or headphone 508 (S55).

According to this exemplary embodiment as described above, terminal device 701 comprises system controller 801 for controlling the entire device, voice synthesizer 802 for voice-synthesizing the voice synthesis subject data with the phonemic data according to the voice synthesizing program, storage unit 805 for storing the voice synthesizing program and the voice synthesis subject data, memory device interface 803 for exchanging data between memory device 702, and communication processor 810 for connecting to public telephone network. Memory device 702 comprises phonemic database 821 for storing phonemic data, and terminal device interface 820 for exchanging data between the terminal device 701. Accordingly, the user is able to listen to reading of text data and the like in voice of his/her favorite character.

### Exemplary Embodiment 4

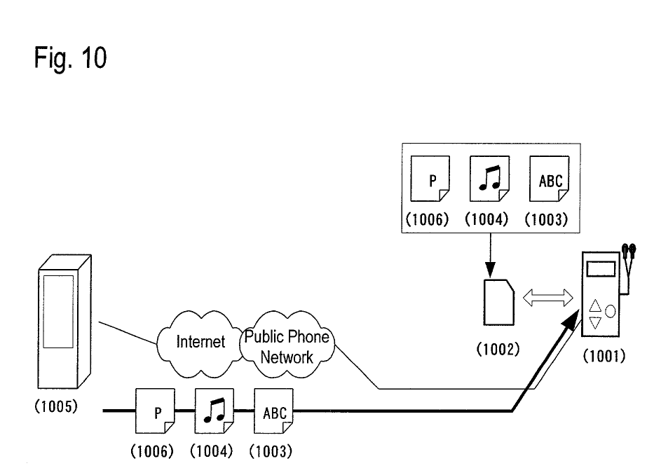

FIG. 10 is a configuration diagram showing a communication system having a portable information terminal according to the present exemplary embodiment. In FIG. 10, terminal device 1001 is provided with a display unit, an operation unit, a voice output unit such as a headphone speaker, and the like. Memory device 1002 such as a memory card stores voice synthesis subject data 1003, i.e. a subject data to be read, phonemic data 1004 for voce of unique characters, and voice synthesizing program 1006. Memory device 1002 is detachable from terminal device 1001. Server device 1005 on the Internet provides voice synthesis subject data 1003 defining the subject to be read, phonemic data 1004, and voice synthesizing program 1006.

In FIG. 10, a user can listen to reading of a text in voice of his/her favorite character by inserting memory device 1002, which stores the voice synthesizing program, the voice synthesis subject data to be read, and the phonemic data of character's voice, into terminal device 1001 and by activating it.

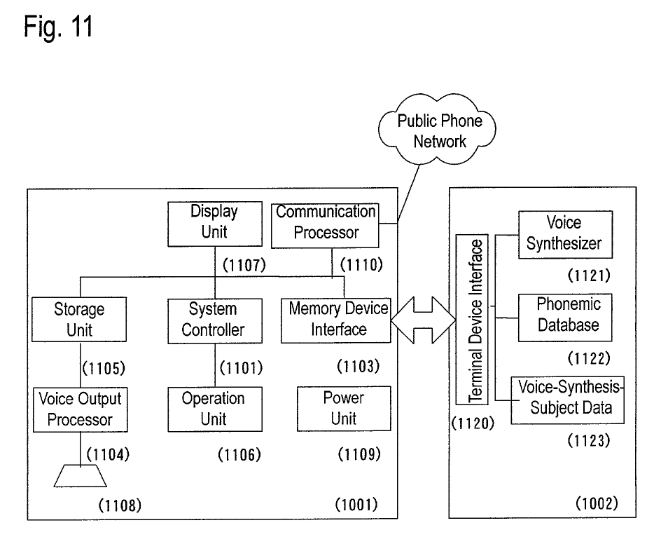

FIG. 11 is a block diagram showing in detail terminal device 1001 and memory device 1002 of FIG. 10. In FIG. 11, system controller 1101, memory device interface 1103, voice output processor 1104 through communication processor 1110, terminal device interface 1120, phonemic database 1122 and voice synthesis subject data memory 1123 are analogous to system controller 101, memory device interface 103, voice output processor 104 through communication processor 110, terminal device interface 120, phonemic database 121 and voice synthesis subject data memory 122 of FIG. 2, and their details will therefore be skipped. Reference numeral 1121 represents a voice synthesizer, which stores the voice synthesizing program.

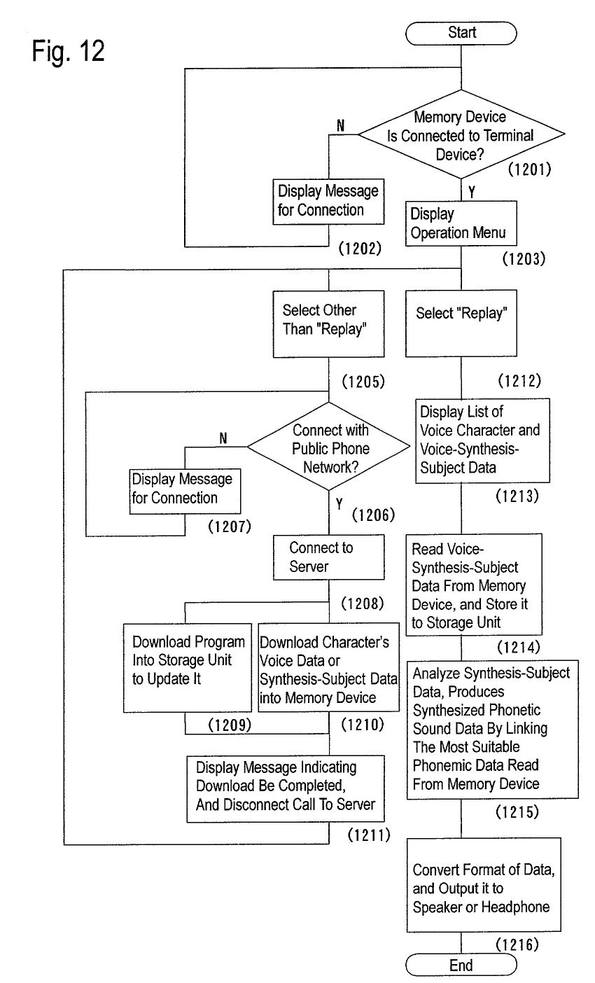

The portable information terminal constructed as above operates in a manner, which will be described hereinafter with reference to FIG. 12. FIG. 12 is a flowchart showing operation of terminal device 1001.

When the user turns on a power supply to terminal device 1001 with operation unit 1106, system controller 1101 sends a command to memory device interface 1103 to verify whether memory device 1002 is in connection to terminal device 1001 (S61). If not connected, system controller 1101 retrieves a font data from storage unit 1105, and displays in display unit 1107 a message such as “insert a memory card” to urge the user to connect memory device 1002 to terminal device 1001 (S62). If memory device 1002 is in connection, system controller 1101 displays in display unit 1107 another message such as “operation menu 1. replay, 2. program update, 3. download reading subject data, 4. download character's voice data, and so on” (S63). When the user makes a selection of any function other than replay (S65), system controller 1101 verifies whether or not terminal device 1001 is in connection with public telephone network through communication processor 1110 (S66). If not connected, system controller 1101 displays in display unit 1107 a message such as “connect to the network” to urge connection (S67). If it is connected, system controller 1101 accesses server device 1005 (refer to FIG. 10) on the Internet through communication processor 1110 (S68).

When the access is completed, system controller 1101 in terminal device 1001 requests server device 1005 to download any the latest voice synthesizing program, the character's voice data (i.e. appropriate phonemic data), and reading subject data (i.e. voice synthesis subject data) according to the selection made by the user. When the voice synthesizing program is transferred from server device 1005, system controller 1101 stores the voice synthesizing program in storage unit 1105, and updates it (S69). The same steps are also taken, when the phonemic data or the reading subject data is transferred, to store it in storage unit 1105 (S70). System controller 1101 then displays a message indicating that the download is completed, and it disconnects the call to server device 1005 (S71).

When the user selects a replay function through operation unit 1106 (S72), system controller 1101 displays a list of reading subject data and character's voice data in display unit 1107 (S73), allowing the user to make selection of any of the reading subject data and the voice data of any character. When the user made a selection, system controller 1101 gives memory device interface 1103 a command to read from memory device 1002 the voice synthesizing program and the voice synthesis subject data selected by the user. Memory device interface 1103 then reads the voice synthesizing program and the voice synthesis subject data through communication with terminal device interface 1120 in memory device 1002, and registers them in storage unit 1105 provided in terminal device 1001 (S74).

Next, system controller 1101 gives voice synthesizer 1102 another command for a start of processing. Voice synthesizer 1102 analyzes the voice synthesis subject data while reading it out successively from storage unit 1105, produces synthesized phonetic sound data by linking it to the most suitable phonemic data read from memory device 1002 (S75), and passes the synthesized phonetic sound data on to voice output processor 1104 after converting it into data of a format processable by voice output processor 1104. Voice synthesizer 1102 repeats the above processes until the user pushes a stop button on operation unit 1106 to let system controller 1101 issue a command to discontinue the processing. Voice output processor 1104 converts a format of the data received from voice synthesizer 1102, and outputs it to speaker or headphone 1108 (S76).

According to this exemplary embodiment as described above, terminal device 1001 comprises system controller 1101 for controlling the entire device, storage unit 1105 for storing the voice synthesizing program, memory device interface 1103 for exchanging data between memory device 1002, and communication processor 1110 for connecting to public telephone network. Memory device 1002 comprises voice synthesizer 1121 for storing voice synthesizing program beside for voice-synthesizing the voice synthesis subject data with the phonemic data according to the voice synthesizing program, phonemic database 1122 for storing the phonemic data, voice synthesis subject data 1123 for storing the voice synthesis subject data, and terminal device interface 1120 for exchanging data between terminal device 1001. Accordingly, the user is able to listen to reading of text data and the like in voice of his/her favorite character.

### Exemplary Embodiment 5

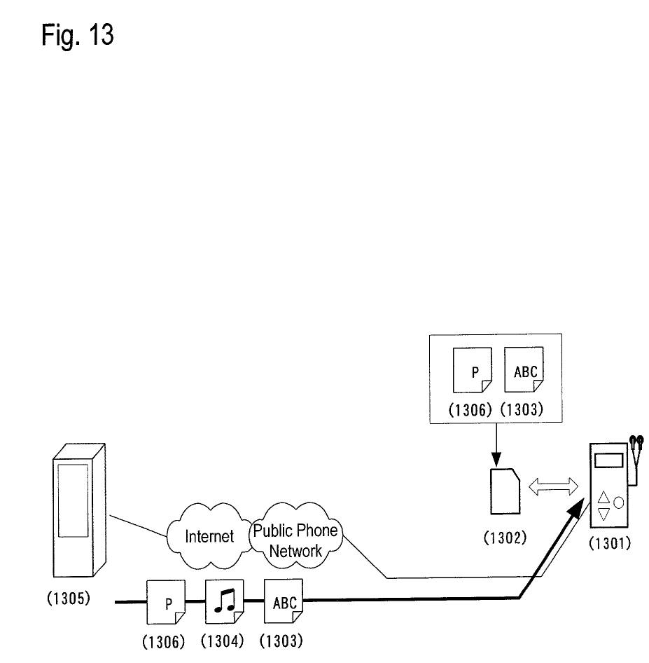

FIG. 13 is a configuration diagram showing a communication system having a portable information terminal according to the present exemplary embodiment. In FIG. 13, terminal device 1301 is provided with a display unit, an operation unit, a voice output unit such as a headphone speaker, and the like. Memory device 1302 such as a memory card stores voice synthesis subject data 1303, which is a subject data to be read, and voice synthesizing program 1306. Memory device 1302 is detachable from terminal device 1301. Server device 1305 on the Internet provides voice synthesis subject data 1303 defining the subject data to be read, phonemic data 1304, and voice synthesizing program 1306.

In FIG. 13, phonemic data for voice of unique characters is stored in a storage unit within terminal device 1301. A user can download phonemic data for voice of his/her favorite character from server device 1305 on the Internet and store it in the storage unit within terminal device 1301. He/she can also download the latest version of voice synthesizing program 1306, and update the program stored in memory device 1302. The user can listen to synthetic voice in voice of his/her favorite character by inserting memory device 1302, which stores the voice synthesis subject data to be read, into terminal device 1301 and by activating it.

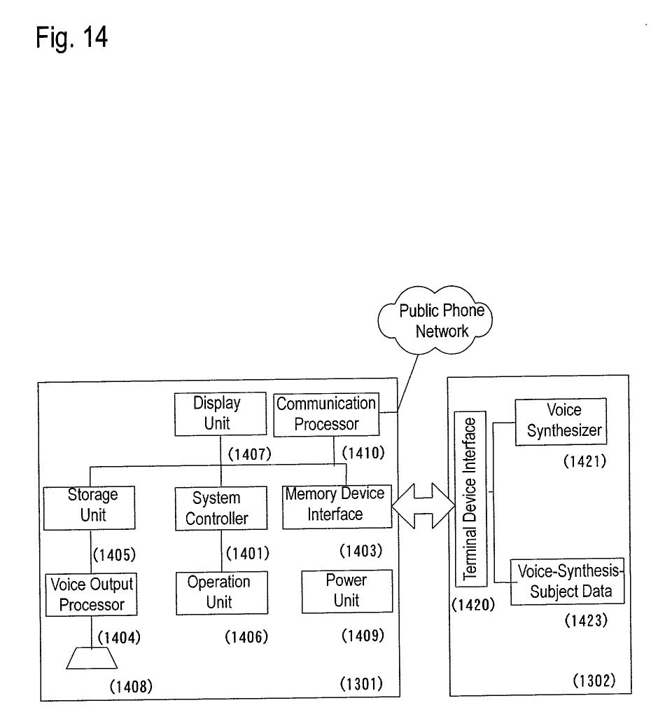

FIG. 14 is a block diagram showing in detail terminal device 1301 and memory device 1302 of FIG. 13. In FIG. 14, system controller 1401, memory device interface 1403, voice output processor 1404 through communication processor 1410, terminal device interface 1420 and voice synthesis subject data 1423 are analogous to system controller 101, memory device interface 103, voice output processor 104 through communication processor 110, terminal device interface 120 and voice synthesis subject data 122 of FIG. 2, and their details will therefore be skipped. Reference numeral 1421 represents a voice synthesizer, which stores the voice synthesizing program.

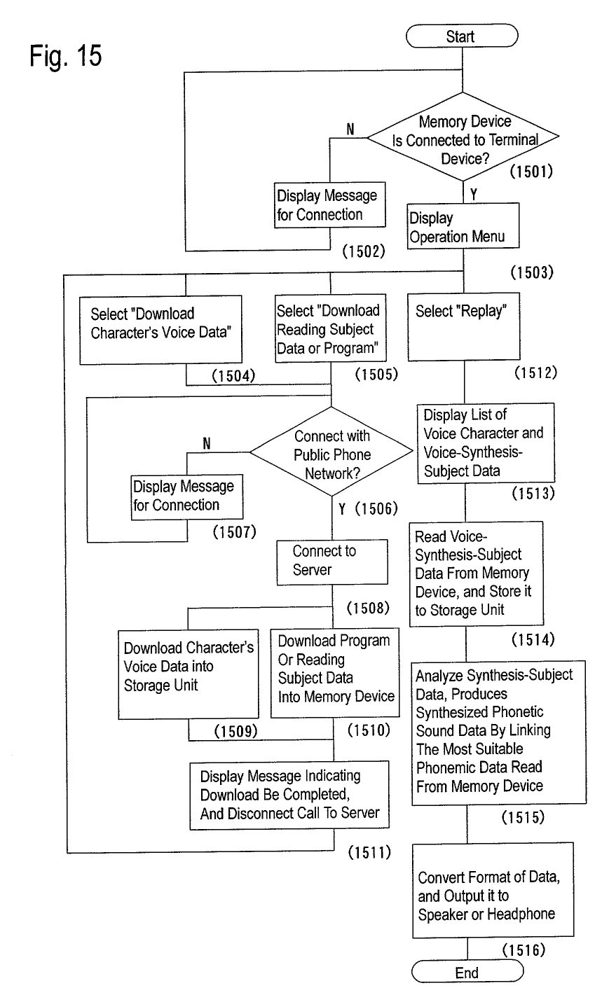

The portable information terminal constructed as above operates in a manner, which will be described hereinafter with reference to FIG. 15. FIG. 15 is a flowchart showing operation of terminal device 1301.

When the user turns on a power supply to terminal device 1301 with operation unit 1406, system controller 1401 sends a command to memory device interface 1403 to verify whether memory device 1302 is in connection with terminal device 1301 (S81). If it is not connected, system controller 1401 retrieves a font data from storage unit 1405, and displays in display unit 1407 a message such as “insert a memory card” to urge the user to connect memory device 1302 to terminal device 1301 (S82). If memory device 1302 is in connection, system controller 1401 displays in display unit 1407 another message such as “operation menu 1. replay, 2. program update, 3. download reading subject data, 4. download character's voice data, and so on” (S83). When the user selects downloading of the character's voice data (S84), system controller 1401 verifies whether terminal device 1301 is in connection to public telephone network through communication processor 1410 (S86). If terminal device 1301 is not connected, system controller 1401 displays in display unit 1407 a message such as “connect to the network” to urge connection (S87). If it is connected, system controller 1401 accesses server device 1305 (refer to FIG. 13) on the Internet through communication processor 1410 (S88).

When the access is completed, system controller 1401 of terminal device 1301 requests server device 1305 to download the character's voice data (i.e. appropriate phonemic data). When the character's voice data is transferred from server device 1305, system controller 1401 stores the character's voice data in storage unit 1405 (S89). System controller 1401 then displays a message indicating that the download is completed, and disconnects the call to server device 1305 (S91).

The same steps are also taken, when selection is made for program update or download of the reading subject data (i.e. voice synthesis subject data) (S85), from getting access to server device 1305 to downloading of the data, as in the aforesaid case of downloading the character's voice data. In this case, however, system controller 1401 stores the downloaded data in memory device 1302 via memory device interface 1403 and terminal device interface 1420 in the memory device 1302 (S90). It then displays a message indicating that the download is completed, and disconnects the call to server device 1305 (S91).

When the user selects a replay function through operation unit 1406 (S92), system controller 1401 displays a list of the reading subject data and the character's voice data in display unit 1407 (S93), allowing the user to make selection of any of the reading subject data and the voice data of any character. When the user made a selection, system controller 1401 gives memory device interface 1403 a command to read from memory device 1302 the voice synthesis subject data selected by the user. Memory device interface 1403 then reads the voice synthesis subject data through communication with terminal device interface 1420 in memory device 1302, and registers it in storage unit 1405 provided in terminal device 1301 (S94). Next, system controller 1401 gives voice synthesizer 1402 another command for a start of processing. Voice synthesizer 1402 analyzes the voice synthesis subject data while reading it out successively from storage unit 1405, produces synthesized phonetic sound data by linking it to the most suitable phonemic data read from storage unit 1405 (S95), and passes on the synthesized phonetic sound data to voice output processor 1404 after converting it into data of a format processable by voice output processor 1404. Voice synthesizer 1402 repeats the above processes until the user pushes a stop button on operation unit 1406 to let system controller 1401 issue a command to discontinue the processing. Voice output processor 1404 converts a format of the data received from voice synthesizer 1402, and outputs it to speaker or headphone 1408 (S96).

According to this exemplary embodiment as described above, terminal device 1301 comprises system controller 1401 for controlling the entire device, storage unit 1405 for storing the voice synthesizing program and the phonemic data, memory device interface 1403 for exchanging data between memory device 1302, and communication processor 1410 for connecting to public telephone network. Memory device 1302 comprises voice synthesizer 1421 for storing voice synthesizing program and for voice-synthesizing the voice synthesis subject data with the phonemic data according to the voice synthesizing program, voice synthesis subject data 1423 for storing the voice synthesis subject data, and terminal device interface 1420 for exchanging data between terminal device 1301. Accordingly, the user is able to listen to reading of text data and the like in voice of his/her favorite character.

### Exemplary Embodiment 6

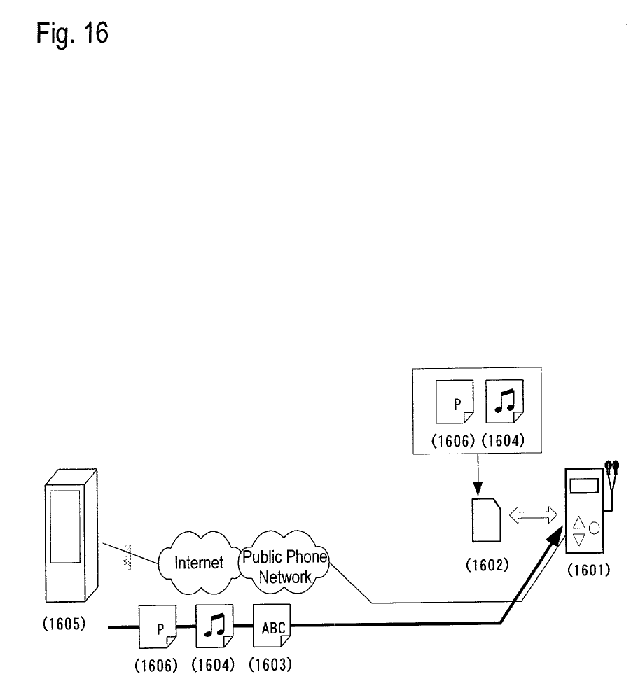

FIG. 16 is a configuration diagram showing a communication system having a portable information terminal according to the present exemplary embodiment. In FIG. 16, terminal device 1601 is provided with a display unit, an operation unit, a voice output unit such as a headphone speaker, and the like. Memory device 1602 such as a memory card stores phonemic data 1604 and voice synthesizing program 1606. Memory device 1602 is detachable from terminal device 1601. Server device 1605 on the Internet provides voice synthesis subject data 1603, or the subject data to be read, phonemic data 1604, and voice synthesizing program 1606.

In FIG. 16, the voice synthesis subject data defining reading subject data is stored in storage unit within terminal device 1601. A user can also download his/her choice of voice synthesis subject data from server device 1605 on the Internet and store it in the storage unit within terminal device 1601. Additionally, the user can download the latest version of voice synthesizing program, and update the program stored in memory device 1602. The user is able to listen to synthetic voice in voice of his/her favorite character by inserting memory device 1602, which stores the phonemic data of character's voice, into terminal device 1601, and by activating it.

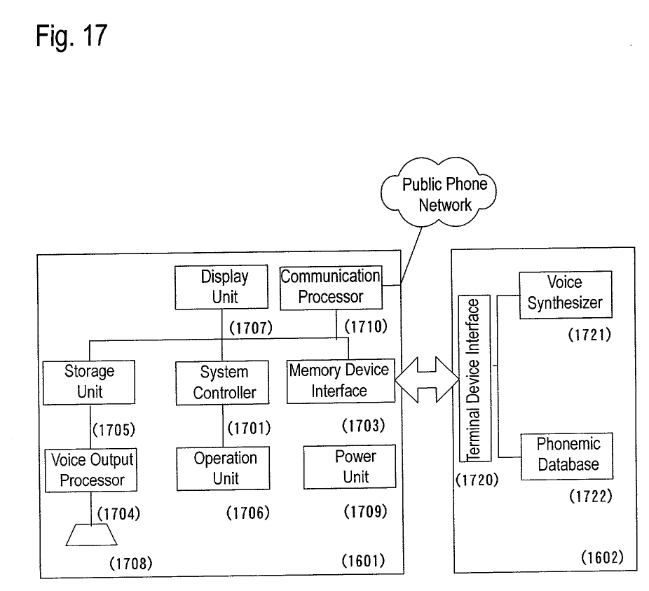

FIG. 17 is a block diagram showing in detail terminal device 1601 and memory device 1602 of FIG. 16. In FIG. 17, system controller 1701, memory device interface 1703, voice output processor 1704 through communication processor 1710, terminal device interface 1720 and phonemic database 1722 are analogous to system controller 101, memory device interface 103, voice output processor 104 through communication processor 110, terminal device interface 120 and phonemic database 121 of FIG. 2, and their details will therefore be skipped. Reference numeral 1721 represents a voice synthesizer, which stores the voice synthesizing program.

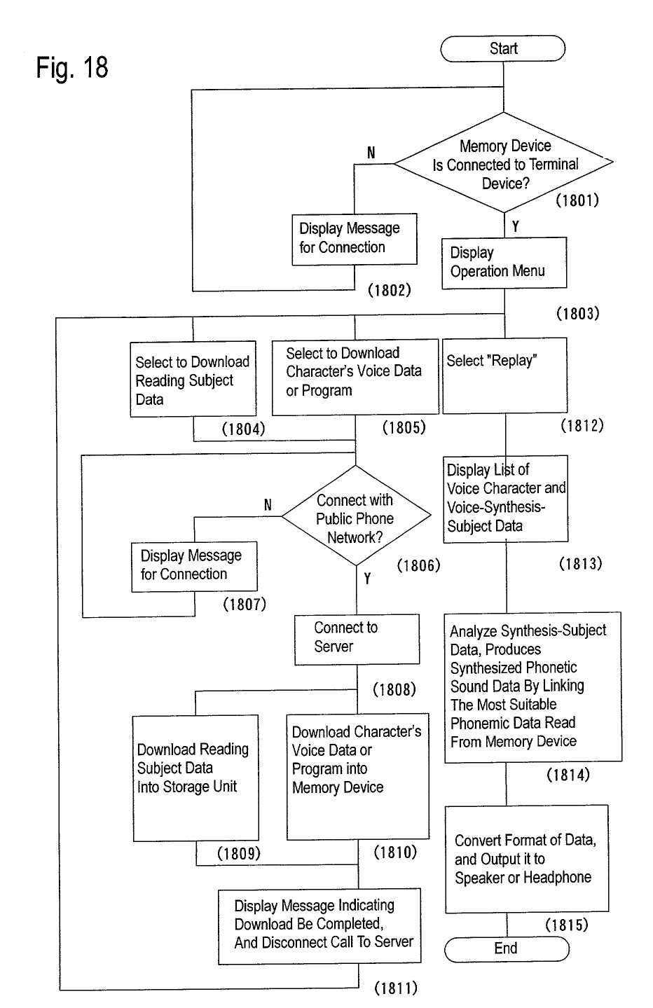

The portable information terminal constructed as above operates in a manner, which will be described hereinafter with reference to FIG. 18. FIG. 18 is a flowchart showing operation of terminal device 1601. When the user turns on a power supply to terminal device 1601 with operation unit 1706, system controller 1701 sends a command to memory device interface 1703 to verify whether or not memory device 1602 is in connection with terminal device 1601 (S101). If not connected, system controller 1701 retrieves a font data from storage unit 1705, and displays in display unit 1707 a message such as “insert a memory card” to urge the user to connect memory device 1602 to terminal device 1601 (S102). If memory device 1602 is in connection, system controller 1701 displays in display unit 1707 another message such as “operation menu 1. replay, 2. program update, 3. download reading subject data, 4. download character's voice data, and so on” (S103).

When the user makes a selection for downloading the reading subject data (S104), system controller 1701 verifies whether terminal device 1601 is in connection to public telephone network through communication processor 1710 (S106). If it is not connected, system controller 1701 displays in display unit 1707 a message such as “connect to the network” to urge connection (S107). If it is in connection, system controller 1701 accesses server device 1605 (refer to FIG. 16) on the Internet through communication processor 1710 (S108).

When the access is completed, system controller 1701 in terminal device 1601 requests server device 1605 to download the reading subject data (i.e. appropriate voice synthesis subject data). When the reading subject data is transferred from server device 1605, system controller 1701 stores it in storage unit 1705 (S109). System controller 1701 then displays a message indicating that the download is completed, and it disconnects the call to server device 1605 (S111).

The same steps are also taken, when selection is made for program update or downloading of character's voice data (i.e. appropriate phonemic data) (S105), from getting access to server device 1605 to downloading of the data, as in the aforesaid case of downloading the reading subject data. In this case, however, system controller 1701 stores the downloaded data in memory device 1602 via memory device interface 1703 and terminal device interface 1720 in the memory device 1602 (Si10). It then displays a message indicating that the download is completed, and disconnects the call to server device 1605 (S111).

When the user selects a replay function through operation unit 1706 (S112), system controller 1701 displays a list of the reading subject data and the character's voice data in display unit 1707 (S113), allowing the user to make selection of any of the reading subject data and the voice data of any character. When the user made a selection, system controller 1701 sends to voice synthesizer 1721 a command to start processing. Voice synthesizer 1702 analyzes the voice synthesis subject data while reading it out successively from storage unit 1705, produces synthesized phonetic sound data by linking it to the most suitable phonemic data read from memory device 1602 (S114), and passes on the synthesized phonetic sound data to voice output processor 1704 after converting it into data of a format processable by voice output processor 1704. Voice synthesizer 1702 repeats the above processes until the user pushes a stop button on operation unit 1706 to let system controller 1701 issue a command to discontinue the processing. Voice output processor 1704 converts format of the data received from voice synthesizer 1702, and outputs it to speaker or headphone 1708 (S115).

According to this exemplary embodiment as described above, terminal device 1601 comprises system controller 1701 for controlling the entire device, storage unit 1705 for storing the voice synthesizer program and the voice synthesis subject data, memory device interface 1703 for exchanging data between memory device 1602, and communication processor 1710 for connecting to public telephone network. Memory device 1602 comprises voice synthesizer 1721 for storing voice synthesizing program beside for voice-synthesizing the voice synthesis subject data with the phonemic data according to the voice synthesizing program, phonemic database 1722 for storing the phonemic data, and terminal device interface 1720 for exchanging data between terminal device 1601. Accordingly, the user is able to listen to reading of text data and the like in voice of his/her favorite character.

### Exemplary Embodiment 7

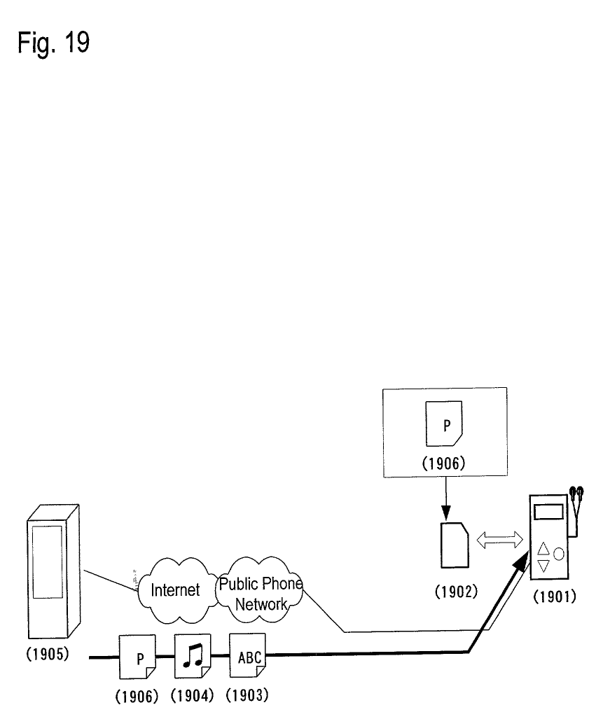

FIG. 19 is a configuration diagram showing a communication system having a portable information terminal according to the present exemplary embodiment. In FIG. 19, terminal device 1901 is provided with a display unit, an operation unit, a voice output unit such as a headphone speaker, and the like. Memory device 1902 such as a memory card stores voice synthesizing program 1906. Memory device 1902 is detachable from terminal device 1901. Server device 1905 on the Internet provides voice synthesis subject data 1903, which is the subject data to be read, phonemic data 1904, and voice synthesizing program 1906.

In FIG. 19, the voice synthesis subject data defining reading subject data, and phonemic data for voice of unique characters are stored in a storage unit within terminal device 1901. A user can also download his/her choice of voice synthesis subject data and the phonemic data from server device 1905 on the Internet and store them in the storage unit within terminal device 1901. In addition, the user can also download the latest version of voice synthesizing program, and update the program stored in memory device 1902. The user can listen to synthetic voice in voice of his/her favorite character by inserting memory device 1902, which stores the voice synthesizing program, into terminal device 1901, and by activating it.

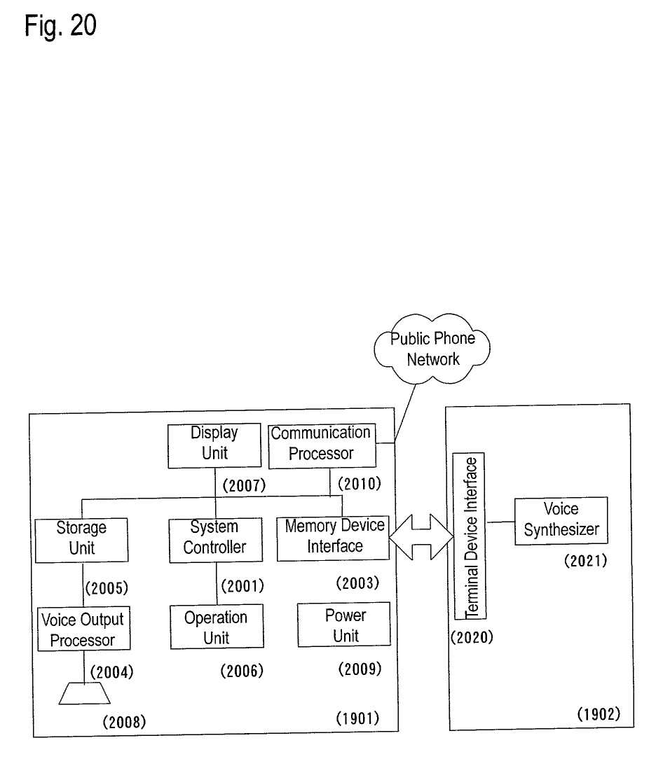

FIG. 20 is a block diagram showing in detail terminal device 1901 and memory device 1902 of FIG. 19. In FIG. 20, system controller 2001, memory device interface 2003, voice output processor 2004 through communication processor 2010, and terminal device interface 2020 are analogous to system controller 101, memory device interface 103, voice output processor 104 through communication processor 110, and terminal device interface 120 of FIG. 2, and their details will therefore be skipped. Reference numeral 2021 represents a voice synthesizer, which stores the voice synthesizing program.

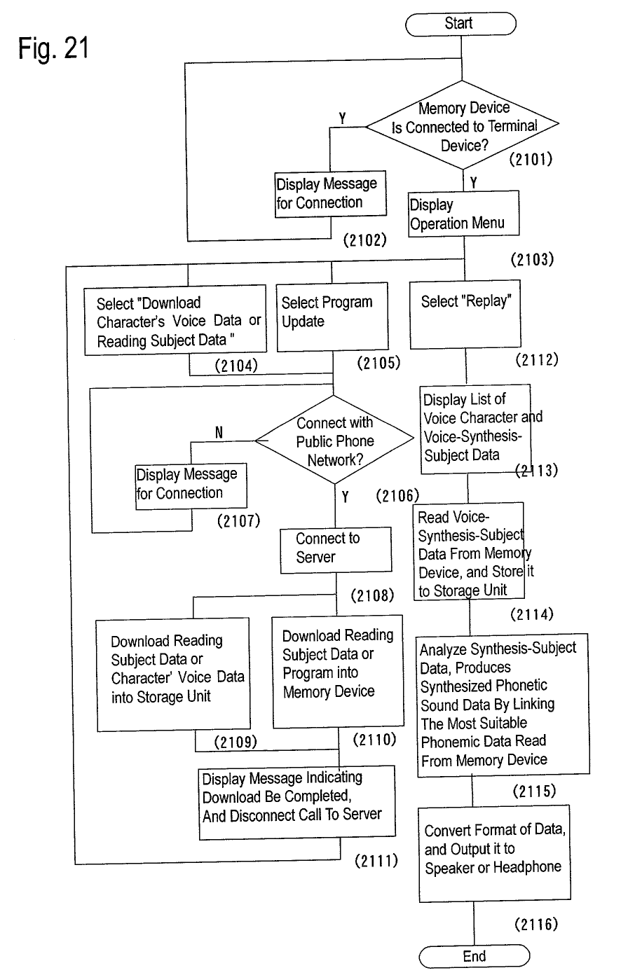

The portable information terminal constructed as above operates in a manner, which will be described hereinafter with reference to FIG. 21. FIG. 21 is a flowchart showing operation of terminal device 1901. When the user turns on a power supply to terminal device 1901 with operation unit 2006, system controller 2001 sends a command to memory device interface 2003 to verify whether memory device 1902 is in connection with terminal device 1901 (S121). If it is not connected, system controller 2001 retrieves a font data from storage unit 2005, and displays in display unit 2007 a message such as “insert a memory card” to urge the user to connect memory device 1902 to terminal device 1901 (S122).

If memory device 1902 is in connection, system controller 2001 displays in display unit 2007 another message such as “operation menu 1. replay, 2. program update, 3. download reading subject data, 4. download character's voice data, and so on” (S123). When the user made a selection for downloading any of the reading subject data and the character's voice data (S124), system controller 2001 verifies whether terminal device 1901 is in connection to public telephone network through communication processor 2010 (S126). If not connected, system controller 2001 displays in display unit 2007 a message such as “connect to the network” to urge connection (S127). If it is connected, system controller 2001 accesses server device 1905 (refer to FIG. 19) on the Internet through communication processor 2010 (S128).

When the access is completed, system controller 2001 in terminal device 1901 requests server device 1905 to download the reading subject data (i.e. appropriate voice synthesis subject data) or the character's voice data (i.e. appropriate phonemic data). When the reading subject data or the character's voice data is transferred from server device 1905, system controller 2001 stores it in storage unit 2005 (S129). System controller 2001 then displays a message indicating that the download is completed, and diconnects the call to server device 1905 (S131).

The same steps are also taken, when selection is made for program update (S125), from getting access to server device 1905 to downloading of the data, as in the aforesaid case of downloading the reading subject data and the character's voice data. In this case, however, system controller 2001 stores the downloaded data in memory device 1902 via memory device interface 2003 and terminal device interface 2020 in the memory device 1902, and updates the voice synthesizing program (S130). It then displays a message indicating that the download is completed, and disconnects the call to server device 1905 (S131).

When the user selects a replay function through operation unit 2006 (S132), system controller 2001 displays a list of the reading subject data and the character's voice data in display unit 2007 (S133), allowing the user to make selection of any of the reading subject data and the voice data of any character. When the user made a selection, system controller 2001 reads out the voice synthesizing program from memory device 1902, and stores it in storage unit 2005 (S134). Next, system controller 2001 sends to voice synthesizer 2021 a command to start processing. Voice synthesizer 2021 analyzes the voice synthesis subject data while reading it out successively from storage unit 2005, produces synthesized phonetic sound data by linking it to the most suitable phonemic data read from storage unit 2005 (S135), and passes on the synthesized phonetic sound data to voice output processor 2004 after converting it into data of a format processable by voice output processor 2004. Voice synthesizer 2021 repeats the above processes until the user pushes a stop button on operation unit 2006 to let system controller 2001 issue a command to discontinue the processing. Voice output processor 2004 converts format of the data received from voice synthesizer 2021, and outputs it to speaker or headphone 2008 (S136).

According to this exemplary embodiment as described above, terminal device 1901 comprises system controller 2001 for controlling the entire device, storage unit 2005 for storing the voice synthesizing program, the voice synthesis subject data and the phonemic data, memory device interface 2003 for exchanging data between memory device 1902, and communication processor 2010 for connecting to public telephone network. Memory device 1902 comprises voice synthesizer 2021 for storing voice synthesizing program beside for voice-synthesizing the voice synthesis subject data with the phonemic data according to the voice synthesizing program, and terminal device interface 2020 for exchanging data between terminal device 1901. Accordingly, the user is able to listen to reading of text data and the like in voice of his/her favorite character.

### Exemplary Embodiment 8

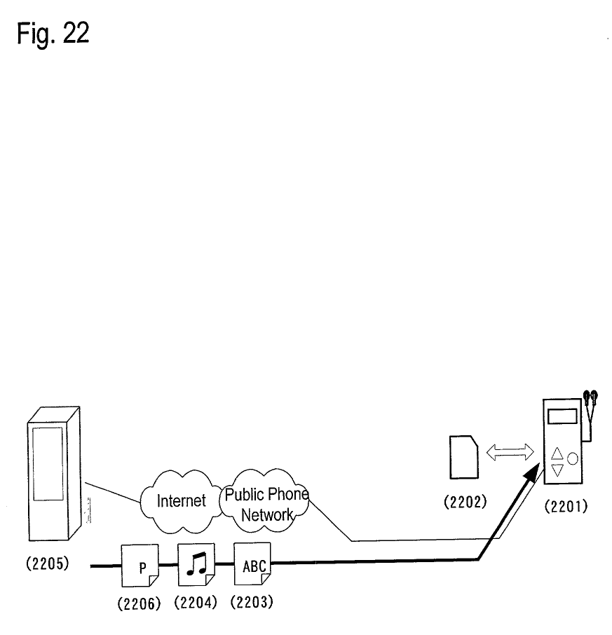

FIG. 22 is a configuration diagram showing a communication system having a portable information terminal according to the present exemplary embodiment. In FIG. 22, terminal device 2201 is provided with a display unit, an operation unit, a voice output unit such as a headphone speaker, and the like. Memory device 2202 such as a memory card is detachable from terminal device 2201. Server device 2205 on the Internet provides voice synthesis subject data 2203, which is the subject data to be read, phonemic data 2204, and voice synthesizing program 2206.

In FIG. 22, the voice synthesis subject data defining reading subject data and phonemic data for voice of unique characters are stored in a storage unit within terminal device 1901. A user can also download his/her choice of voice synthesis subject data and phonemic data from server device 1905 on the Internet and store them in the storage unit within terminal device 1901. In addition, he/she can also download the latest version of voice synthesizing program, and update the program stored in terminal device 1901. The user can listen to synthetic voice in voice of his/her favorite character by operating the terminal device.

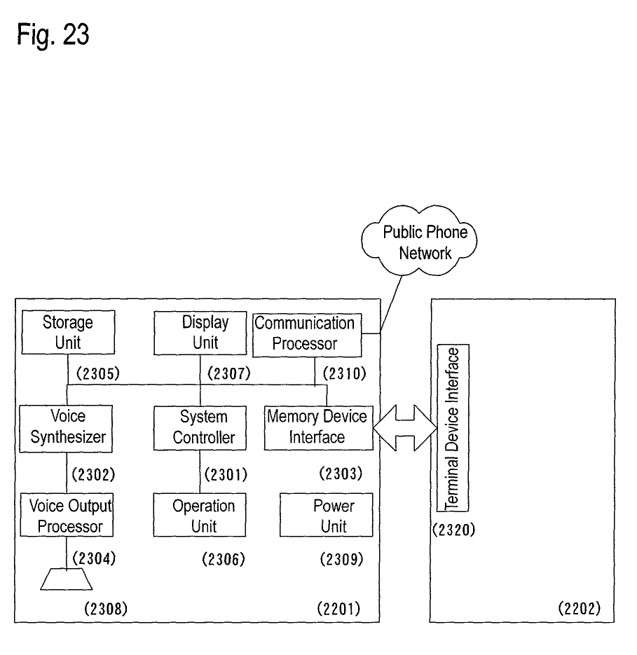

FIG. 23 is a block diagram showing in detail terminal device 2201 and memory device 2202 of FIG. 22. In FIG. 23, system controller 2301, memory device interface 2303, voice output processor 2304 through communication processor 2310, and terminal device interface 2320 are analogous to system controller 101, memory device interface 103, voice output processor 104 through communication processor 110, and terminal device interface 120 of FIG. 2, and their details will therefore be skipped.

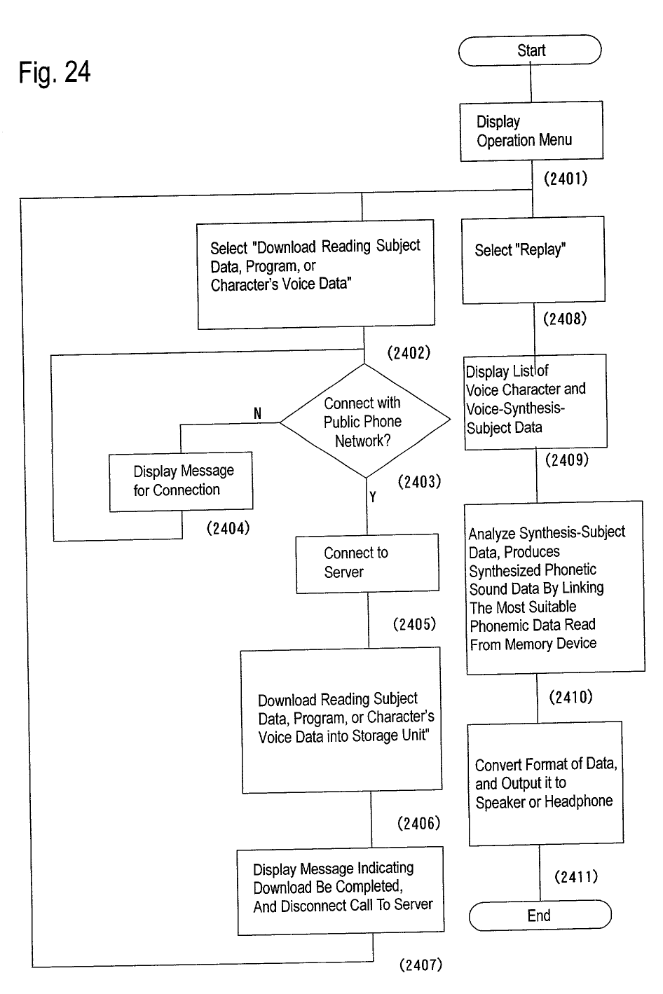

The portable information terminal constructed as above operates in a manner, which will be described hereinafter with reference to FIG. 24. FIG. 24 is a flowchart showing operation of terminal device 2201. When the user turns on a power supply to terminal device 2201 with operation unit 2306, system controller 2301 displays in display unit 2307 a message such as “operation menu 1. replay, 2. program update, 3. download reading subject data, 4. download character's voice data, and so on” (S2401). When the user made a selection for any of downloading the reading subject data, the character's voice data and program update (S2402), system controller 2301 verifies whether or not terminal device 2201 is in connection with public telephone network through communication processor 2310 (S2403). If it is not connected, system controller 2301 displays in display unit 2307 another message such as “connect to the network” to urge connection (S2404). If it is connected, system controller 2301 accesses server device 2205 (refer to FIG. 22) on the Internet through communication processor 2310 (S2405).

When the access is completed, system controller 2301 in terminal device 2201 requests server device 2205 to download the reading subject data (i.e. appropriate voice synthesis subject data), the character's voice data (i.e. appropriate phonemic data) or the latest voice synthesizing program. When the reading subject data, the character's voice data or the program is transferred from server device 2205, system controller 2301 stores it in storage unit 2305 (S2406). System controller 2301 then displays a message indicating that the download is completed, and disconnects the call to server device 2205 (S2407).

When the user selects a replay function through operation unit 2306 (S2408), system controller 2301 displays a list of the reading subject data and the character's voice data in display unit 2307 (S2409), allowing the user to make selection of any of the reading subject data and the voice data of any character. When the user made a selection, system controller 2301 sends to voice synthesizer 2302 a command to start processing. Voice synthesizer 2302 analyzes the voice synthesis subject data while reading it out successively from storage unit 2305, produces synthesized phonetic sound data by linking it to the most suitable phonemic data read from storage unit 2305 (S2410), and passes on the synthesized phonetic sound data to voice output processor 2304 after converting it into data of a format processable by voice output processor 2304. Voice synthesizer 2302 repeats the above processes until the user pushes a stop button on operation unit 2306 to let system controller 2301 issue a command to discontinue the processing. Voice output processor 2304 converts format of the data received from voice synthesizer 2302, and outputs it to speaker or headphone 2308 (S2411).

According to this exemplary embodiment as described above, terminal device 2201 comprises system controller 2301 for controlling the entire device, storage unit 2305 for storing the voice synthesizing program, the voice synthesis subject data and the phonemic data, memory device interface 2303 for exchanging data between memory device 2202, communication processor 2310 for connecting to public telephone network, and voice synthesizer 2302 for voice-synthesizing the voice synthesis subject data with the phonemic data according to the voice synthesizing program. Memory device 2202 comprises terminal device interface 2320 for exchanging data between terminal device 2201. Accordingly, the user is able to listen to reading of text data and the like in voice of his/her favorite character.

### Exemplary Embodiment 9

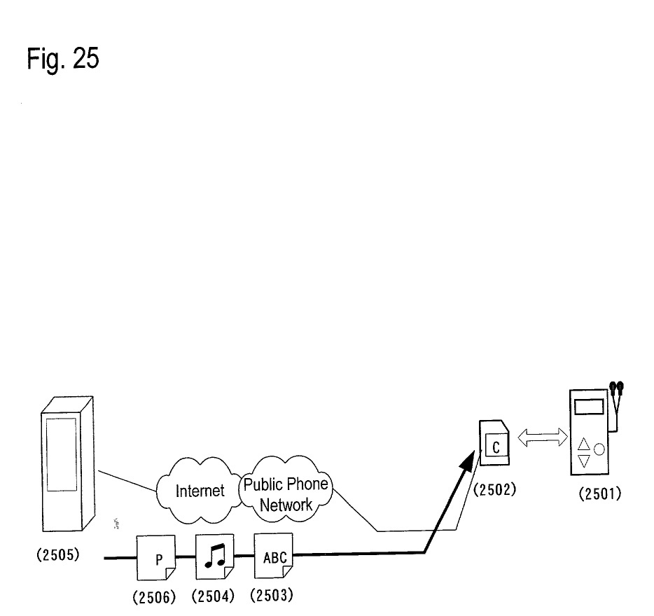

FIG. 25 is a configuration diagram showing a communication system having a portable information terminal according to the present exemplary embodiment. In FIG. 25, terminal device 2501 is provided with a display unit, an operation unit, a voice output unit such as a headphone speaker, and the like. Memory device 2502 such as a memory card is capable of storing phonemic data for voice of unique characters, voice synthesis subject data, which is the subject data to be read, and/or voice synthesizing program. Memory device 2502 is also equipped therein with a communication processor capable of making communication over the Internet. Memory device 2502 is detachable from terminal device 2501. Server device 2505 on the Internet provides voice synthesis subject data 2503 defining reading subject data, phonemic data 2504, and voice synthesizing program 2506.

In FIG. 25, a user inserts memory device 2502 containing the communication processor into terminal device 2501, and downloads any of the voice synthesizing program, the voice synthesis subject data and the phonemic data from server device 2505 on the Internet via the communication processor in memory device 2502, and store them also in memory device 2502 or in a storage unit within terminal device 2501. Thus, the user can listen to synthetic voice of the reading subject data in voice of his/her favorite character by operating terminal device 2501.

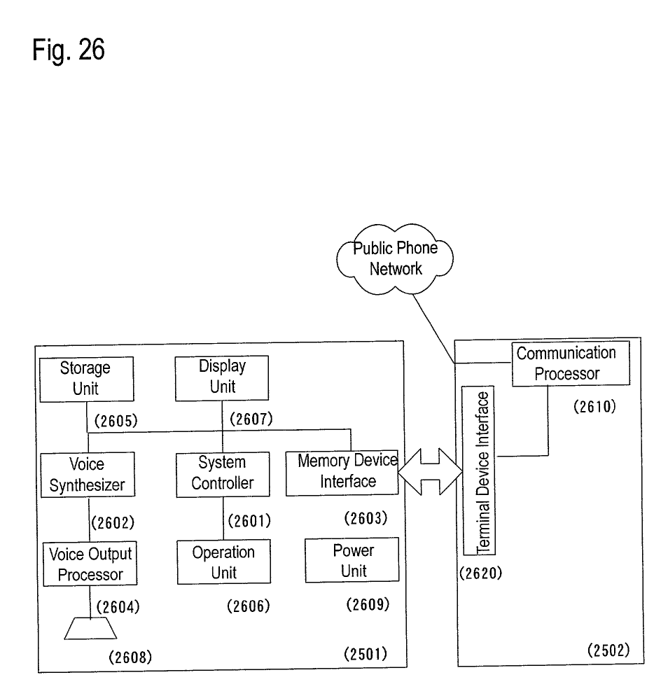

FIG. 26 is a block diagram showing in detail terminal device 2501 and memory device 2502 of FIG. 25. In FIG. 26, system controller 2601, memory device interface 2603, voice synthesizer 2602 through power unit 2609, and terminal device interface 2620 are analogous to system controller 101, memory device interface 103, voice output processor 104 through power unit 109, and terminal device interface 120 of FIG. 2, and their details will therefore be skipped. Communication processor 2610 contained in the memory device carries out communication with a server device over the Internet.

The portable information terminal constructed as above operates in a manner, which is described hereinafter.

When the user turns on a power supply to terminal device 2501 with operation unit 2606, system controller 2601 sends a command to memory device interface 2603 to verify whether memory device 2602 is in connection with terminal device 2501. If not connected, system controller 2601 retrieves a font data from storage unit 2605, and displays in display unit 2607 a message such as “insert a memory card” to urge the user to connect memory device 2502 to terminal device 2501. If it is connected, system controller 2601 displays in display unit 2607 another message such as “operation menu 1. replay, 2. program update, 3. download reading subject data, 4. download character's voice data, and so on”. When the user made a selection for any function other than replay, system controller 2601 verifies whether terminal device 2501 is in connection to public telephone network through communication processor 2610. If it is not connected, system controller 2601 displays in display unit 2607 a message such as “connect to the network” to urge connection. If it is connected, system controller 2601 accesses server device 2505 (refer to FIG. 25) on the Internet through communication processor 2610.

When the access is completed, system controller 2601 in terminal device 2501 requests server device 2505 to download any of the reading subject data (i.e. appropriate voice synthesis subject data), the character's voice data (i.e. appropriate phonemic data) and the voice synthesizing program according to the selection made by the user. When the reading subject data, the character's voice data or the voice synthesizing program is transferred from server device 2505, system controller 2601 stores the individual data in storage unit 2605 or memory device 2502. System controller 2601 then displays a message indicating that the download is completed, and disconnects the call to server device 2505.

When the user selected a replay function through operation unit 2606, terminal device 2501 operates to output synthesized phonetic sound in a manner which varies depending on where each of the voice synthesizing program, the voice synthesis subject data and the phonemic data is stored, in memory device 2502 or storage unit 2605 in terminal device 2501. Details as to how it operates is not repeated here, since each of the ways in which the data are stored corresponds to any one of embodiments 1 to 7 (one of FIG. 3, 6, 9, 12, 15, 18 and 21).

According to this exemplary embodiment as described above, memory device 2502 is provided with communication processor 2610, whereas terminal device 2501 is not. Since this can avoid terminal device 2501 from carrying the communication processor, it simplifies a structure of terminal device 2501, thereby realizing a reduction in cost of terminal device 2501.

### Exemplary Embodiment 10

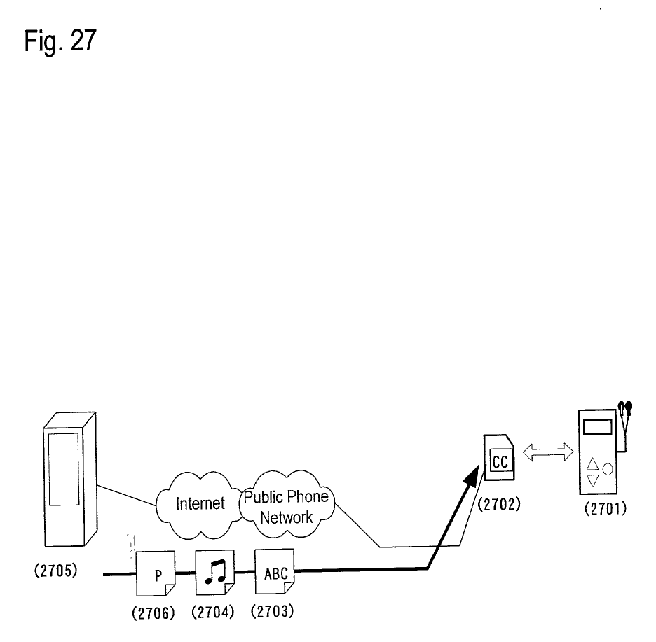

FIG. 27 is a configuration diagram showing a communication system having a portable information terminal according to the present exemplary embodiment. In FIG. 27, terminal device 2701 is provided with a display unit, an operation unit, a voice output unit such as a headphone speaker, and the like. Memory device 2702 such as a memory card is able to store phonemic data for voice of unique characters, voice synthesis subject data, which is the subject data to be read, and/or voice synthesizing program, and it is equipped therein with a communication processor capable of making communication over the Internet and a memory controller for controlling the communication processor. Memory device 2702 is detachable from terminal device 2701. Server device 2705 on the Internet provides voice synthesis subject data 2703 defining reading subject data, phonemic data 2704, and voice synthesizing program 2706.

In portable terminal device 2701 and memory device 2702 of FIG. 27, the communication processor and the memory controller for controlling the communication processor are incorporated in a manner that memory device 2702 alone is capable of downloading any of the voice synthesizing program, the voice synthesis subject data and the phonemic data from server device 2705 over the Internet. Thus a user is able to listen to synthetic voice of the reading subject data in voice of his/her favorite character by downloading these data into memory device 2702 or a storage unit in terminal device 2701, and by activating them.

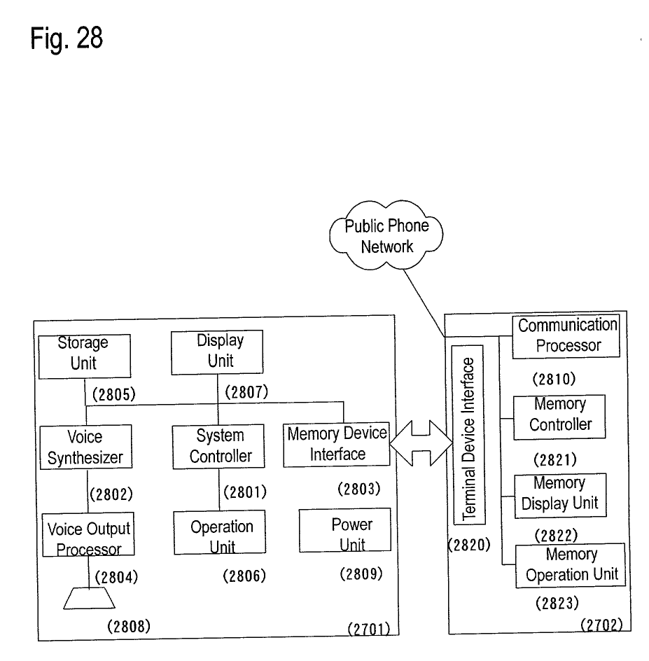

FIG. 28 is a block diagram showing in detail terminal device 2701 and memory device 2702 of FIG. 27. In FIG. 28, system controller 2801, memory device interface 2803, voice synthesizer 2802 through power unit 2809, and terminal device interface 2820 are analogous to system controller 101, memory device interface 103, voice output processor 104 through power unit 109, and terminal device interface 120 of FIG. 2, and their details will therefore be skipped. Communication processor 2810 equipped in the memory device carries out communication with server device 2705 over the Internet. Memory controller 2821 controls communication processor 2810. Memory display unit 2822 providing a user interface is disposed to memory device 2702 for displaying information when the user attempts a communication only with memory device 2702. Memory operation unit 2823 is also provided to realize user interface when using memory device 2702 alone.

The portable information terminal constructed as above operates in a manner, which is described hereinafter. When the user turns on a power supply to memory device 2702 with memory operation unit 2823, memory controller 2821 displays in memory display unit 2822 a message such as “operation menu 1. replay, 2. program update, 3. download reading subject data, 4. download character's voice data, and so on”. When the user selects any of the functions, memory controller 2821 verifies whether memory device 2702 is in connection to public telephone network through communication processor 2810. If memory device 2702 is not connected, memory controller 2821 displays in memory display unit 2822 a message such as “connect to the network” to urge connection. If it is connected, memory controller 2821 accesses server device 2705 (refer to FIG. 27) on the Internet through communication processor 2810.

When the access is completed, system controller 2801 in terminal device 2701 requests server device 2705 to download any of the reading subject data (i.e. appropriate voice synthesis subject data), the character's voice data (i.e. appropriate phonemic data) or the voice synthesizing program according to the selection made by the user. When the reading subject data, the character's voice data or the voice synthesizing program is forwarded from server device 2705, the individual data are stored in memory device 2702. It then displays a message indicating that the download is completed, and disconnects the call to server device 2705.

Further details of operation will be skipped in the case the user inserts memory device 2702 into terminal device 2701 and activates for replay, since it has been described in embodiment 4 (in FIG. 12).

According to this exemplary embodiment as described above, memory device 2702 is provided with memory controller 2821 for controlling communication processor 2810, wherein memory controller 2821 downloads the voice synthesizing program, the phonemic data and the voice synthesis subject data from server device 2705 on the Internet through communication processor 2810, and it transfers the downloaded program and data to storage unit 2805 via terminal device interface 2820 and memory device interface 2803. This enables memory device 2702 to download the program and data by itself, simplifies the structure of terminal device 2701, and realizes reduction in cost of terminal device 2701.

### Exemplary Embodiment 11

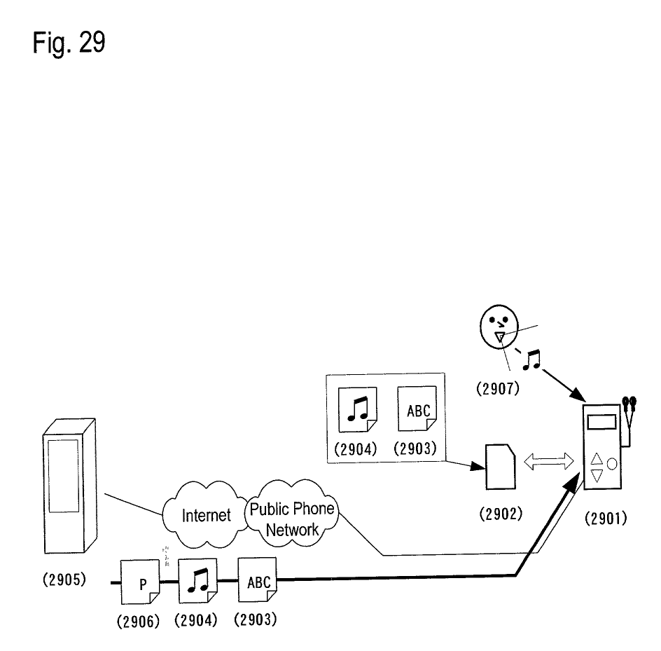

FIG. 29 is a configuration diagram showing a communication system having a portable information terminal according to the present exemplary embodiment. In FIG. 29, components 2901 through 2906 are analogous to components 201 through 206 of FIG. 2, and their details will therefore be skipped. A user registers natural voice by himself/herself as human voice 2907 in the portable information terminal. The user can thus have his/her desired text data and the like read in natural voice registered by him/her.

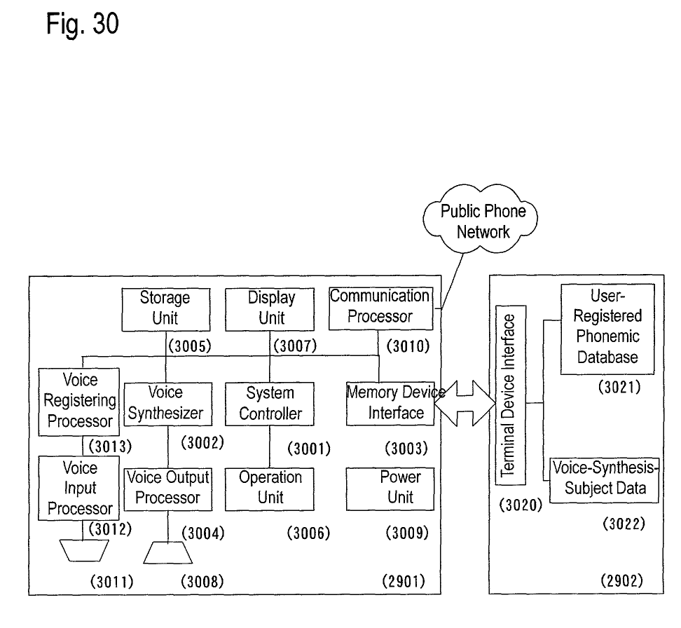

FIG. 30 is a block diagram showing in detail terminal device 2901 and memory device 2902 of FIG. 29.

Components 3001 through 3010, 3020 and 3022 are analogous to corresponding components 101 through 110, 120 and 122 shown in FIG. 1, and their details will therefore be skipped.

Microphone 3011 inputs natural voice of a subject character to be registered. Voice input processor 3012 samples analog voice data, and converts it into digital data. Voice registering processor 3013 analyzes the digital voice data converted by voice input processor 3012, and constructs a phonemic database. User-registered phonemic database 3021 is stored in memory device 2902.

The portable information terminal constructed as above operates in a manner, which is described below. However, described hereinafter pertains only to a process of registering human voice, since details about the voice synthesis operation has already been discussed in embodiment 1.

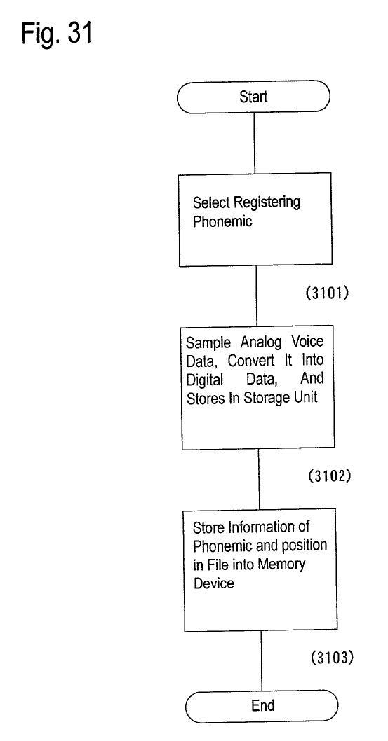

FIG. 31 is a flowchart in the process of voice registering in the portable information terminal according to embodiment 11. When the user initiates voice registering operation with operation unit 3006 (S3101), system controller 3001 activates voice input processor 3012 and voice registering processor 3013. Voice input processor 3012 samples analog voice data input from microphone 3011, converts it into digital data, and stores in storage unit 3005 (S3102).

Voice registering processor 3013 registers the voice input in the terminal device by the user in a manner that: it analyzes the voice data stored in storage unit 3005 by reading it out one after another; labels them to identify information such as a duration and fundamental frequency of sound for each of phoneme, data related to power, etc. of the sound, name of data file to which the phoneme belong, and a starting position and ending position of each of the phoneme in the file, and so on; forms them into database of a suitable format; and registers them in memory device 2902 (S3103). Synthesized phonetic sound is output thereafter when the user activates a replay function after selecting the voice that he/she registered as human voice of unique character, as well as synthesis subject data of his/her choice. This part of processes is skipped, as it has been described already in embodiment 1.

In this way, the user can register natural voice of his/her desired character into the device, and listen to reading of any text data with voice of the registered character.

### Exemplary Embodiment 12

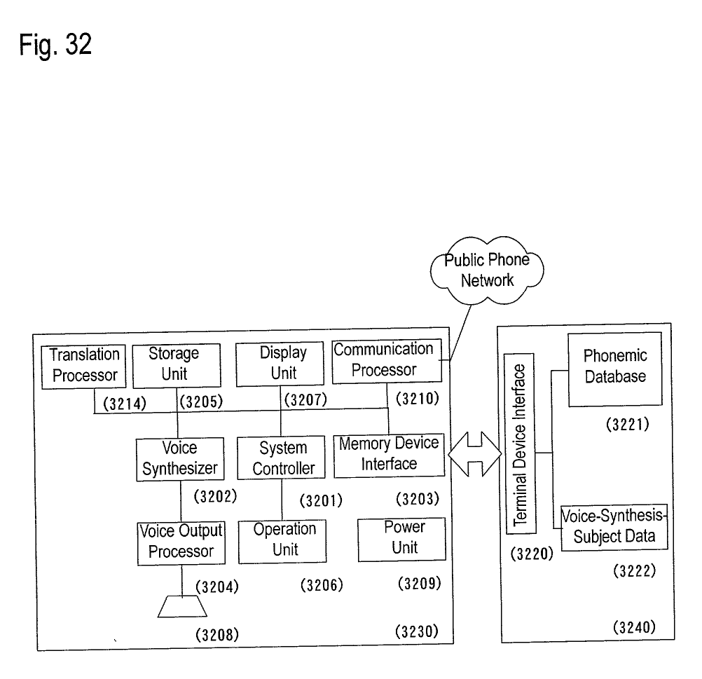

FIG. 32 is a detailed block diagram of a portable information terminal of this exemplary embodiment. Reference numeral 3230 represents a terminal device, and reference numeral 3240 represents a memory device. Components 3201 through 3210, 3020 through 3022 are analogous to corresponding components 101 through 110, 120 through 122 shown in FIG. 1, and their details will therefore be skipped. Translation processor 3214 converts the original synthesis subject data into another synthesis subject data in the language preferred by a user.

Voice synthesizing process is made for a text data in translated language and voice of a character desired by the user, and synthesized phonetic sound is output from terminal device 3230, when memory device 3240, in which phonemic database in voice of a unique character, and voice synthesis subject data such as the text data and the like are stored, is inserted into terminal device 3230, and a replay function is actuated after a selection is input for the language of translation (e.g., translation from English to Japanese) to terminal device 3230.

When the user activates the replay function in this portable information terminal, it first performs a translation process of the synthesis subject data, and a voice synthesis process thereafter for the translated data. Details of processes other than translation process will be omitted, since they have been described already in embodiment 1.

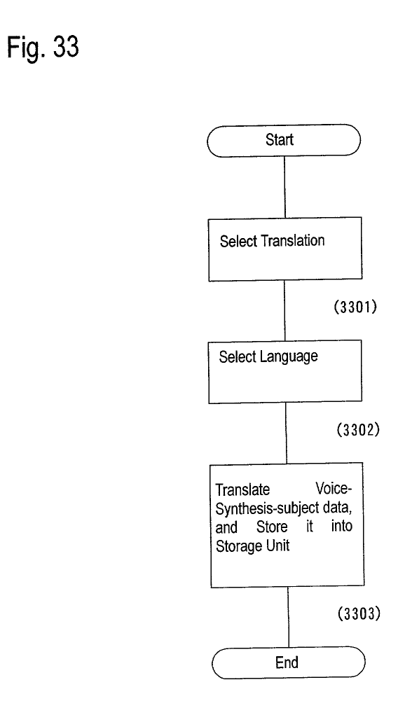

FIG. 33 shows a flowchart of the translation process of the portable information terminal of embodiment 12.

When the user selects the replay function through operation unit 3206 (S3301), system controller 3001 displays in display unit 3207 a message such as “select language for reading” as well as a list of languages available for the translation. When the user then selects one of the languages for reading using operation unit 3206 (S3302), a command is given to memory device interface 3203 to retrieve synthesis subject data 3222 stored in memory device 3240.

Memory device interface 3203 reads synthesis subject data 3222 while communicating with portable terminal device interface 3220 in memory device 3240, and stores it into storage unit 3205 within portable terminal device 3230.

Next, system controller 3201 brings translation processor 3214 into processing operation. Translation processor 3214 analyzes the data, and, while converting it into synthesis subject data of the language the user selected, stores the converted data into storage unit 3205. Following the above operation, voice synthesizer 3202 reads the converted data, performs the synthesizing operation in the like manner as described in embodiment 1, and outputs synthesized phonetic sound.

Accordingly, the user is able to listen to reading of the text data and the like in his/her desired language and in voice of the desired character.

### Exemplary Embodiment 13

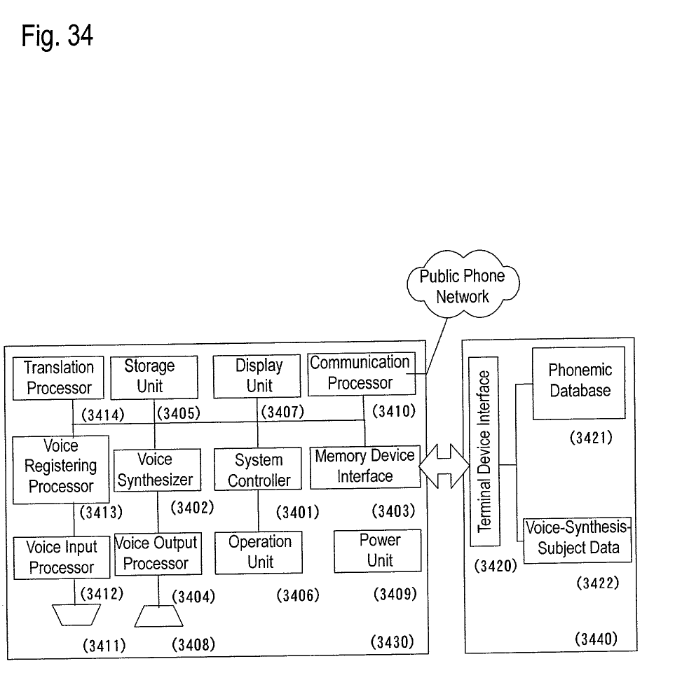

FIG. 34 is a detailed block diagram of a portable information terminal of the present exemplary embodiment. Reference numeral 3430 represents a terminal device, and reference numeral 3440 represents a memory device. Components 3401 through 3410, 3420 and 3422 are analogous to corresponding components 101 through 110, 120 and 122 shown in FIG. 1 in embodiment 1, and their details will therefore be skipped. Components 3411 through 3413 and 3421 are also analogous to components 3011 through 3013 and 3021 of FIG. 30 in embodiment 11, and component 3414 is analogous to component 3214 of FIG. 32 in embodiment 12. Details of their explanation are also skipped.

In this portable information terminal, synthesized phonetic sound is output in translated language desired by the user and in voice of a character registered by the user, when the user inserts memory device 3240, in which phonemic database in voice of the character registered by the user, and voice synthesis subject data such as text data and the like are stored, into terminal device 3230, and initiates a replay function after selecting the language of translation (e. g., translation from English to Japanese) on the terminal device.

Details as to how the voice registering process is carried out is not repeated, since they have been described with reference to FIG. 31 in embodiment 11.

In addition, details of the translation process is also skipped, as they have been described with reference to FIG. 33 in embodiment 12. Furthermore, details of the other processes are also skipped because they have been discussed according to FIG. 3 in embodiment 1.

The user can thus listen to reading of the text data and the like in voice of the character he/she registered and in his/her desired language.

### Exemplary Embodiment 14

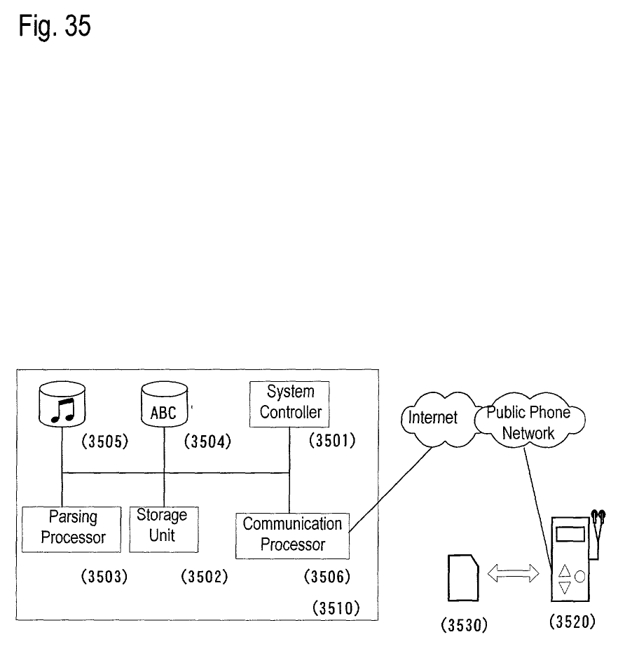

FIG. 35 is a configuration diagram showing a communication system having a portable information terminal of this exemplary embodiment, including a block diagram of a server device. Server device 3510 supplies voice synthesis subject data. For the sake of easiness in understanding, terminal device 3520 and memory device 3530 are so constructed in this embodiment that their internal configurations are analogous to those of FIG. 1 in embodiment 1.

A user can download his/her desired synthesis subject data such as a novel and the like through terminal device 3520. In this case, the user may specify, if he/she desires, a section of the data to be downloaded in the synthesis subject data.

If it is data of a novel or the like, for instance, the data may consist of header information covering a date the novel was written, name of the publisher and the like, a table of contents, main body of the story, and so on. However, the user may not always desire the device to read the header information and the table of contents. Thus, it provides for the user a selection such as “only main text”, in such instance.

Server device 3510 analyzes a structure of the synthesis subject data according to the information of data section specified by the user, extracts the specified section, and forwards the extracted synthesis subject data to the user. The forwarded synthesis subject data is stored in memory device 3530. Thus, when the user initiates a replay operation, the portable information terminal voice-synthesizes the text data, but only in the section of synthesis subject data selected by the user, with voice of a character preferred by the user, and outputs voice of synthesized phonetic sound.

Described next pertains to details about the server device.

System controller 3501 in the server device exchanges data with individual processors within the device to controls the entire device itself. In addition, it also includes a communicating function through network to perform communication over the Internet. Storage unit 3502 in the server device stores a control program of the server device, as well as a work area for processing a variety of tasks and the like. Parsing processor 3503 analyzes a structure of text data selected by the user, and extracts only a portion of the text data specified by the user (only a main body of the text, etc. for instance). Synthesis subject data memory 3504 stores a plurality of text data like novels, etc. Phonemic database memory 3505 stores phonemic database for a plurality of characters.

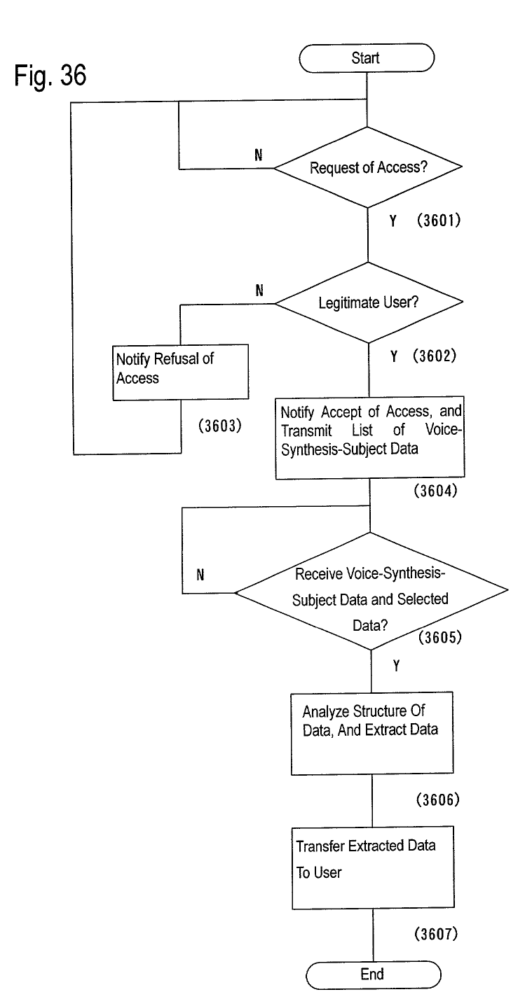

They operate in a manner as described hereinafter. FIG. 36 is a flowchart showing operation of the server device in exemplary embodiment 14. First, the server device waits for a request of access from the user (S3601). When the user enters his/her request for access using his/her user ID, password, and the like, the system controller in the server device verifies if the user who entered the request for access is a legitimate user or not (S3602). It notifies refusal of access to the user if he/she is not found to be the legitimate user (S3603). If he/she is the legitimate user, system controller 3501 permits the access, and transmits a listing information of the synthesis subject data stored in synthesis subject data memory 3504. The user selects his/her choice of the synthesis subject data from this listing information, and any section of the selected synthesis subject data (e.g., only a main body of the text, and the like) to be downloaded. The server device waits for reception of data from the user indicating the synthesis subject data and the section thereof selected by the user for downloading (S3605). When it receives the data, parsing processor 3503 reads out the corresponding synthesis subject data from synthesis subject data memory 3504, analyzes a structure of the data, and extracts the section of data selected by the user (S3606). It then transfers the extracted data to the user (S3607).

The user stores the transferred data into the memory device, which can be inserted into the terminal device for replay and output of synthesized phonetic sound. Accordingly, the user can listen to reading of the preferred section of the text in voice of his/her favorite character.

### Exemplary Embodiment 15

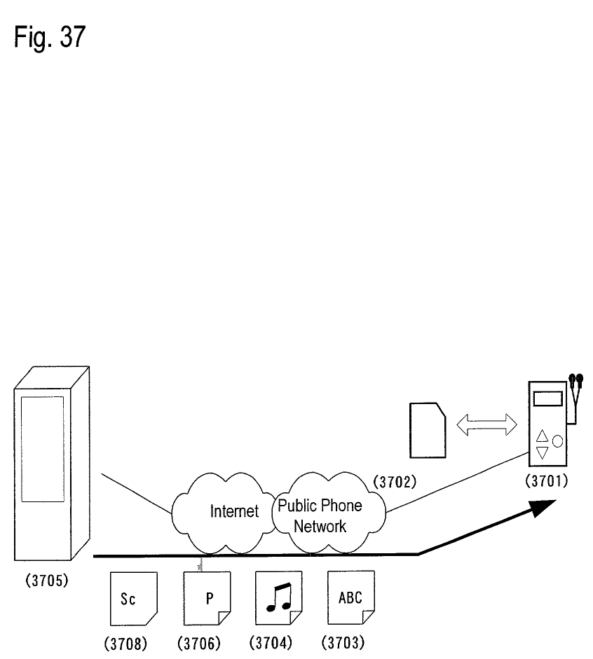

FIG. 37 is a configuration diagram showing a communication system having a portable information terminal according to the present exemplary embodiment. In FIG. 37, components 3701 through 3706 are analogous to components 201 through 206 of FIG. 2 described in embodiment 1. Server device 3705 provides musical score data 3708 to terminal device 3701.

A user accesses server device 3705 over the Internet through terminal device 3701, and selects a music he/she likes to listen and a character by whom he/she wants the music sung. Server device 3705 then forwards synthesis subject data 3703 containing a text and the like that corresponds to lyrics, and musical score data 3708 of the music the user selected, as well as phonemic database 3704 of a singer character. The forwarded data are stored in a memory device via the terminal device, which reproduces the music with voice of the character the user selected, when the user initiates a replay function.

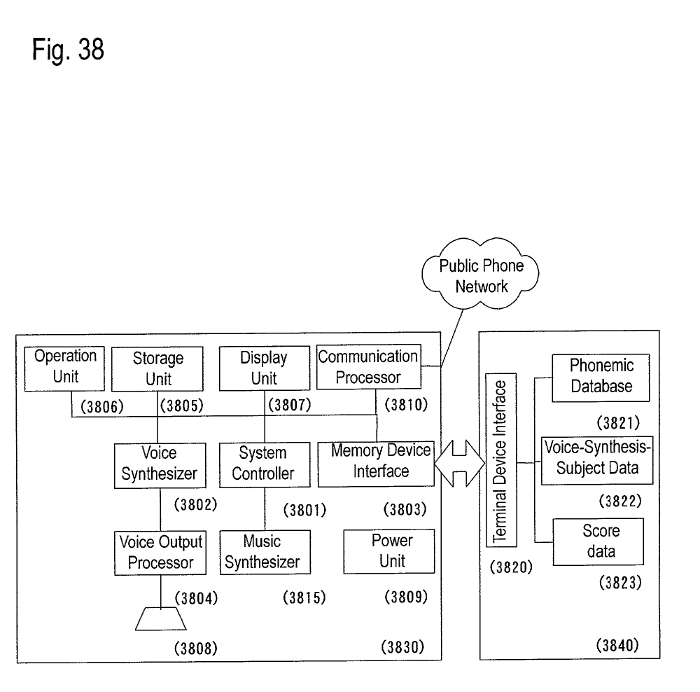

FIG. 38 is a detailed block diagram showing portable terminal device 3701 and memory device 3702. In FIG. 38, components 3801 through 3810 and 3820 through 3822 are analogous to corresponding components 101 through 110 and 120 through 122 of embodiment 1, and their details will therefore be skipped. Music synthesizer 3815 analyzes the musical score data for such information as pitch, duration, and the like of individual tones that compose the music. Musical score data 3708 is stored in the memory device.

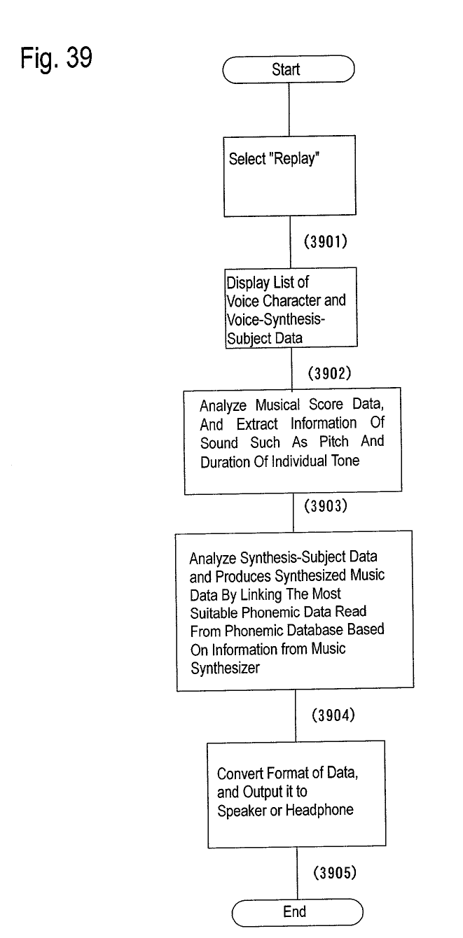

FIG. 39 is a flowchart showing operation of the portable information terminal of FIG. 38 in embodiment 15. This portable information terminal operates in the same manner as described in embodiment 1 except for that of the replay function, and their details are therefore skipped.

When the user selects the replay function with operation unit 3806 (S3901), system controller 3801 displays a list of music data and character's voice in display unit 3807 (S3902) allowing the user to make selection of any of the music data and the voice data of any character. When the user made his/her selection, system controller 3801 sends to memory device interface 3803 a command to read musical score data corresponding to the music data from those stored in memory device 3702. Memory device interface 3803 reads out the musical score data while communicating with terminal device interface 3820 in memory device 3702, and registers it in storage unit 3805 located in the terminal device. Music synthesizer 3815 then analyzes the musical score data by reading it out successively, and extracts information on the sound such as pitch and duration of individual tones that compose the music (S3803). Next, system controller 3801 sends to memory device interface 3803 another command to read synthesis subject data representing lyrics data of the corresponding music stored in memory device 3702, and registers the data in storage unit 3805. System controller 3801 now sends to voice synthesizer 3802 another command for a start of processing. Voice synthesizer 3802 analyzes the voice synthesis subject data while reading it out one after another from storage unit 3705, produces music data by linking it to the most suitable phoneme data read from memory device 3702 according to the sound data it extracted (S3904), and passes the data on to voice output processor 3804 after converting it into data of a format processable by voice output processor 3804. Voice synthesizer 3802 repeats the above processes until the user pushes a stop button on operation unit 3806 to let system controller 3801 issue a command to discontinue the processing. Voice output processor 3804 converts format of the data received from voice synthesizer 3802, and outputs it to speaker or headphone 3808 (S3905). The user can thus listen to the music in voice of the desired character.

### Exemplary Embodiment 16

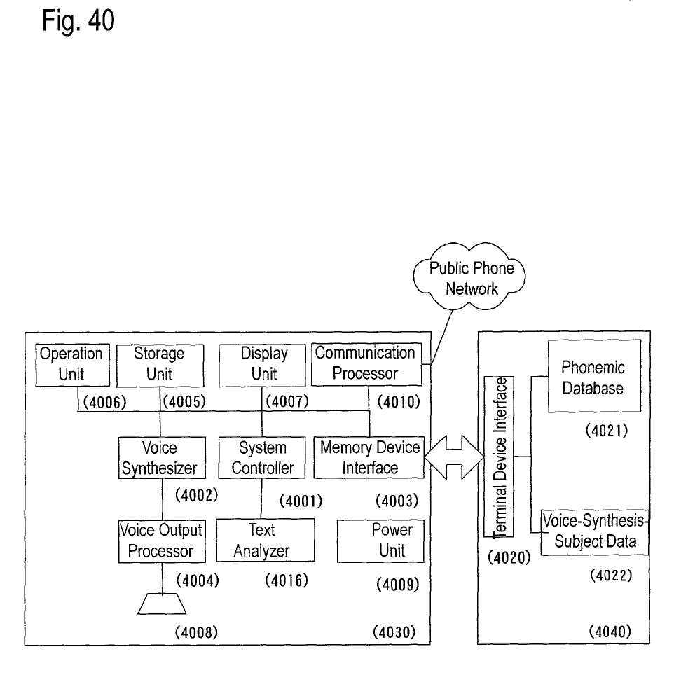

FIG. 40 is a block diagram of a portable information terminal of this exemplary embodiment. This portable information terminal provides for reading of synthesis subject data in voice of a substitute character for a certain string in the data, instead of voice of a character specified by the user, in order to prevent the device from being used illegitimately for a purpose of voice authentication and the like.

In FIG. 40, the portable information terminal comprises terminal device 4030 and memory device 4040. Components 4001 through 4010 and 4020 through 4022 are analogous to components 101 through 110 and 120 through 122 of embodiment 1, and their details will therefore be skipped. Text analyzer 4016 browses the synthesis subject data to verify if it contains a certain character string associated with monetary unit, numerical figures and the like.

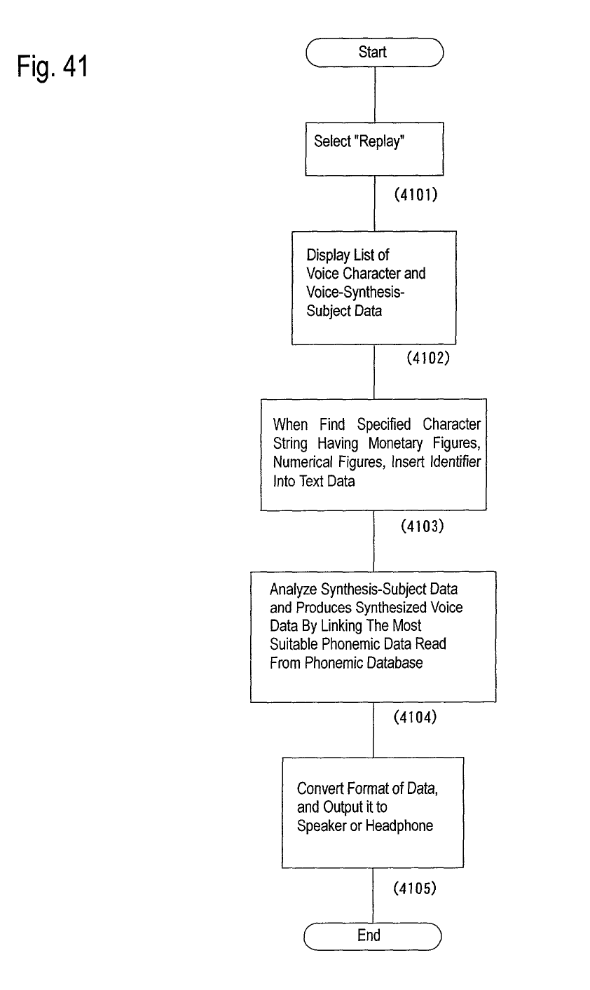

FIG. 41 is a flowchart showing operation of the portable information terminal of FIG. 40 in exemplary embodiment 16. This portable information terminal operates in the same manner as that described in embodiment 1 except for the replay function, and their details will therefore be skipped.

When a user selects the replay function with operation unit 4006 (S4101), system controller 4001 displays a list of the synthesis subject data and character's voice in display unit 4007 (S4102) allowing the user to make selection of any of the synthetic subject data and the voice data of any character. When the user made his/her selection, system controller 4001 sends memory device interface 4003 a command to read the corresponding synthetic subject data stored in memory device 4040. Memory device interface 4003 reads out the synthetic subject data while communicating with terminal device interface 4020 in memory device 4040, and registers it in storage unit 4005 within the terminal device. Text analyzer 4016 then analyzes texts of the synthetic subject data while reading them one after another. When text analyzer 4016 finds any character string having monetary figures, numerical figures and the like in the text, it registers the text in memory device 4040 after inserting an identifier into a leading end and a tail end of the character string (S4103), the identifier being such that it gives no influence to the voice synthesis processing.

Next, system controller 4001 sends to voice synthesizer 4002 a command for a start of the processing. Voice synthesizer 4002 analyzes the voice synthesis subject data while reading it out one after another from storage unit 4005. Voice synthesizer 4002 uses phonemic database for character's voice not chosen by the user if the read data is bracketed with the identifiers, or it uses another phonemic database for voice of the character specified by the user if the data is not bracketed. Voice synthesizer 4002, while analyzing the data, reads out the most suitable phonemic data from memory device 4040, and produces synthesized phonetic sound data by linking them together (S4104). It then passes on the synthesized phonetic sound data to voice output processor 4004 after converting it into data of a format processable by voice output processor 4004. Voice synthesizer 4002 repeats the above processes until the user pushes a stop button on operation unit 4006, letting system controller 4001 issue a command to discontinue the processing. Voice output processor 4004 converts format of the data received from voice synthesizer 4002, and outputs it to speaker or headphone 4008 (S3905).

As described, the device can reads the synthesis subject data in voice of a substitute character for a certain string in the data, instead of voice of the character specified by the user, so as to prevent the device from being used illegitimately for the purpose of voice authentication and the like.

### Exemplary Embodiment 17

A portable information terminal of this exemplary embodiment is such a device that compulsorily inserts a sound at every punctuation mark of comma and/or period, or at intervals of a predetermined number of characters in a text being read. The sound indicates that voice being output is synthetic sound, so as to prevent the device from being used illegitimately for the purpose of voice authentication and the like. An internal structure of the device is similar to that of embodiment 1 shown in FIG. 1, and the details will therefore be skipped.

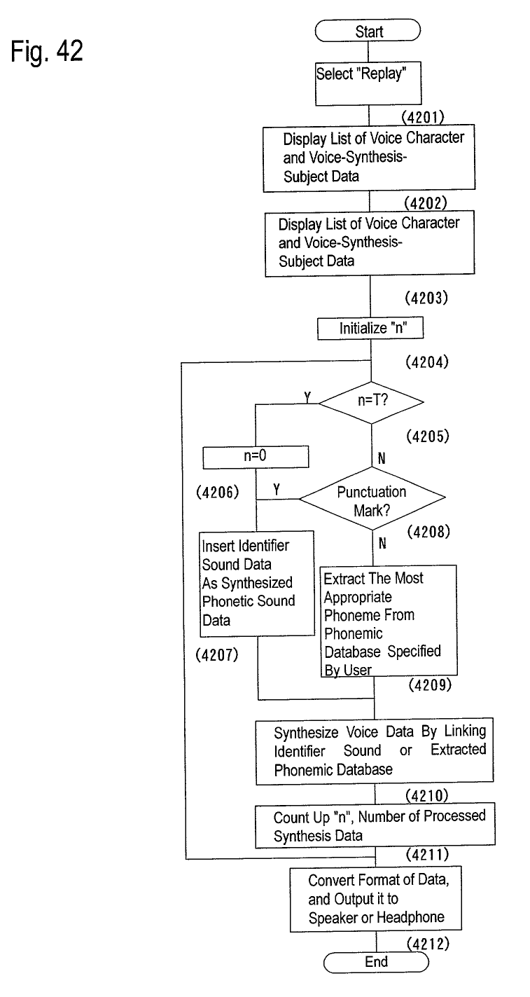

FIG. 42 is a flowchart showing operation of the information terminal according to exemplary embodiment 17. This portable information terminal operates in the same manner as that described in embodiment 1 except for the replay function, and their details are therefore skipped.

When a user selects the replay function with an operation unit (S4201), a system controller displays a list of voice synthesis subject data and character's voice in a display unit (S4202) allowing the user to make selection of any of the synthetic subject data and the voice data of any character. When the user made his/her selection, a system controller sends to a memory device interface a command to read the corresponding synthetic subject data stored in a memory device. The memory device interface reads out the synthetic subject data while communicating with a terminal device interface in the memory device, and registers it in a storage unit provided in a terminal device.

Next, the system controller sends another command to a voice synthesizer, letting it start the processing. The voice synthesizer analyzes the voice synthesis subject data while reading it out one after another from the storage unit. At the start, the voice synthesizer initializes variable “n” representing a number of synthesis-processed characters to be stored (S4204), and it then verifies whether the number of processed characters becomes equal to “T”, which is a number of characters after which identifier sound needs to be inserted (S4205). When the variable “n” becomes equal to the number “T”, the voice synthesizer resets the variable “n” to zero (S4206), and inserts an identifier sound data as a synthesized phonetic sound data (S4207). If the number of processed characters has not reached the number “T” for which the identifier sound is to be inserted, the voice synthesizer verifies whether a character being processed is a data signifying a punctuation mark such as comma and period (S4208). If it is, the voice synthesizer inserts an identifier sound data as a synthesized phonetic sound data (S4207). If not, the voice synthesizer extracts the most appropriate phoneme from the phonemic database for the voice of character specified by the user (S4209).

The voice synthesizer then produces synthesized phonetic sound data by consecutively linking the identifier sound data and the phoneme data extracted from the phonemic database (S4210). The voice synthesizer counts up the variable representing the number of characters that have been processed (S4211), and repeats the above processes (S4205) through (S4211) until a command is sent from the operation unit to discontinue the processing. The synthesized phonetic sound data is converted of the data format, and output to a speaker or a headphone (S4212).

In this device, as described, the invention makes possible to compulsorily insert the sound indicating that the voice being output is synthetic sound, at every punctuation mark of comma and period, or at intervals of the predetermined number of characters in the text, so as to prevent the device from being used illegitimately for the purpose of voice authentication and the like.

### Exemplary Embodiment 18

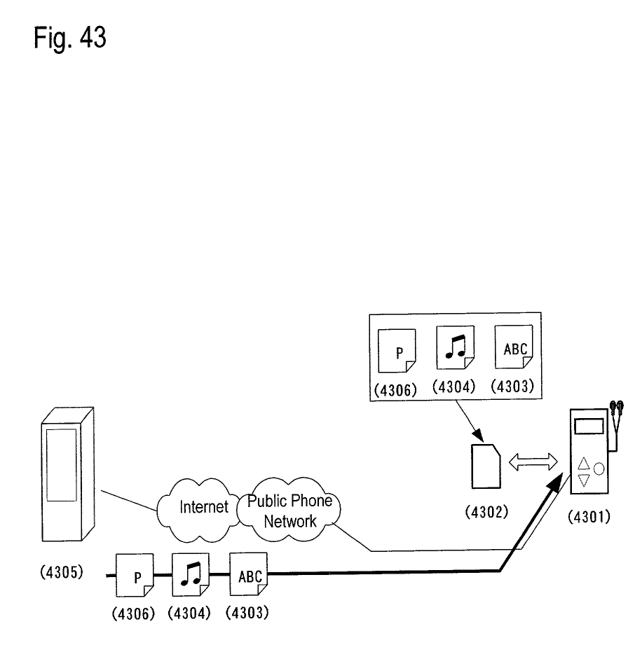

FIG. 43 is a configuration diagram showing a communication system having a portable information terminal of the present exemplary embodiment. Portable terminal device 4301 is provided with a display unit, an operation unit, voice output unit such as an amplifier, a headphone, speaker, and the like. Memory device 4302 such as a memory card, optical disk, magnetic disk and the like stores voice synthesis subject data, phonemic database for voice of unique characters, and voice synthesizing program, and it is detachable from the portable terminal device.

Voice synthesis subject data 4303 in this portable information terminal means text data such as a novel and the like. Phonemic database 4304 is constructed of sampled data taken from natural voice of a real character and formed into a database. It plays an important role in determining tone of synthesized phonetic sound output by this device.

Server device 4305 on the Internet provides voice synthesis subject data such as text data of novels and the like, phonemic database, and voice synthesizing program. Although shown here is only one server device, there may be cases that the voice synthesis subject data and the phonemic database are provided separately by a plurality of server devices. Reference numeral 4306 represents the voice synthesizing program provided by server device 4305 over the Internet, and it is executed in the information terminal.

A user first inserts memory device 4302, which stores phonemic database for voice of unique characters, voice synthesis subject data and the voice synthesizing program, into main terminal device 4301, and turns on a replay function to carry out voice synthesis processing of the synthesis subject data using the phonemic database of his/her favorite character. Thus, the user can listen to reading of the voice synthesis subject data with such voice as if it were spoken by the real character.

Alternatively, the user can access server device 4305 over the Internet, downloads a text data such as a novel of his/her choice and phonemic database of his/her favorite character by selecting them, and activate the replay function to listen to reading of the voice synthesis subject data with the voice just as it were spoken by the real character. In this instance, a service provider analyzes sampled data of voice spoken by a number of characters, extracts data in the vocal sound relative to strength, pitch and the like of the sound, and keeps them available as phonemic database in server device 4305.

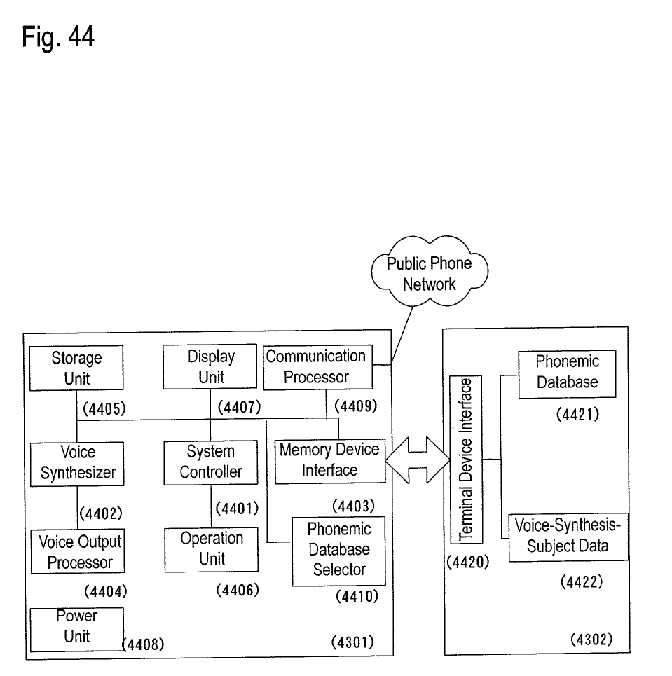

FIG. 44 shows a block diagram of this portable information terminal. In FIG. 44, memory device 4302 is a storage device connectable to main terminal device 4301. System controller 4401 is provided within main terminal device 4301, and it exchanges data with individual processors in the device to control the entire terminal device 4301. Voice synthesizer 4302 analyzes the voice synthesis subject data, extracts the most suitable phonemic data for the synthetic subject data (for each of character data or word data), and links them together. Memory device interface 4403 writes/reads the data in and out of memory device 4302.

Voice output unit 4404 receives data from voice synthesizer 4402, carries out process such as format conversion and the like of the data, converts the data from digital form to analog form, removes undesired noises, and outputs the data to a speaker, headphone, or the like. Storage unit 4405 of the portable terminal devise stores a program for controlling the terminal device, font data used to display in display unit, as well as synthesized phonetic sound data, and it is also used as a work space when processing a variety of data.

The user gives his/her command to the device through operation unit 4406. Display unit 4407 displays an operating status and the like of the device for the user. Power unit 4408 supplies electric power to the device. Communication processor 4409 makes connection to a public telephone network, and exchanges data over the Internet.

Phonemic database selector 4410 analyzes the voice synthesis subject data, and selects a phonemic database to be used for the voice synthesis processing. Terminal device interface 4420 exchanges data with terminal device 4301 through memory device interface 4403.

Next, memory device 4302 stores phonemic database 4421 and voice synthesis subject data 4422. In this embodiment, memory device 4302 and storage unit in the terminal device may individually store any combination of the voice synthesis subject data, the phonemic database, and the voice synthesizing program.

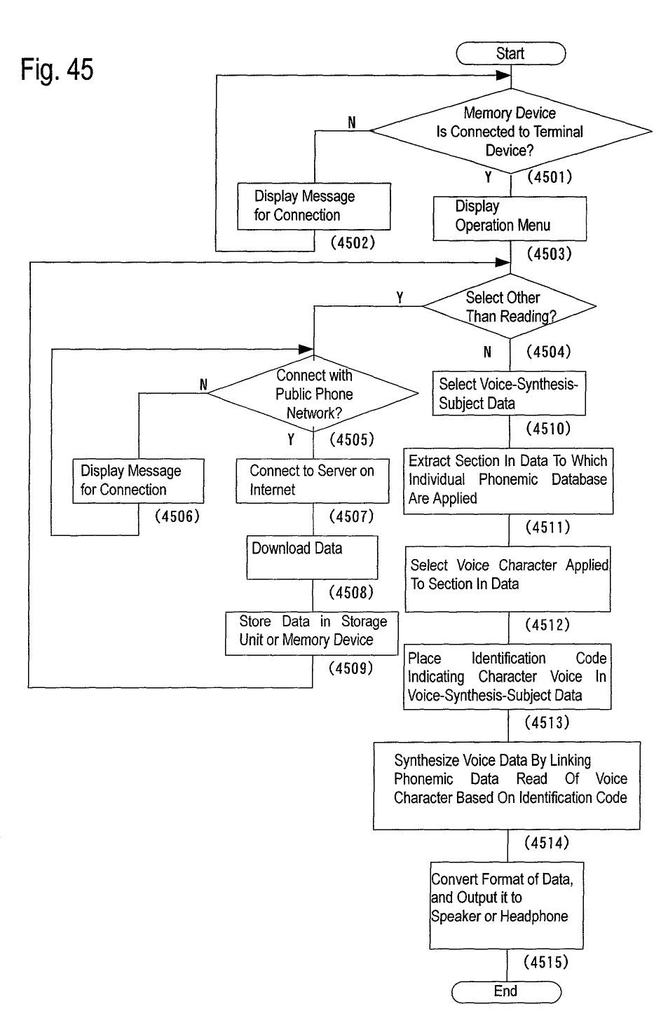

The portable information terminal of this invention operates in a manner, which will be described hereinafter with reference to an operational flowchart shown in FIG. 45. When the user turns on the power supply of the device with the operation unit, system controller 4401 gives a command to memory device interface 4403 to check whether or not memory device 4302 is in connection with main terminal device 4401 (S4501). If not connected, system controller 4401 displays in display unit 4407 a message such as “insert a memory card” to urge the user to connect memory device 4302 to main terminal device 4301 (S4502).

If memory device 4302 is connected with main terminal device 4301, system controller 4401 displays in display unit 4407 another message such as “operation menu 1. reading, 2. program update, 3. download voice synthesis subject data, 4. download character's voice data, and so on” to urge the user to play further with the terminal device (S4503).

When the user plays operation unit 4406 to select any function other than reading (S4504), system controller 4401 verifies whether main terminal device 4301 is in connection with public telephone network through communication processor (S4505). If it is not connected, system controller 4401 displays in display unit 4407 a message such as “connect to the network” to urge connection to the network (S4506).

If terminal device 4301 is connected to the public network, system controller 4401 accesses server device 4305 on the Internet through communication processor 4409 (S4507). System controller 4401 in main terminal device 4301 requests server device 4305 to download any of the voice synthesizing program, the voice synthesis subject data and the phonemic database (S4508). When server device 4305 forwards the data, system controller 4401 stores the data in any of storage unit 4405 and memory device 4302 (S4509). System controller 4401 disconnects the call to server device 4305 upon completion of the above process.

When the user selects a reading function using operation unit 4406 while the above-said operation menu is on the display (S4504), system controller 4401 now displays in display unit 4407 a list of the voice synthesis subject data as well as a list of the voice characters stored in the device. When the user makes his/her selection of any of the voice synthesis subject data using operation unit 4406 (S4510), phonemic database selector 4410 analyzes the voice synthesis subject data, and extracts sections in the data to which individual phonemic database are applied (S4511). If the voice synthesis subject data is text data of a novel, for instance, phonemic database selector 4410 divides the data into such sections as speaking part of characters, narrating part, and the like, and forwards the result to the system controller.

Based on the result given by phonemic database selector 4410, system controller 4401 puts on display unit 4407 a message such as “select a voice character applied to each of the following sections: 1. voice of character A; 2. voice of character C; 4. narration” and the like, so as to let the user select any of the voice characters to be allocated for reading the individual sections of the voice synthesis subject data.

The user gives his/her decision of a voice character through operation unit 4406 (S4512). The user may on occasion choose more than one character, so that different voice character may be assigned to each of a plurality of the characters in the novel.

System controller 4401 gives a result of the selection to phonemic database selector 4410. Phonemic database selector 4410 places an identification code in a coexisting manner with each section of the voice synthesis subject data to which the phonemic database of the selected character is applied according to the above result (S4513) so as to make the individual sections of the voice synthesis subject data distinguishable for voice synthesizer 4402 in respect to which voice character it needs to use for each of the sections. The resulted data is then stored in storage unit 4405. In short, the identification code is added to every section of the voice synthesis subject data in order to specify a voice character appropriate to it.

Accordingly, during voice synthesis processing, voice synthesizer 4402 carries out the voice synthesis using phonemic database of the voice character appropriate to each section of the voice synthesis subject data. This enables voice synthesizer 4402 to implement voice synthesizing of a novel, for instance, using different voice character for speaking part of each character, to achieve more realistic reading. In this phonemic database selector, there are many ways of dividing the data into sections where individual phonemic databases are applied, such as speaking parts of the characters as discussed above, individual paragraphs, individual lines, and the like, and that the way of dividing the data is not restrictive since it depends on substance of the voice synthesis subject data.

Next, system controller 4401 activates voice synthesizer 4402 to start the processing. Voice synthesizer 4402 reads one after another the voice synthesis subject data previously processed by the phonemic database selector one after another from storage unit 4405, and selects phonemic database of an appropriate voice character for use according to the identification code. It analyzes the voice synthesis subject data, reads the phonemic data most suitable for each of the data from storage unit 4405 or memory device 4302, and produces synthesized phonetic sound data by linking them together (S4514).

Voice output unit 4404 receives the synthesized phonetic sound data from voice synthesizer 4402, converts format of the data, and outputs it to a speaker or a headphone (S4515).

In this embodiment, memory device 4302 such as a memory card, optical disk and the like is used as a data entry unit. However, the data entry unit may be a network interface such as modem, and a keyboard. In addition, although communication processor 4409 is disposed within the main body of terminal device (201), it may be mounted to memory device 4302, so that memory device 4302 downloads and stores therein the phonemic database, the voice synthesis subject data and the voice synthesizing program from the server device on the network.

Moreover, the voice synthesis subject data needs not be limited only to text data such as novels, but it may be a music data having a score data (musical score) and text data (lyrics), so as to allow the user to select his/her favorite character and music data using main terminal device 4301, and listen to the music in voice of the favorite character of the user by processing voice synthesis based on phonemic database of the character and the music data.

### Exemplary Embodiment 19

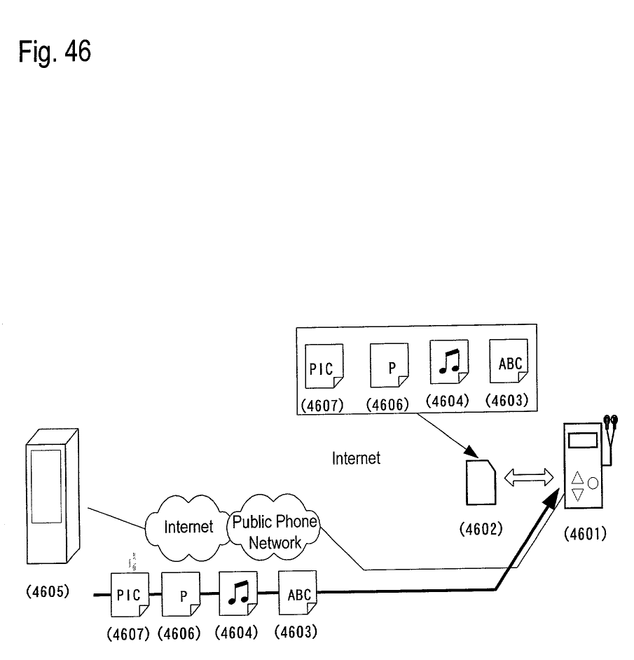

FIG. 46 is a configuration diagram showing a communication system having a portable information terminal of the present exemplary embodiment. Portable terminal device 4601 is provided with a display unit, an operation unit, an amplifier, and a voice output unit such as a headphone, speaker, and the like. Memory device 4602 such as a memory card, optical disk, magnetic disk and the like stores voice synthesis subject data, phonemic database for voice of unique characters, a voice synthesizing program, and image data such as illustrations. Memory device 4602 is detachable from portable terminal device 4601.

Voice synthesis subject data 4603 in the portable information terminal is a text data such as a novel and the like. Phonemic database 4604 is constructed of sampled data taken from natural voice of a real character, and formed into a database. It plays an important role in determining tone of synthetic sound output by this device.

Server device 4605 (205) on the Internet provides voice synthesis subject data such as text data of a novel and the like, phonemic database, voice synthesizing program and/or image data. Although shown here is only one server device, there may be cases in that individual data are provided separately by a plurality of server devices.

Voice synthesizing program 4606 is provided by server device 4605 on the Internet, and executed in the portable information terminal. Image data 4607 represents such data as illustrations and the like associated with the voice synthesis subject data.

A user first inserts memory device 4602, which stores phonemic database for voice of unique characters, voice synthesis subject data, the voice synthesizing program and/or image data, into main terminal device 4601, and activates a replay function to carry out voice synthesis processing with the phonemic database of his/her favorite character. Thus, the user can listen to reading of the voice synthesis subject data in such voice as if it were spoken by the real character.

Alternatively, the user can access server device 4605 on the Internet, downloads a text data such as a novel of his/her choice and phonemic database of his/her favorite character by selecting them, and activates replay function to listen to reading of the voice synthesis subject data in voice just as it were spoken by the real character. In this instance, a service provider analyzes sampled data of voice spoken by a number of characters, extracts data in the vocal sound relative to strength, pitch and the like of the sound, and keeps them available as phonemic database in server device 4605.

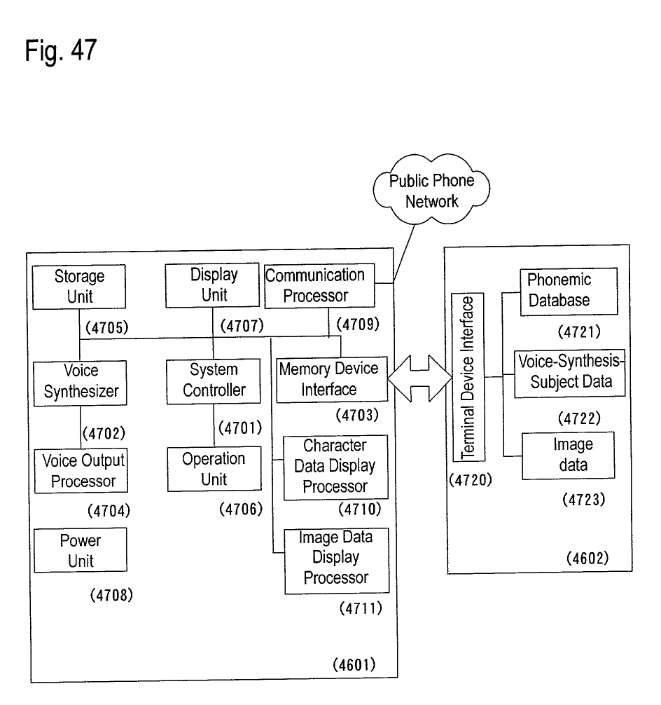

FIG. 47 is a block diagram of this portable information terminal. In FIG. 47, memory device 4602 is a storage device connectable to main terminal device 4601.

With respect to main terminal device 4601, system controller 4701 provided within main terminal device 4601 exchanges data with individual processors in the device, and controls the entire device. Voice synthesizer 4702 analyzes the voice synthesis subject data, extracts the most suitable phonemic data for the synthetic subject data (for each of character data or word data), and links them together. Memory device interface 4703 writes/reads data in and out of memory device 4602.

Voice output unit 4704 receives data from voice synthesizer 4702, carries out a process such as format conversion and the like of the data, converts the data from digital form into analog form, removes undesired noises, and outputs the data through a speaker, headphone, or the like. Storage unit 4705 in the portable terminal device stores a program for controlling the terminal device , font data used for display in display unit 4707 as well as synthesized phonetic sound data, and it is also used as a work space when processing a variety of data.

The user gives his/her command to the device through operation unit 4706. Display unit 4707 displays an operating status of the device, the voice synthesis subject data, image data such as illustrations, and the like for the user. Power unit 4708 supplies electric power to the device. Communication processor 4709 makes connection to a public telephone network, and exchanges data over the Internet.

Character data display processor 4710 gives a display of the voice synthesis subject data whose synthesized phonetic sound is being delivered. Image data display processor 4711 gives a display of illustration or image that corresponds to substance of a portion of the synthesized phonetic sound being delivered. Terminal device interface 4720 communicates with memory device interface 4703 to exchange data with terminal device 4602.

Next, memory device 4602 stores phonemic database 4721 and voice synthesis subject data 4722. Image data 4723 represents such data as illustrations associated with the voice synthesis subject data. In this embodiment, memory device 4602 and storage unit in the terminal device may individually store any combination of the voice synthesis subject data, the phonemic database, the voice synthesizing program, and the image data.

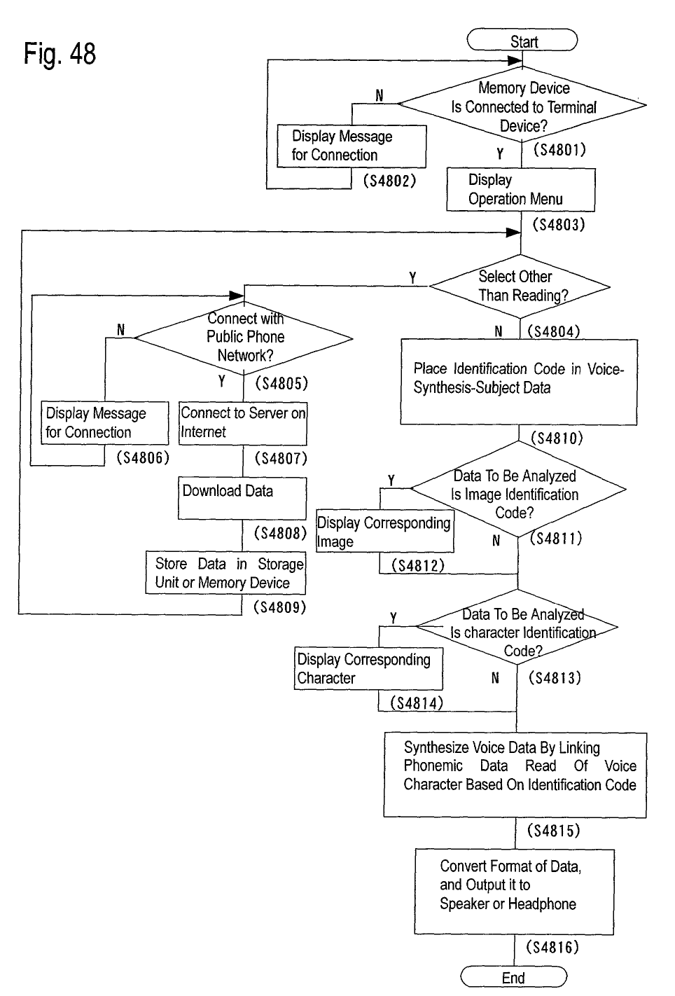

The portable information terminal of this invention operates in a manner, which will be described hereinafter with reference to an operational flowchart shown in FIG. 48. When the user turns on the power supply of the device with operation unit, system controller 4701 gives a command to memory device interface 4703 to check whether or not memory device 4602 is in connection with main terminal device 4601 (S4801). If it is not connected, system controller 4701 displays in display unit 4707 a message such as “insert a memory card” to urge the user to connect memory device 4602 to main terminal device 4601 (S4802).

If memory device 4602 is in connection to main terminal device 4601, system controller 4701 displays in display unit 4707 another message such as “operation menu 1. reading, 2. program update, 3. download voice synthesis subject data, 4. download character's voice data, 5. download image data, and so on” to urge the user to operate further with the terminal device (S4803). System controller 4701 monitors a status of operation being input through operation unit 4706.

When the user plays with operation unit 4706 to select any function other than reading (S4804), system controller 4701 checks whether main terminal device 4601 is in connection to public telephone network through communication processor (S4805). If it is not connected, system controller 4701 displays in display unit 4707 a message such as “connect to the network” to urge connection to the network (S4806).

If main terminal device 4601 is connected to the public network, system controller 4701 access server device 4605 on the Internet through communication processor 4709 (S4807). System controller 4701 in main terminal device 4601 requests server device 4605 to download any of the voice synthesizing program, the voice synthesis subject data, the phonemic database and image data (S4808). When server device 4605 transfers the data, system controller 4701 stores the data in any of storage unit 4705 and memory device 4602 (S4809). System controller 4701 disconnects the call to server device 4605 upon completion of the above process.

When the user selects a reading function through operation unit 4706 (S4804), system controller 4701 displays in display unit 4707 a list of the voice synthesis subject data as well as a list of the voice characters stored within the device. When the user makes his/her selection of any of the voice synthesis subject data using operation unit 4706 (S4810), character data display processor 4710 reads the voice synthesis subject data 4722 from storage unit 4705 or memory device 4602, places a character display identification code for each section covering a predetermined number of characters that can be displayed in a display area of display unit 4707, in a coexisting manner with the voice synthesis subject data, and stores it in either storage unit 4705 or memory device 4602 (S4810). The character display identification code is used to display in display unit 4707 the synthesis subject data, e.g. characters, being output as synthesized phonetic sound.

There are a number of ways to place the character display identification code into the voice synthesis subject data in a coexisting manner therewith. For instance, one each of the identification codes may be placed to the first and the last character data in a manner to bracket character string to be displayed, or one identification code may be placed only to the first character data, and these methods are not restrictive.

Next, voice synthesizer 4702 reads out the data processed by character data display processor, and converts the voice synthesis subject data, when necessary, into data of other format processable for voice synthesis. It then checks if the data being synthesis-analyzed is an image display identification code (S4811). The image display identification code is intended to display an image data corresponding to substance of the synthesis subject data, or one that helps the user to comprehend the synthesis subject data being output as synthesized phonetic sound. The image display identification code may be placed in advance into the synthesis subject data. Or, image data display processor 4711 may be given a task of placing an identification code representing an image data suitable for the synthesis subject data, by analyzing the synthesis subject data, and selecting the image data.

If the data being analyzed is the image display identification code, voice synthesizer 4702 passes on meaning of the code to image data display processor 4711. Image data display processor 4711 reads out an image data corresponding to the meaning of the code from storage unit 4705 or memory device 4602, and displays it in display unit 4707 (S4812).

If the data is not an image display identification code, voice synthesizer 4702 checks to verify whether it is a character display identification code (S4813). If it is a character display identification code, voice synthesizer 4702 forwards the code to character data display processor 4710. Character data display processor 4710 displays in display unit 4707 the forwarded a character data string bracketed by the identification codes, or a section containing the predetermined number of characters displayable in the display area following the code placed to the first character thereof (S4814).

If the data being analyzed is not a character display identification code, the data is assumed to be the voice synthesis subject data. Hence voice synthesizer 4702 reads a phonemic data most suitable to that data out of storage unit 4705 or memory device 4602, and produces synthesized phonetic sound data by linking them together (S315).

Voice output unit receives the synthesized phonetic sound data produced by voice synthesizer 4702, converts format of the data, and outputs it as synthetic voice from a speaker or a headphone (S4816).

In this embodiment, memory device 4602 such as a memory card, optical disk and the like is used as a data entry unit. However, the data entry unit may be a network interface such as modem, and a keyboard. In addition, although communication processor 4709 is mounted within the main body of terminal device 4601, it may be mounted to memory device 4702, so that memory device 4602 downloads and stores therein the phonemic database, the voice synthesis subject data, the voice synthesizing program and the image data from the server device on the network.

### Exemplary Embodiment 20

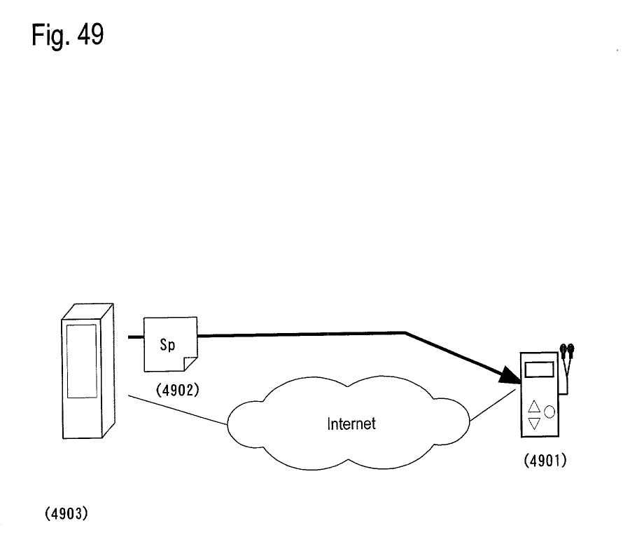

FIG. 49 is a configuration diagram showing a reading system of the present exemplary embodiment. Portable terminal device 4901 is provided with a display unit, an operation unit, a voice output unit such as a headphone, speaker, and the like. Synthesized phonetic sound data 4902 composed of character's voice and synthesis subject data selected by a user is provided by server device 4903 to the user.

First, the user accesses server device 4903 on the Internet through portable terminal device 4901, and selects synthesis subject data defining text data of a novel and the like, and character's voice of his/her choice. Server device 4903 voice-synthesize the synthesis subject data with phonemic database of the character selected by the user, and transmits synthesized phonetic sound data to the user over the Internet. The user stores the data in the portable terminal device. When the user activates a replay function, the portable terminal device outputs synthesized phonetic sound of the text data in voice of his/her favorite character.

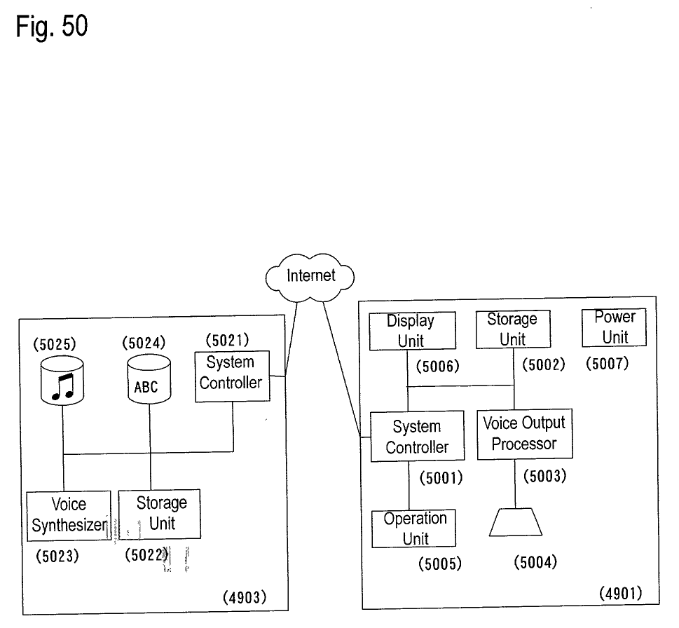

FIG. 50 is a detailed illustration of portable terminal device 4901 and server device 4903. In FIG. 50, system controller 5001 in the portable terminal device exchanges data with individual processors within the device, and controls the entire device. It also includes a network communication function to communicate over the Internet. Storage unit 5002 in the portable terminal device stores a control program of the portable terminal device, font data to be displayed in display unit as well as synthesized phonetic sound data sent from server device 4903, and it is also used as a work space for executing a variety of tasks. Voice output processor 5003 converts the data from digital form into analog form, removes undesired noises, and outputs the data to speaker 5004. The user gives the device his/her command through operation unit 5005. Display unit 5006 displays an operating status and the like of the device for the user. Power unit 5007 supplies electric power to the device.

System controller 5021 in the server device exchanges data with individual processors within the device, and controls the entire device. It also includes a network communication function to communicate over the Internet. Storage unit 5022 in the server device stores a control program of the server device, and it is also used as a work space for executing a variety of tasks. Voice synthesizer 5023 analyzes the synthesis subject data, extracts the most suitable phonemic data for each of character data, links them together, and converts the data into format acceptable to voice output processor 5003 in the portable terminal device. Synthesis subject data memory 5024, stores a plurality of synthesis subject data such as text data for novels and the like. Phonemic database memory 5025 stores phonemic database for a plurality of unique characters.

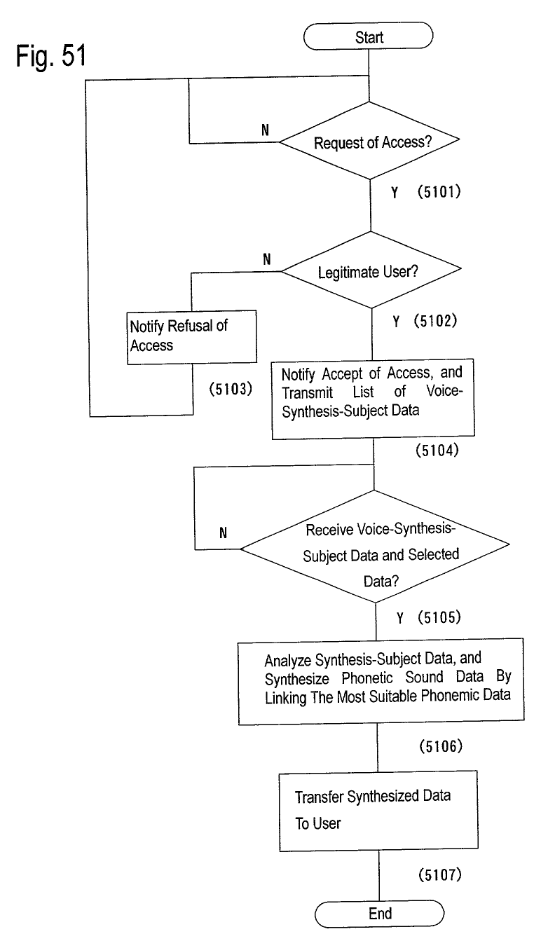

The reading system operates in a manner as described in detail below. Described first pertains to an internal operation when the user downloads synthesized phonetic sound data from the server device. FIG. 51 is a flowchart showing operation of the reading system. Initially, the server device waits for a request of access from the user (S5101). When the user sends a request of access using his/her user ID, password, and the like, system controller 5021 in the server device verifies as to whether the user requesting the access is a legitimate user (S5102). If he/she is not a legitimate user, system controller 5021 notifies refusal of the access to the user (S5103). If he/she is a legitimate user, system controller 5021 accepts the access, and transfers to him/her a listing information of synthesis subject data stored in synthesis subject data memory 5024 as well as voice characters stored in phonemic database memory 5025 (S5104). When system controller 5021 of the server device receives a request data of synthesis subject data and voice character data selected by the user as his/her choice (S5105), it brings voice synthesizer 5023 into processing. Voice synthesizer 5023 analyzes the synthesis subject data while reading them out one after another from storage unit 5022 of the server device, reads out phonemic data most suitable for each of character data from storage unit 5022, and produces synthesized phonetic sound data by linking them together (S5106). It then transfers the synthesized phonetic sound data to the user (S5107). In this way, the user can obtain the synthesized phonetic sound data constructed of his/her desired synthetic subject data with voice of his/her favorite character.

Described next pertains to reproduction of the synthetic sound in the portable terminal device. When storage unit 5002 of the portable terminal device completes storage of the entire synthesized phonetic sound data, system controller 5001 waits for the user to push a replay button on operation unit 5005. When the button is pushed, system controller 5001 activates voice output processor 5003. Voice output processor 5003 reads the synthesized phonetic sound data consecutively out of the storage unit 5002, converts them into analog voice, and outputs the voice to speaker 5004.

The user can thus listen to reading of the text data and the like in the voice of his/her favorite character.

### Exemplary Embodiment 21

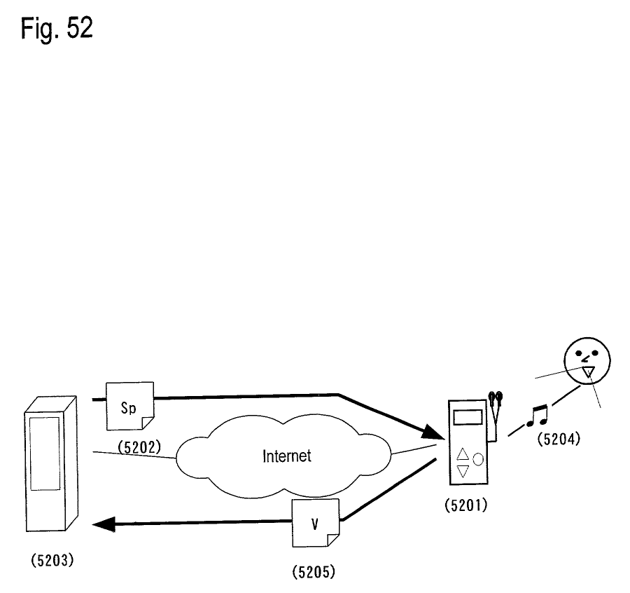

FIG. 52 is a configuration diagram showing a reading system of the present exemplary embodiment. Components 5201 through 5203 are analogous to components 4901 through 4903 of FIG. 49 discussed in exemplary embodiment 20. A user registers natural human voice 5204. Sampled human voice data 5205 is thus taken into portable information terminal.

First, the user uses portable terminal device 5201 to input to therein human voice 5204 that he/she desires to register. He/she then accesses server device 5203 over the Internet, and transfers sampled human voice data 5205 to server device 5203. Server device 5203 carries out a process of voice registering, and it registers sampled human voice data 5205 as a phonemic database. Using portable terminal device 5201, the user selects his/her desired synthetic subject data along with the sampled human voice data that he/she registered in advance as character's voice. Server device 5203 carries out a necessary process in response to the selection of the user, and transmits synthesized phonetic sound data 5202 to the user's portable terminal device 5201. Accordingly, the user is able to listen to reading of the selected synthetic subject data such as a text data and the like in voice of the character he/she has registered from portable terminal device 5201, by downloading synthesized phonetic sound data 5202 into portable terminal device 5201 and activating replay function.

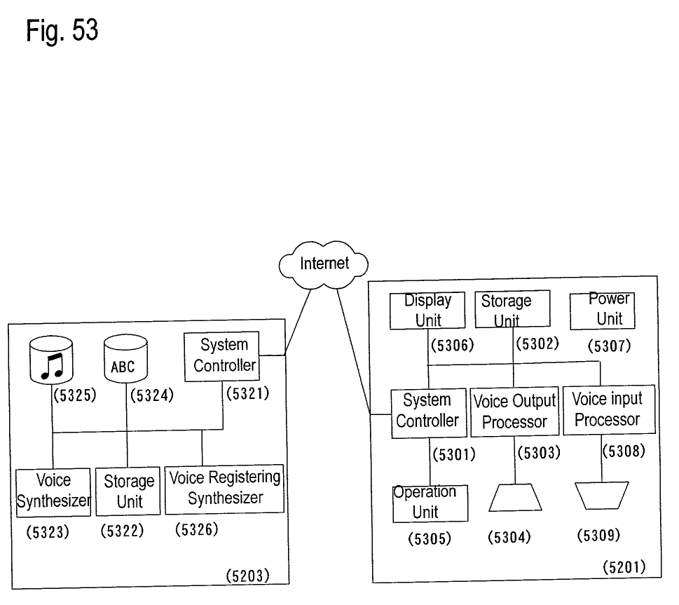

FIG. 53 is a detailed illustration of portable terminal device 5201 and server device 5203. In FIG. 53, components 5301 through 5307 are analogous to corresponding components 5301 through 5307 shown in FIG. 50 discussed in embodiment 20. Reference numeral 5309 represents a microphone for the user to input natural human voice for registering, and reference numeral 5308 is a voice input processor for sampling analog data of the human voice taken from the microphone, and converting it into digital data. Components 5321 through 5325 are analogous to corresponding components 5021 through 5025 of FIG. 50 discussed in embodiment 20. Reference numeral 5326 represents a voice registering processor for analyzing the digital voice data converted by voice input processor 5308 of portable terminal device 5201, and for producing phonemic database.

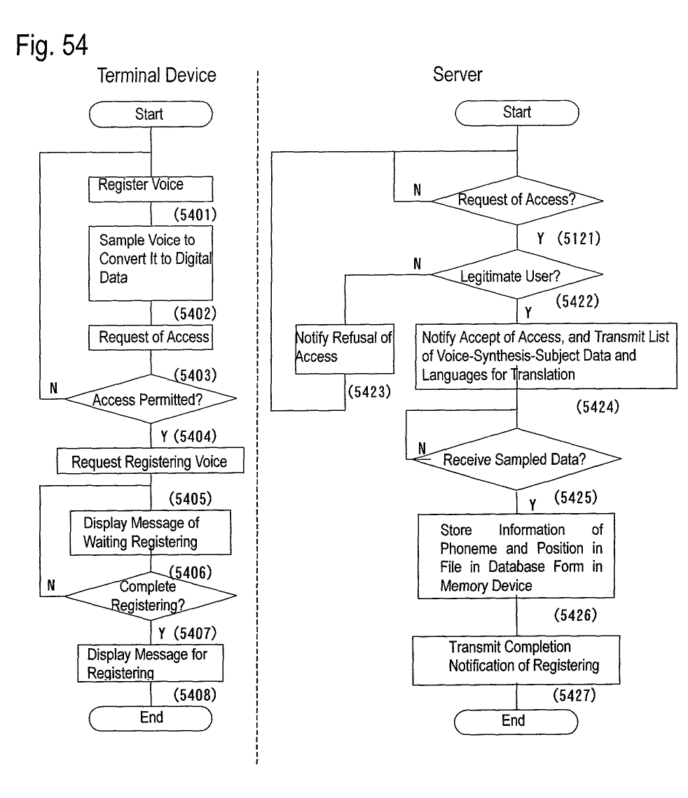

The reading system of this exemplary embodiment operates in a manner as described hereinafter in detail. FIG. 54 is a flowchart showing operation of the reading system. Described below is an operation up to the voice registering process. The system operates in the same manner as that described in embodiment 20 with reference to FIG. 51 for the user to obtain synthesized phonetic sound data from the server device, and to replay the phonetic sound data in the terminal device, and their details will therefore be skipped here.

When the user plays operation unit 5305 for voice registering in portable terminal device 5201 (S5401), system controller 5301 in the portable terminal device activates voice input processor 5308 to sample the analog voice data input through microphone 5309, converts it into digital data (S5402), and registers it in storage unit 5302 in the portable terminal device. Server device 5203 waits for a request of access from the user (S5121). When the user gives a request of access by sending his/her user ID, password and the like (S5403), system controller 5321 in server device 5203 verifies whether or not the user who has given the request is a legitimate user (S5422). It notifies the user a refusal of access if he/she is not a legitimate user (S5423). If he/she is the legitimate user, system controller 5321 notifies permission of access (S5424). When terminal device 5201 receives a message of the permission from server device 5203 (S5404), it reads the sampled human voice data from storage unit 5302, and transmits it to server device 5203 . When server device 5203 receives the data from the user (S5425), it stores the received data into storage unit 5322. Following the above process, voice registering processor 5326 analyzes the voice data stored in storage unit 5322 by reading it out one after another, labels them to identify information such as a duration and fundamental frequency of sound for each of phoneme, data related to power, etc. of the sound, name of data file to which the phoneme belongs, and a starting position and an ending position of the phoneme within the file, and the like, registers them in storage unit 2902 after forming them into database of appropriate format, and completes registering of the voice the user has input through the terminal device (S5426). Server device 5203 then transmits to the user a completion notification of the registering (S5427). The terminal device, while waiting for a completion notification of the registering from the server device, displays in display unit 5306 a message such as “voice registering in progress” or the like (S5406, S5407). When the terminal device receives a completion notification of the registering from the server device, system controller (S5301) displays in display unit 5306 a message indicating that the registering is completed (S5408).

When the user selects the registered voice as a character's voice used for reading, the portable terminal device outputs synthesized phonetic sound as it operates in a similar manner as described in embodiment 20. The user can thus listen to the desired text data with the character's voice registered by himself/herself.

### Exemplary Embodiment 22

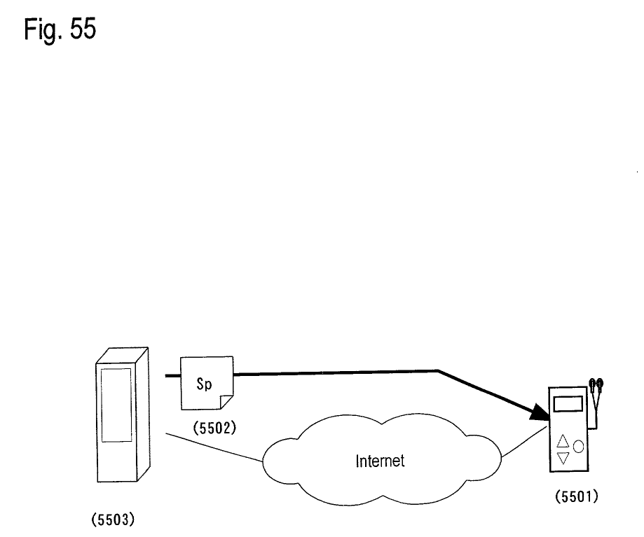

FIG. 55 is a configuration diagram showing a reading system of the present exemplary embodiment. Components 5501 through 5503 are analogous to components 4901 through 4903 of FIG. 49 discussed in embodiment 20.

A user accesses server device 5503 on the Internet through portable terminal device 5501, and selects his/her desired synthesis subject data such as a novel and the like, a language for reading, and character's voice of his/her choice. Server device 5503 carries out a necessary process for voice synthesis using the language, synthesis subject data and phonemic database of the character selected by the user, and transmits synthesized phonetic sound data to the user over the Internet. The user stores the data in the portable terminal device. When the user activates a replay function, the portable terminal device outputs synthesized phonetic sound of the synthesis subject data in the desired language and voice of the character he/she has specified. The user can thus listen to reading of the text data and the like in language and voice of the character he/she desires.

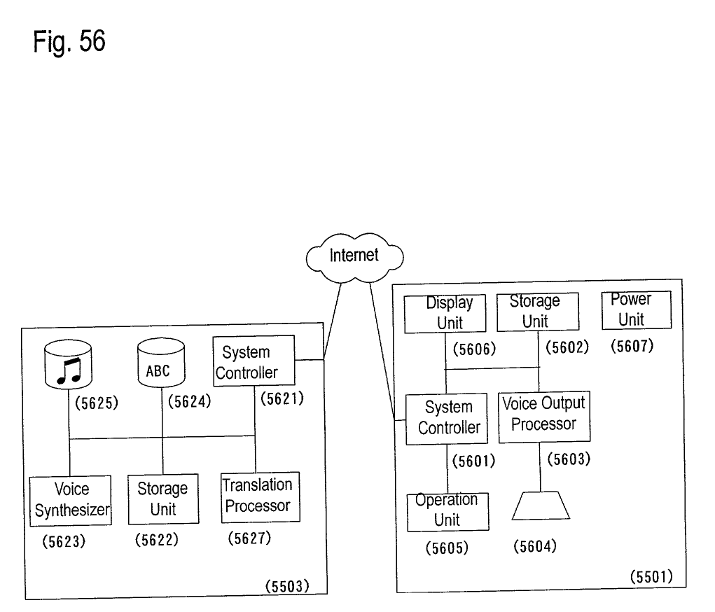

FIG. 56 is a detailed illustration of portable terminal device 5501 and server device 5503. In FIG. 56, components 5601 through 5607 are analogous to components 5001 through 5007 of FIG. 50 described in embodiment 20. In addition, components 5621 through 5625 are analogous to components 5021 through 5025 of FIG. 50, also described in embodiment 20. Reference numeral 5627 is a translation processor for converting the original synthesis subject data into data of another language desired by the user.

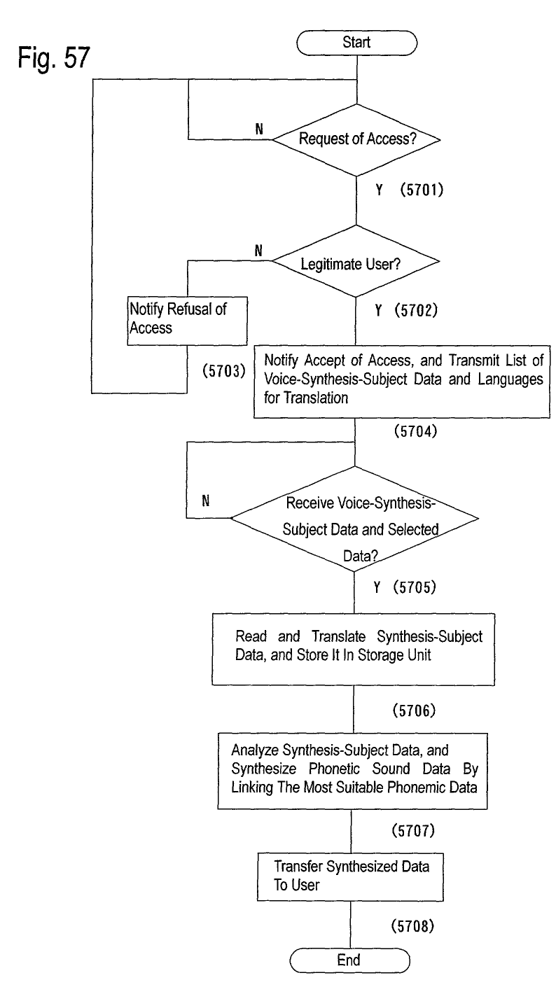

In this exemplary embodiment, the reading system operates in a manner as described in detail below. FIG. 57 is a flowchart showing operation of the reading system. Initially, the server device waits for a request of access from the user (S5701). When the user sends a request of access using his/her user ID, password, and the like, system controller 5621 in the server device verifies as to whether the user making access is a legitimate user (S5702). If he/she is not a legitimate user, system controller 5621 notifies refusal of the access to the user (S5703). If he/she is a legitimate user, system controller 5621 accepts the access, and transfers to him/her a listing information of synthesis subject data stored in synthesis subject data memory 5624, as well as voice characters and languages available for translation stored in phonemic database memory 5625 (S5704). When server device 5503 receives a request data of the synthesis subject data, voice character data and translation language selected by the user as his/her choice (S5705), system controller 5621 brings translation processor 5627 into processing. Translation processor 5627 analyzes the synthetic subject data, and translates the data into another synthetic subject data in the language selected by the user while storing the translated data one by one into storage unit 5622 (S5606). Following the above process, system controller 5621 in the server device starts voice synthesizer 5623 into processing. Voice synthesizer 5623 analyzes the synthetic subject data while reading it one after another from storage unit 5622 in the server device, reads out from storage unit 5022 phonemic data most suitable for each of character data, and produces synthesized phonetic sound data by linking them together (S5707). It then transfers the synthesized phonetic sound data to the user (S5107). In this way, the user can obtain synthesized phonetic sound data composed of his/her desired synthetic subject data with voice of his/her favorite character.

When the user takes the synthesized phonetic sound data into his/her terminal device and replays it, the terminal device outputs synthesized phonetic sound.

The user can thus listen to reading of the text data and the like in the desired language and voice of his/her favorite character.

### Exemplary Embodiment 23

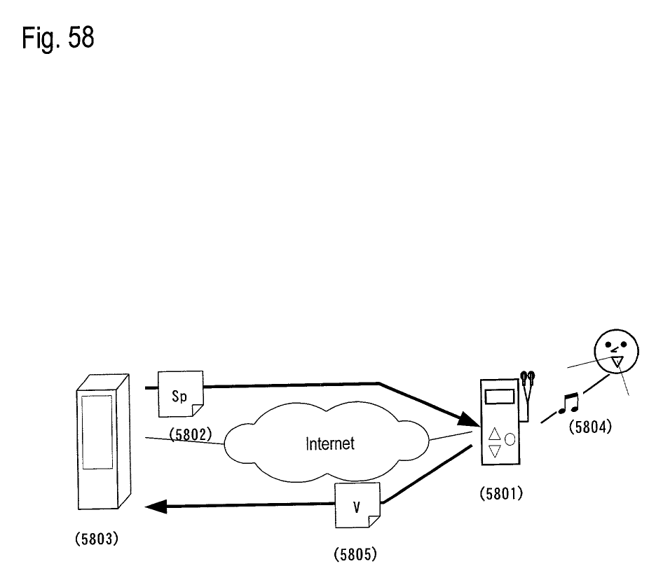

FIG. 58 is a configuration diagram showing a reading system of the present exemplary embodiment. Components 5801 through 5804 are analogous to components 5201 through 5204 of FIG. 52 discussed in embodiment 21.

A user registers natural voice of a character that he/she desires to register in the like manner as described in embodiment 21. The user then selects synthetic subject data such as his/her desired novel and the like along with language used for reading and character's voice that he/she has registered, in the same manner as discussed in embodiment 22. Server device 5203 carries out necessary processes for voice synthesis using the selected language, synthesis subject data and phonemic database of the character registered by the user, and transmits a result developed to the user over the Internet. The user stores the data in the portable information terminal. When the user initiates a replay process, the information terminal outputs synthesized voice of the synthesis subject data in the specified language and voice of the character he/she has registered. The user can thus listen to reading of the text data and the like in the language and voice of his/her favorite character.

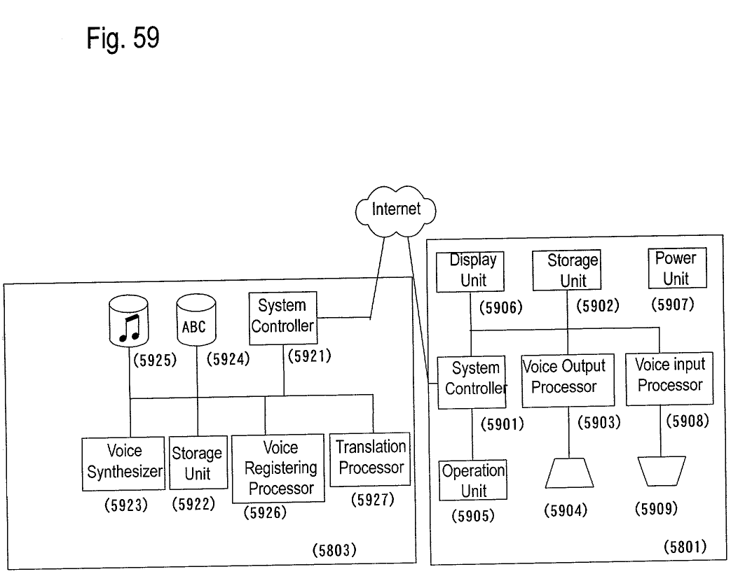

FIG. 59 is a detailed illustration of portable terminal device 5801 and server device 5803. In FIG. 59, components 5901 through 5909 are analogous to corresponding components 5301 through 5309 shown in FIG. 53 discussed in embodiment 21. In addition, components 5921 through 5926 are analogous to components 5321 through 5326 of FIG. 53, also described in embodiment 21. Furthermore, component 5927 is analogous to component 5627 of FIG. 56 in embodiment 22.

Details as to how portable terminal device 5801 and server device 5803 operate internally in the voice registering process is same as that described in embodiment 22, and in the translation process as that described in embodiment 23. Details of their operations are therefore skipped. As a result, the user can listen to reading of a text data and the like in the desired language and voice of the character that he/she has registered.

### Exemplary Embodiment 24

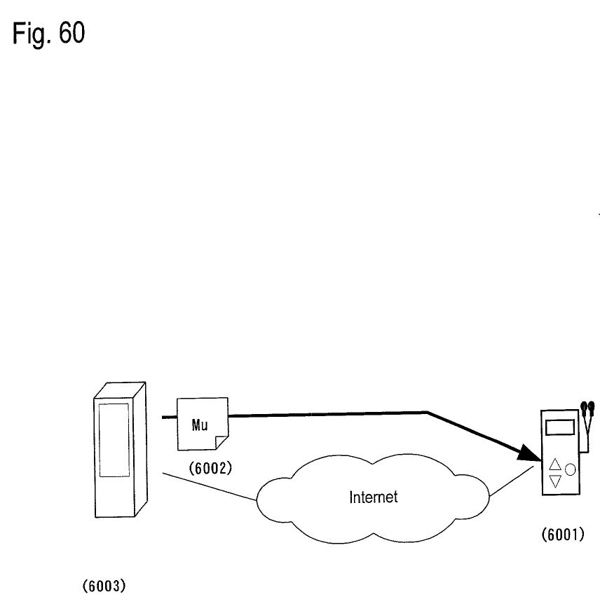

FIG. 60 is a configuration diagram showing a reading system of the present exemplary embodiment. In FIG. 60, components 6001 through 6003 are analogous to components 4901 through 4903 of FIG. 49 described in embodiment 20. Reference numeral 6002 represents music data provided for portable terminal device 6001 by server device 6003.

First, a user accesses server device 6003 over the Internet, and selects a music he/she likes to listen and a character by whom he/she desires the music sung. In response to the user's request, server device 6003 analyzes musical score data, voice-synthesis lyrics data of the selected music with a phonemic database of the selected character according to the analyzed sound data, and forwards the resulted data to the user over the Internet. The user can listen to the music with voice of his/her favorite character when he/she takes the music data into his/her portable terminal device 6001 and initiates a replay function.

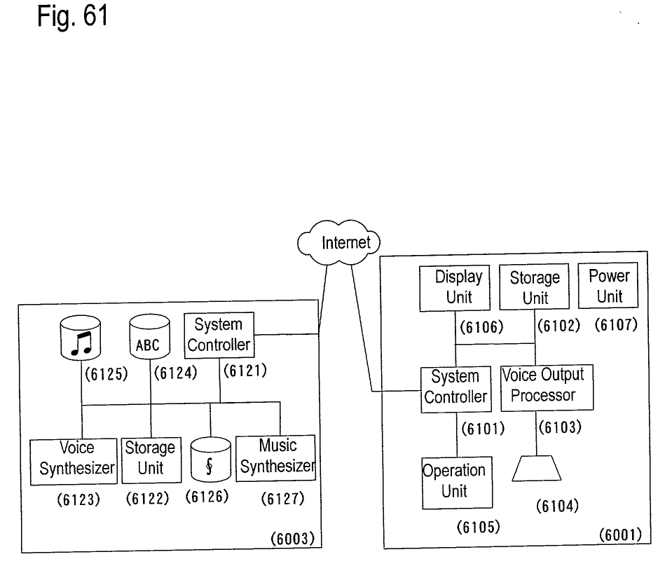

FIG. 61 is a detailed illustration showing portable terminal device 6001 and server device 6003. In FIG. 60, components 6101 through 6107 in the portable terminal device are analogous to corresponding components 5001 through 5007 of FIG. 50 described in embodiment 21. Also, components 6121 through 6125 in the server device are analogous to corresponding components 5021 through 5025 of FIG. 50. Reference numeral 6126 represents a musical score data memory for storing musical score data of the music. Reference numeral 6127 represents a music synthesizer for analyzing musical score data for such information as pitch, duration, and the like of individual tones that compose the music.

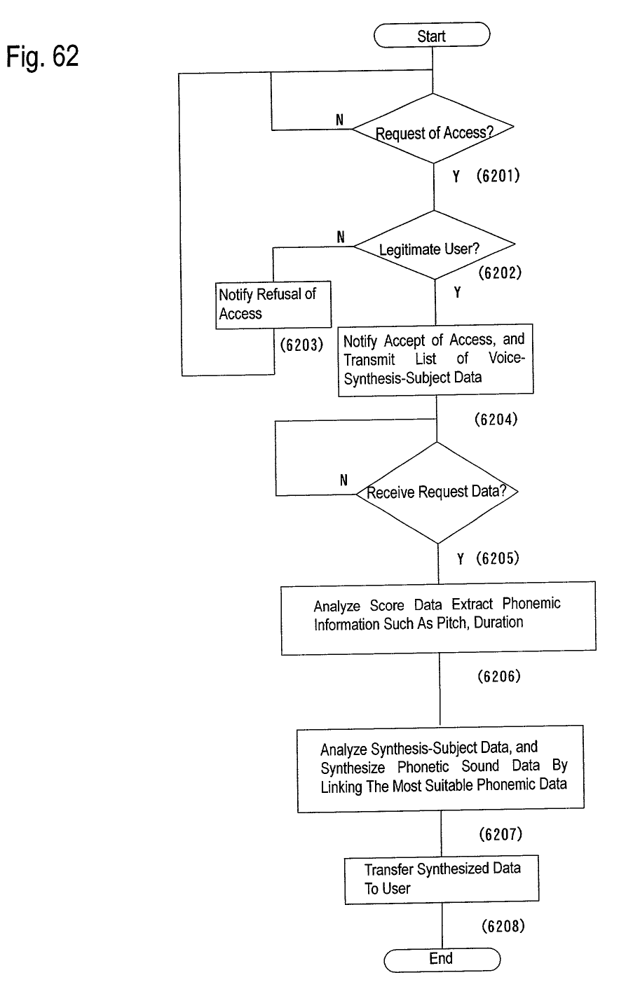

FIG. 62 is a flowchart showing operation of the reading system of this exemplary embodiment. Initially, the server device waits for a request of access from the user (S6201). When the user sends a request of access using his/her user ID, password, and the like, system controller 6121 in the server device verifies as to whether the user making access is a legitimate user (S6202). If he/she is not a legitimate user, system controller 6121 notifies refusal of the access to the user (S6203). If he/she is a legitimate user, system controller 6121 accepts the access, and transfers to him/her a listing information of synthesis subject data (lyrics data) stored in synthesis subject data memory 6124 and voice characters stored in phonemic database memory 6125 (S6204). When server device 6003 receives a request data of the music data and voice character data selected by the user as his/her choice (S6205), system controller 6121 reads an appropriate musical score data from musical score data memory 6126 and registers it in storage unit 6122 within the server device. Music synthesizer 6127 then reads the musical score data one after another, analyzes them to extract phonemic information such as pitch, duration, and the like of individual tones that compose the music (S6206). Next, system controller 6121 issues a command to read synthetic subject data representing lyrics data of the corresponding music, and stores the data into storage unit 6122. System controller 6121 then sends another command to voice synthesizer 6123 to initiate the processing. Voice synthesizer 6123 analyzes the synthetic subject data while reading them out one after another from storage unit 6122, it then reads out the most suitable phonemic data from phonemic data memory 6125 according to the phonemic information extracted by the music synthesizer, and produces synthesized phonetic sound data (music data) by linking them together (S6207). It transmits this synthesized phonetic sound data to the user (S6208).

In this way, the user can obtain the synthesized phonetic sound data composed of his/her desired synthetic subject data and the voice of his/her favorite character. When the user takes into his/her terminal device and replays the synthesized phonetic sound data, the terminal device reproduces synthesized phonetic sound (i. e. music). Thus, the user can listen to the music with voice of his/her favorite character.

### Exemplary Embodiment 25

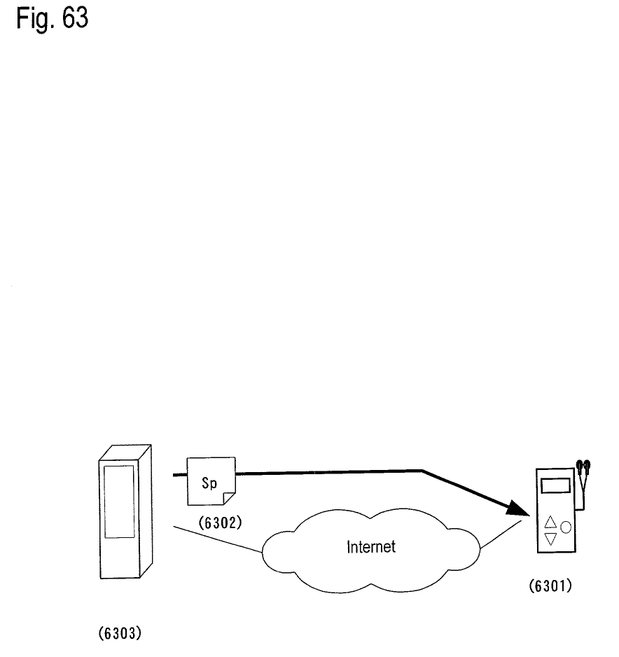

FIG. 63 is a configuration diagram showing a reading system of the present exemplary embodiment. In FIG. 63, components 6301 through 6303 are analogous to components 4901 through 4903 of FIG. 49 described in embodiment 20. In this reading system, information terminal outputs phonetic sound of synthesis subject data in voice of a substitute character, instead of voice of a character specified by the user, only for a certain string within the data, in order to prevent the device from being used illegitimately for the purpose of voice authentication and the like.

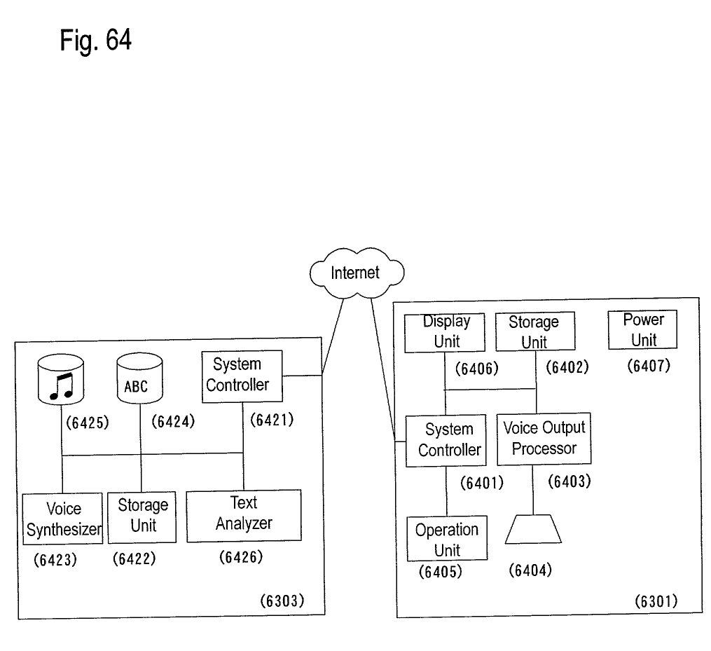

FIG. 64 is a detailed illustration of portable terminal device 6301 and server device 6303. Components 6401 through 6407 are analogous to corresponding components 4901 through 4907 of FIG. 49 described in embodiment 20. Also, components 6421 through 6425 in server device 6303 are analogous to components 4921 through 4925 of FIG. 49. Text analyzer 6426 browses the synthesis subject data to verify if it contains certain characters associated with monetary unit and numerical figures.

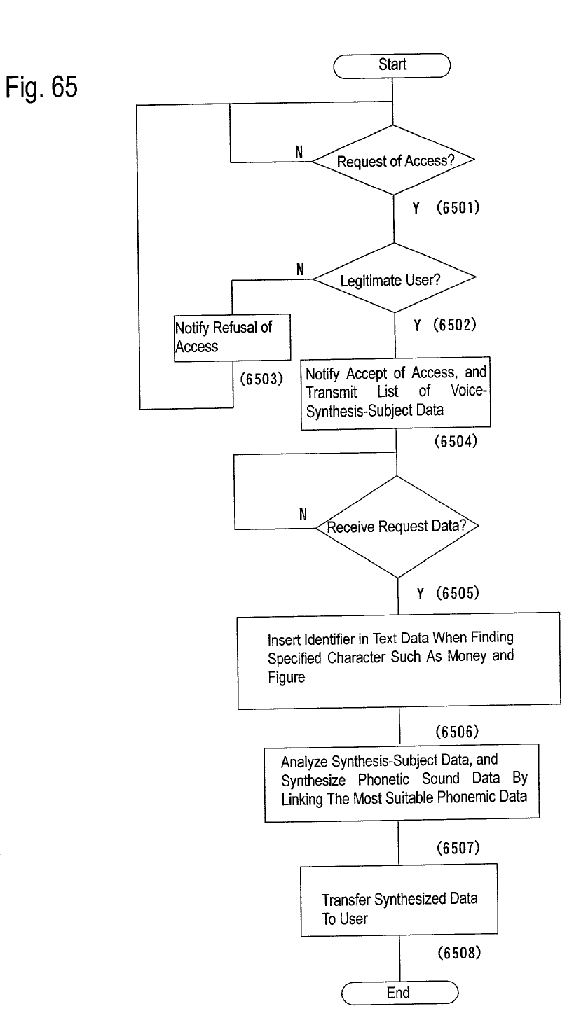

The reading system of the present exemplary embodiment operates in a manner which is described hereinafter. FIG. 65 is a flowchart showing operation of the reading system. Initially, the server device waits for a request of access from the user (S6501). When the user sends a request of access using his/her user ID, password, and the like, system controller 6421 in the server device verifies as to whether the user making access is a legitimate user (S6502). If he/she is not a legitimate user, system controller 6421 notifies refusal of the access to the user (S6503). If he/she is a legitimate user, system controller 6421 accepts the access, and transfers to him/her a listing information of synthesis subject data stored in synthesis subject data memory 6424 and voice characters stored in phonemic database memory 6425 (S6504). When server device 6303 receives a request data of his/her desired synthesis subject data and voice character data that he/she has selected (S6505), system controller 6421 in the server device reads the corresponding synthesis subject data from synthesis subject data memory 6424 and stores it in storage unit 6422 in the server device.

Text analyzer 6426 then analyzes texts of the synthetic subject data while reading them one after another from storage unit 6422. When text analyzer 6426 finds a certain character string having monetary unit, numerical figures and the like in any of the texts, it registers the text in storage unit 6422 after inserting an identifier having no influence to the voice synthesis processing into a leading end and a tail end of the character string (S6506). Following the above process, system controller 6421 in the server device issues a command to voice synthesizer 6423 to initiate the processing. Voice synthesizer 6423 analyzes the voice synthetic subject data while reading it one after another from storage unit 6422. Voice synthesizer 6423 uses phonemic database for voice of a character not specified by the user if the read data is bracketed with the identifiers, or it uses another phonemic database for voice of the character chosen by the user if the data is not bracketed.

Voice synthesizer 6423, while analyzing the synthetic subject data, reads out from phonemic database memory 6425 the most suitable phonemic data for the synthetic subject data, and produces synthesized phonetic sound data by linking them together (S6507). It then transfers the synthesized phonetic sound data to the user (S6508). When the user takes into his/her terminal device and replays the synthesized phonetic sound data, the terminal device reproduces synthesized phonetic sound.

According to this system, the device can read the synthesis subject data in voice of a substitute character for a certain character string in the data, instead of the voice of character specified by the user, so as to prevent the device from being used illegitimately for the purpose of voice authentication and the like.

### Exemplary Embodiment 26

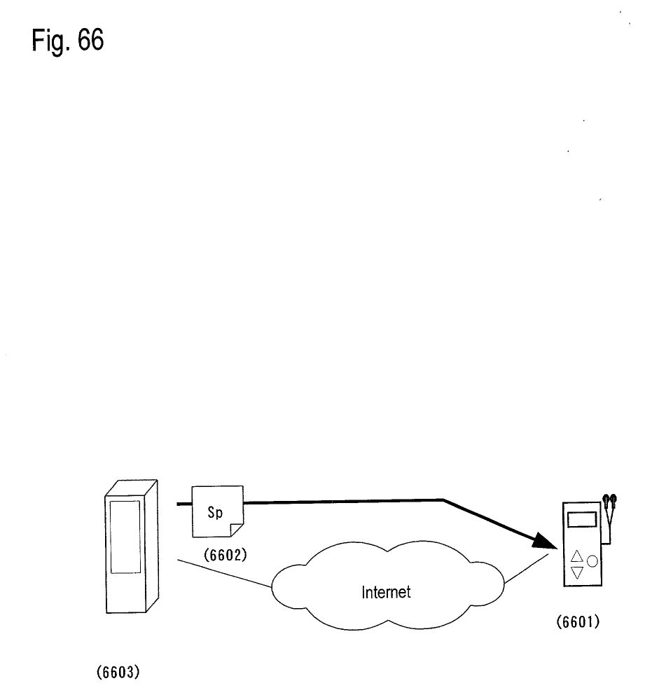

FIG. 66 is a configuration diagram showing a reading system of the present exemplary embodiment. In FIG. 66, components 6601 through 6603 are analogous to components 4901 through 4903 of FIG. 49 described in embodiment 20.

In this reading system, a portable information terminal compulsorily inserts a phonetic sound after every punctuation mark of comma and period, or at intervals of a predetermined number of characters,. The inserted sound indicates that the voice being output is synthetic sound, so as to prevent the device from being used illegitimately for the purpose of voice authentication and the like.

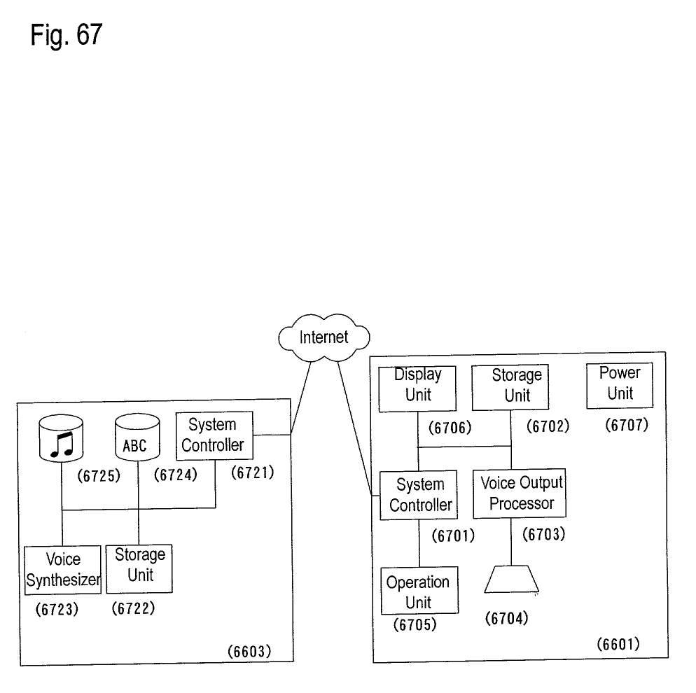

FIG. 67 is a detailed illustration of portable terminal device 6601 and server device 6603. Components 6701 through 6707 are analogous to corresponding components 4901 through 4907 of FIG. 49 described in embodiment 20. Also, components 6721 through 6725 in the server device are analogous to components 4921 through 4925 in FIG. 49.

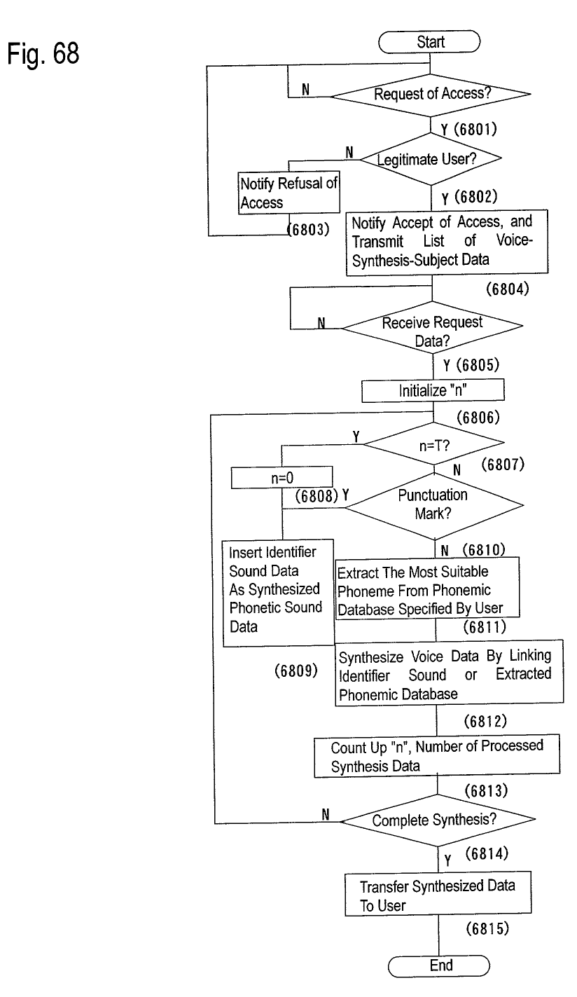

FIG. 68 is a flowchart showing an operation of the reading system. First, the server device waits for a request of access from the user (S6801). When the user sends a request of access using his/her user ID, password, and the like, system controller 6721 in the server device verifies as to whether the user making access is a legitimate user (S6802). If he/she is not a legitimate user, system controller 6721 notifies refusal of the access to the user (S6803). If he/she is a legitimate user, system controller 6721 accepts the access, and transmits to him/her a listing information of synthesis subject data stored in synthesis subject data memory 6724 and voice characters stored in phonemic database memory 6725 (S6804). When server device 6603 receives a request data of his/her desired synthesis subject data and voice character data that he/she has selected (S6805), system controller 6721 in the server device retrieves the corresponding synthesis subject data from synthesis subject data memory 6724 and registers it in storage unit 6722 in the server device.

Following the above, system controller 6721 in the server device issues a command to voice synthesizer 6723 to initiate the processing. Voice synthesizer 6723 analyzes the voice synthetic subject data while reading it one after another from storage unit 6722. At the start, voice synthesizer 6723 initializes variable “n” representing a number of synthesis-processed characters to be stored (S6806), and it then verifies whether the number of processed characters becomes equal to “T”, which is a number of characters after which identifier sound needs to be inserted (S6807). When the number becomes equal to the number “T”, voice synthesizer 6723 resets the variable “n” to zero (S6808), and inserts an identifier sound data as a synthesized phonetic sound data (S6809). If the number of processed characters has not reached the number “T”, for which the identifier sound is to be inserted, voice synthesizer 6723 verifies whether the character being processed is data signifying a punctuation mark such as comma or period (S6810). If it is, voice synthesizer 6723 inserts an identifier sound data as a synthesized phonetic sound data (S6809). If not, voice synthesizer 6723 extracts the most appropriate phoneme from the phonemic database for the voice of character selected by the user (S6811).

The voice synthesizer 6723 then produces synthesized phonetic sound data by consecutively linking the identifier sound data and the phonemic data extracted from the phonemic database (S6812). The voice synthesizer counts up the variable representing the number of characters that have been processed (S6813), and verifies whether or not it has synthesis-processed all of the synthetic subject data (S6814). If it has completed the synthesis processing, it transmits the synthesized phonetic sound data to the user (S6815). The terminal device outputs synthesized phonetic sound data when the user takes the synthesized phonetic sound data into his/her terminal device and replays it.

In this system, as has been described, the device is able to compulsorily insert a sound indicating that voice sound being output is synthetic sound, after every punctuation mark of comma and period, or at intervals of the predetermined number of characters in the text data, so as to prevent the device from being used illegitimately for the purpose of voice authentication and the like.

### Exemplary Embodiment 27

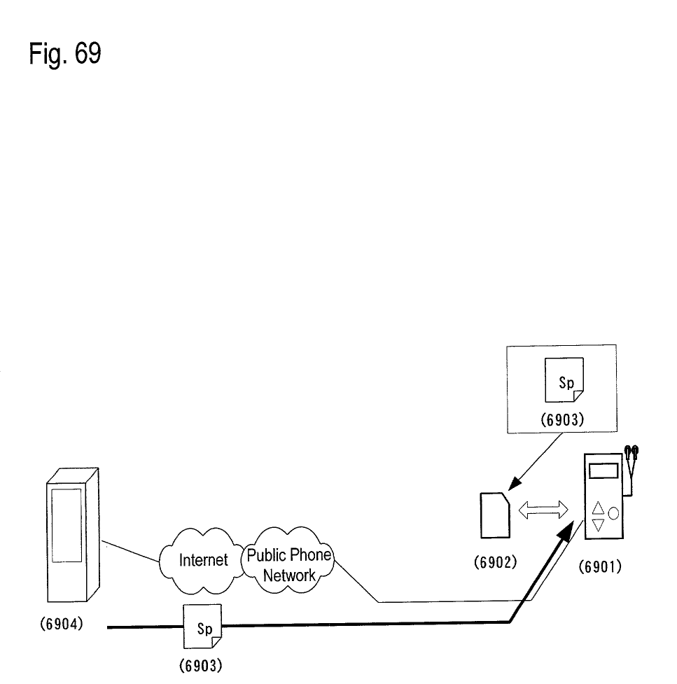

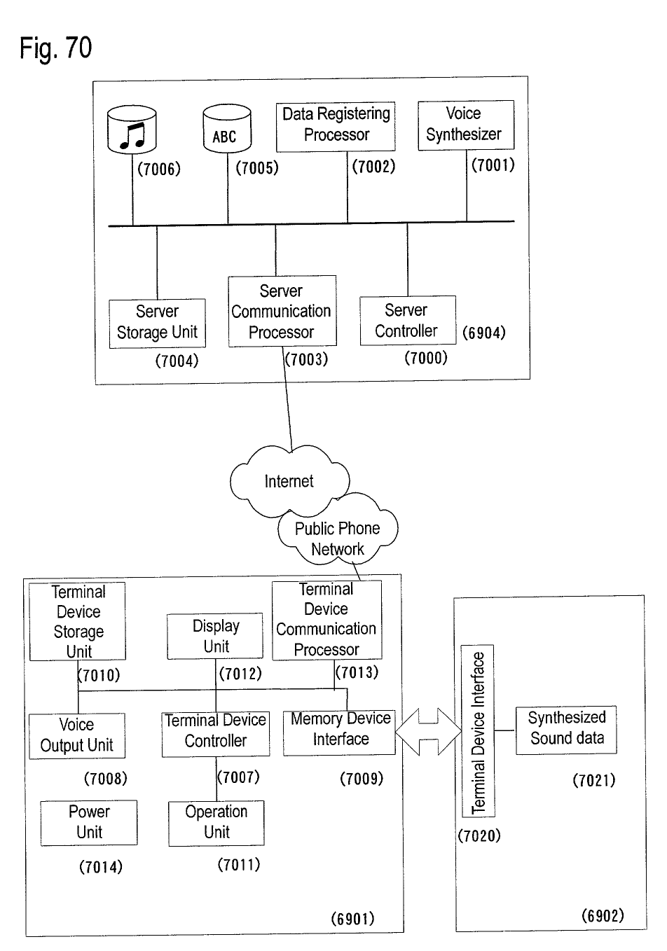

FIG. 69 is an illustrative diagram of a reading system. In FIG. 69 and FIG. 70, main terminal device 6901 is provided with synthesized sound data entry unit, an amplifier, and a voice output unit including a speaker, and the like. The synthesized sound data entry unit here implies such devices as a network interface like a modem and the like, and an interface for memory device capable of entering data to a registering medium such as an optical disk, magnetic disk, memory card and so forth. Memory device 6902 such as memory card, optical disk, magnetic disk, etc. stores voice synthesized phonetic sound data and the like, and it is detachable from main terminal device 6901. Synthesized phonetic sound data 6903 is delivered from a server. Server 6904 on the Internet voice-synthesizes voice synthesis subject data and phonemic database of a voice character specified by the user, and delivers synthesized phonetic sound data to the user.

As an instance, the user makes a communication with server 6904 over the Internet through main terminal device 6901, and selects a voice synthesis subject data stored in server 6904. The user further selects a voice character to be used for voice-synthesizing each of data sections in the selected voice synthesis subject data, such as speaking parts of characters, for example if the voice synthesis subject data is a novel or the like. Server 6904 voice-synthesizes the voice synthesis subject data using phonemic database of the selected voice character, and transfers synthesized phonetic sound data to the user by way of communication means. The user can listen to the synthetic voice in voice of the desired character by taking the synthesized phonetic sound data delivered from server 6904 into main terminal device 6901 via the synthesized sound data entry unit, and by reproducing it.

In this embodiment, server 6904 is not necessarily an entity on the Internet. Alternatively, a request of the user may be received off-line, through a telephone call, facsimile, mail, and/or by hand, and the synthesized phonetic sound data be delivered to the user in a registered storage medium such as an optical disk, magnetic disk, memory card, and the like.

FIG. 70 is a block diagram of the reading system. The reading system comprises main terminal device 6901, memory device 6902, and server 6904. Individual blocks of server 6904 will be described first.

In server 6904, server controller 7000 controls the entire server. Voice synthesizer 7001 analyzes the voice synthesis subject data, extracts the most suitable phoneme data to each of the data, and links them together. Phonemic database selector 7002 analyzes the voice synthesis subject data, extracts sections in the data whereto the voice characters are applied, and selects phonemic database for use in voice-synthesizing each of the data sections. Server communication processor 7003 performs such tasks as transferring synthesized phonetic sound data to users, and interfacing with the users. Server storage unit 7004 stores a program for controlling the entire server, and it is also used as a work space for processing a variety of data. Synthesis subject data memory 7005 registers the voice synthesis subject data. Phonemic database memory 7006 stores phonemic database of a variety of voice characters. The phonemic database is constructed of sampled data taken from natural voice of a real character, and formed into a database. It plays an important role in determining tone of the synthesized voice sound to be output.

Described next pertains to individual blocks of main terminal device 6901. In main terminal device 6901, terminal device controller 7007 exchanges data with individual components within the device, to control the entire device. Voice output unit 7008 carries out format conversion of the synthesized phonetic sound data, and outputs it to a speaker or a headphone. Memory device interface 7009 defining one of the synthesized sound data entry unit writes/reads data in and out of the memory device. Terminal device storage unit 7010 is used to store a program of the entire device, and as a work space for processing a variety of tasks. A user gives his/her command to the device through operation unit 7011. Display unit 7012 displays an operating status and the like of the device for the user. Terminal device communication processor 7013 receives synthesized sound data transferred from the server, and interfaces between server 6904 and main terminal device 6901. Power unit 7014 supplies electric power to the device.

Memory device 6902 defining another of the synthesized sound data entry unit has the following blocks, which are described hereinafter. Terminal device interface 7020 exchanges data with main terminal device 6901 through memory device interface 7009. Synthesized sound data 7021 is stored within the memory device.

The present system operates in a manner of which details are described below.

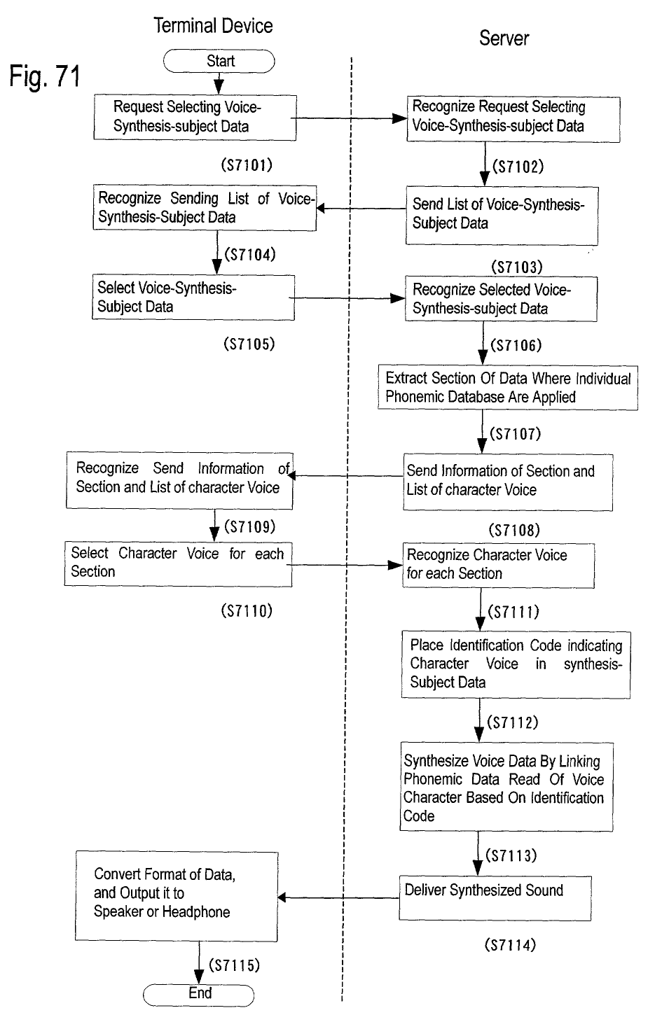

FIG. 71 is a flow chart showing operation of the reading system of this invention. When the user operates operation unit 7011 of main terminal device 6901 for accessing server 6904, terminal device communication processor 7013 completes the access to server 6904. The user sends a request for selection of voice synthesis subject data such as novel and the like (S7101). The request for selection sent from main terminal device 6901 is taken into server 6904 through server communication processor 7003, wherein server controller 7000 recognizes that it is a request of voice synthesis subject data from main terminal device 6901 (S7102).

Next, server controller 7000 produces a listing information of the synthesis subject data that are kept available for voice synthesis in the synthesis subject data memory, and sends the information to main terminal device 6901 that has originated the request (S7103). Terminal device controller 7007 of main terminal device 6901 recognizes it as the listing information sent from server 6904, and displays it in display unit 7012 (S7104). The user thus make his/her selection of a desired voice synthesis subject data using operation unit 7011 of main terminal device 6901 (S7105). Next, server controller 7000 recognizes the voice synthesis subject data selected by the user (S7106), reads data corresponding to it from synthesis subject data memory 7005, and registers it in server storage unit 7004. Phonemic database selector 7002 then analyzes the voice synthesis subject data while reading it from server storage unit 7004, and extracts sections of the data where individual phonemic database are applied (S7107). If the voice synthesis subject data is text data of a novel, for instance, phonemic database selector 7002 divides the data into such sections as speaking parts of characters, narrating parts, and the like, and forwards the result to server controller 7000. Server controller 7000 produces a listing information of voice characters stored in the phonemic database memory, and transfers the data to main terminal device 6901, along with a result received from phonemic database selector 7002 (S7108).

Terminal device controller 7007 recognizes information on the data sections received from server 6904 (S7109), and puts on display unit 7012 a message such as “select a voice character applied to each of the following sections: 1. voice of character A, 2. voice of character B, 3. voice of character C, 4. narration” and the like. At the same time, terminal device controller 7007 also displays the listing information of voice characters. The user select any of the voice characters to be allocated for the individual data sections using operation unit 7011 (S7110). On occasion, the user may select more than one character, so that different voice character is assigned for each of a plurality of the characters in the novel. Server controller 7000 then recognizes the voice character selected by the user as the one applied to each of the data sections (S7111), and passes on the result to phonemic database selector 7002.

Based upon this result, phonemic database selector 7002 places an identification code in a coexisting manner with each section of the voice synthesis subject data to which the phonemic database of the selected character is applied (S7112) so as to make the individual sections of the voice synthesis subject data distinguishable in respect to which voice character needs to be used when voice synthesizer 7001 applies the phonemic database to them. Phonemic database selector 7002 registers this result in server storage unit 7004. In short, the identification code is added to every section of the voice synthesis subject data in order to specify a voice character appropriate to it. Accordingly, during voice synthesis processing, voice synthesizer 7001 voice-synthesizes the voice synthesis subject data a phonemic database of the voice character appropriate to each section of the voice synthesis subject data. This enables voice synthesizer 7001 to implement voice synthesizing of a novel, for instance, using different voice character for speaking part of each character, to achieve more realistic reading.

In regard to the phonemic database selector, there are many ways of dividing the data into sections where individual phonemic databases are applied, such as speaking parts of the characters as discussed above, individual paragraphs, individual lines, and the like, and that the way of dividing the data is not restrictive since it depends on substance of the voice synthesis subject data.

Subsequently, server controller 7000 activates voice synthesizer 7001 to start the processing. Voice synthesizer 7001 reads one after another the data processed by phonemic database selector 7002 from server storage unit 7004, and selects phonemic database of the character to be used according to the identification code. At the same time, voice synthesizer 7001 also analyzes the voice synthesis subject data, reads the phonemic data most suitable for each of the subject data out of server storage unit 7004 or phonemic database memory 7006, and produces synthesized phonetic sound data by linking them together (S7113). Server controller 7000 delivers the synthesized phonetic sound data produced by voice synthesizer 7001 to the user via server communication processor 7003 (S7114). The synthesized phonetic sound data delivered from server 6904 is registered in terminal device storage unit 7010 within main terminal device 6901 or memory device 6902 through terminal device communication processor 7013. When the user activates a replay function through operation unit 7011, the synthesized phonetic sound data is read out of terminal device storage unit 7010 or memory device 6902, and passed on to voice output unit 7008. Voice output unit 7008 executes format conversion of the data, and outputs synthesized phonetic sound to a speaker or a headphone (S7115).

In this embodiment, although terminal device communication processor 7013 is disposed within main terminal device 6901, a communication processor may be incorporated into memory device 6902, and thereby the data can be downloaded from the server device on the network and stored in the memory device.

### Exemplary Embodiment 28

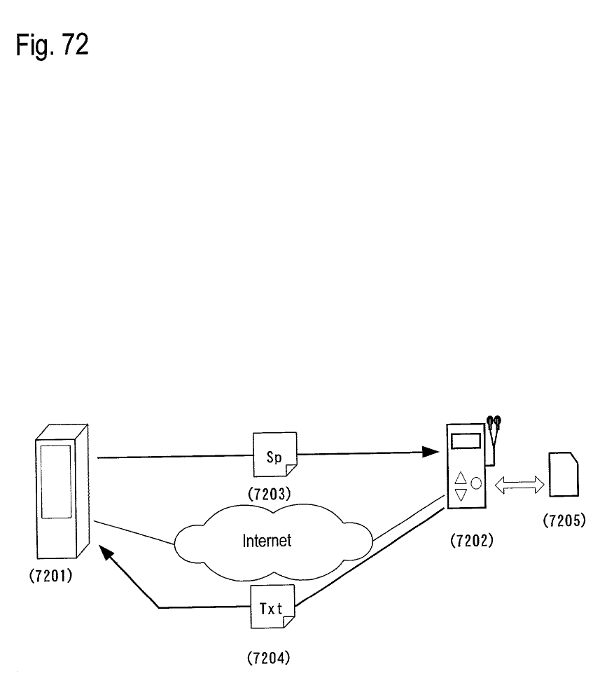

FIG. 72 is a configuration diagram showing a reading system of exemplary embodiment 28. Server 7201 on the Internet voice-synthesizes voice synthesis subject data with phonemic database of a voice character preferred by a user, and delivers synthesized phonetic sound data to the user. Main terminal device 7202 is provided with synthesized sound data entry unit, and voice output unit including an amplifier, a speaker, and the like.

The synthesized sound data entry unit here implies such devices as a network interface like a modem and the like, and an interface for memory device capable of entering data to a registering medium such as an optical disk, magnetic disk, memory card and the like. Synthesized phonetic sound data 7203 is delivered by server 7201. The user transmits voice synthesis subject data 7204 to server 7201.

At the start, the user transmits data containing a voice synthesis subject text to server 7201 through main terminal device 7202, and, at the same time, selects a voice character of his/her choice. Server 7201 voice-synthesizes the voice synthesis subject data transmitted by the user, using phonemic database of the voice character selected by the user, and returns synthesized phonetic sound data to the user by way of the Internet. The user takes the data into main terminal device 7202 and activates it for replay to produce output of synthesized phonetic sound of the text data transmitted by him/her in voice of his/her favorite character from main terminal device 7202.

Memory device 7205, which is detachable from main terminal device 7202, such as a memory card, optical disk, magnetic disk or the like stores the synthesized phonetic sound data and the like. In this embodiment, a request of the user for voice synthesis and receipt thereof may be made not only via the Internet but also through a telephone call, facsimile, mail, and/or by hand. In addition, delivery of the synthesized phonetic sound data from server 7201 to the user may be made by physically forwarding a storage medium such as an optical disk, magnetic disk, memory card, and the like having the registered synthesized phonetic sound data, beside the Internet.

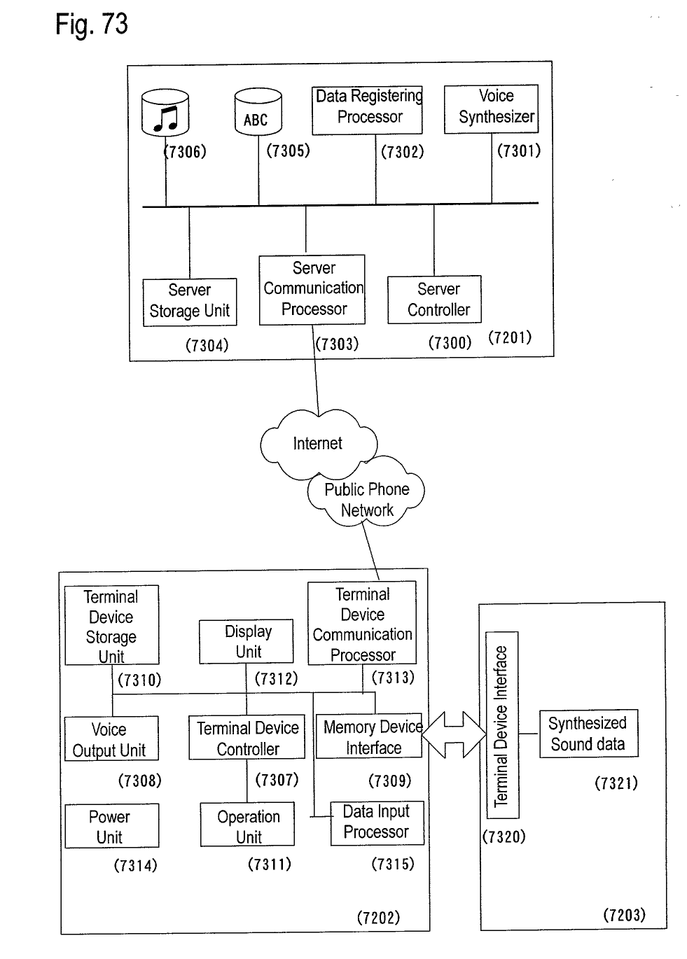

FIG. 73 is a block diagram of the reading system of this exemplary embodiment. In FIG. 73, the reading system is provided with server 7201, main terminal device 7202, and memory device 7203. Described first will pertain to individual blocks of server 7201.

In server 7201, server controller 7300 controls the entire server. Voice synthesizer 7301 analyzes the voice synthesis subject data, extracts the most suitable phoneme data for each of the data, and links them together. Data registering processor 7302 produces and controls data that correlates voice synthesis subject data sent by users with identity information of the user.

Server communication processor 7303 performs such tasks as transferring synthesized phonetic sound data to users, and interfacing with the users. Server storage unit 7304 stores a program for controlling the entire server, and it is also used as a work space for processing a variety of data. Synthesis subject data memory 7305 registers voice synthesis subject data. Phonemic database memory 7306 registers phonemic database of a variety of voice characters.

Described next pertains to individual blocks of main terminal device 7202. In main terminal device 7202, terminal device controller 7307 exchanges data with individual components within the device, to control the entire device. Voice output unit 7303 carries out format conversion of the synthesized phonetic sound data, and outputs it to a speaker or a headphone. Memory device interface 7309 defining one of the synthesized sound data entry unit writes/reads data in and out of the memory device. Terminal device storage unit 7310 is used to store a program of the entire device, and as a work space for processing a variety of tasks. A user gives his/her command to the device using operation unit 7311. Display unit 7312 displays an operating status and the like of the device for the user. Terminal device communication processor 7313 receives synthesized phonetic sound data transferred from the server, and interfaces between server 7201 and main terminal device 7202. Power unit 7314 supplies electric power to the device. Data entry processor 7315 is used by the user for entering voice synthesis subject data.

Terminal device interface 7320 exchanges data with main terminal device 7202 through memory device interface 7309. Synthesized sound data 7321 is stored within the memory device.

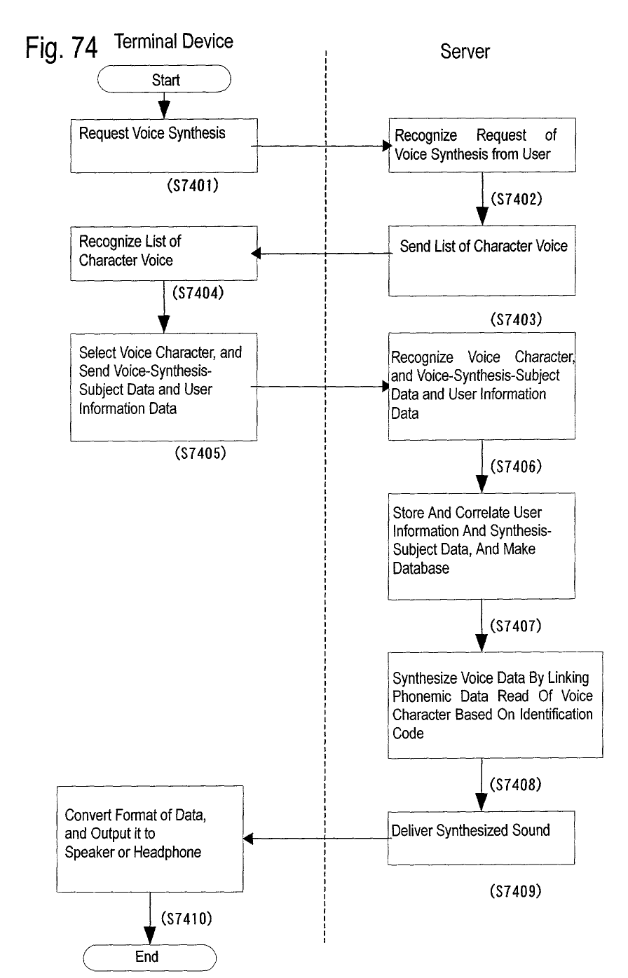

FIG. 74 is a flowchart of the reading system of this exemplary embodiment. When the user plays operation unit 7211 of main terminal device 7202 to attempt an access to server 7201, terminal device communication processor 7213 completes the access to server 7201. The user sends server 7201 a request for voice synthesis (S7401). The request sent from main terminal device 7202 is given to server 7201 through server communication processor 7303, wherein server controller 7300 recognizes that it is the request of voice synthesis by the user (S7402). Subsequently, server controller 7300 produces a listing information of voice characters stored in phonemic database memory 7306, and forwards the data to main terminal device 7202 (S7403).

Terminal device controller 7307 in main terminal device 7202 recognizes it as the listing information sent from server 7201, and displays it in display unit 7312 (S7404). The user thus makes his/her selection of a desired voice character using operation unit 7311 of main terminal device 7202. The user also uses data entry unit to input voice synthesis subject data into main terminal device 7202. In addition, the user enters his/her information such as name, address, telephone number, e-mail address, account number of a credit card, and the like using operation unit 7311. Terminal device controller 7307 sends these data to server 7201 (S7405). The user information required here are such data that can identify the user, and/or that are needed to collect payment from the user when server 7201 charges a fee for the services.

Next, server controller 7300 recognizes the voice character and voice synthesis subject data selected by the user as well as data of the user information (S7306), and it registers the synthesis subject data into synthesis subject data memory 7305 and the user information into server storage unit 7304. Data registering processor 7302 correlates both of the data, and registers them in server storage unit 7304 along with relevant data such as amount, name of the voice character and so on of the voice synthesis subject data received from the user. (S7407). Server 7201 then collects a payment from the user, if necessary, to cover the services rendered.

Subsequently, server controller 7300 reads data corresponding to that requested by the user from the synthesis subject data memory, registers it in server storage unit 7304, and activates the voice synthesizer to initiate the processing. Voice synthesizer 7301 analyzes the voice synthesis subject data while reading it one after another, reads phoneme data most suitable to each of the data from server storage unit 7304 or the phonemic database memory, and produces synthesized phonetic sound data by linking them together (S7408). Server controller 7300 delivers the synthesized phonetic sound data produced by voice synthesizer 7301 to the user by way of server communication processor 7303 (S7409).

The synthesized phonetic sound data delivered from server 7201 is registered in terminal device storage unit 7310 within the main terminal device or the memory device through terminal device communication processor 7313. When the user activates a replay function with operation unit 7311, the synthesized phonetic sound data is read out of terminal device memory unit 7310 or the memory device, and passed on to the voice output unit. Voice output unit 7308 executes format conversion of the data, and outputs synthesized phonetic sound to a speaker or a headphone (S7410).

What is claimed is:

1. An information terminal comprising:
a main terminal device comprising a voice synthesizer for voice-synthesizing voice-synthesis-subject data based on phonemic database having organized phoneme data; and
a memory device for storing said voice-synthesis-subject data and said phonemic database, said memory device being detachable from said main terminal device.

2. The information terminal as recited in claim 1, wherein said phonemic database includes sampled data of natural voice from a human.

3. The information terminal as recited in claim 1,
wherein said main terminal device further comprises:
a voice output processor for delivering an output of said voice synthesizer to a speaker after removing an undesired noise from said output;
an operation unit for a user to input a command; and
a communication processor for accessing a server device over a network,
wherein said phonemic database includes sampled data of natural voice taken from human,
wherein, if the user selects a kind of said phonemic database and said voice-synthesis-subject data through said operation unit, said communication processor transfers information on the selected kind of said phonemic database and said selected voice-synthesis-subject data to said server device, and
wherein said voice synthesizer synthesizes phonetic sound with said phonemic database and said voice-synthesis-subject data transferred from said server device via the network.

4. An information terminal comprising:
a voice synthesizer for synthesizing phonetic sound using voice-synthesis-subject data and phonemic data constructed of phoneme according to a voice-synthesizing program;
a storage unit for storing said voice-synthesizing program and said voice-synthesis-subject data;
a memory device interface for exchanging data between a memory device; and
a communication processor for accessing a network,
wherein said memory device comprises:
said phonemic database; and
a terminal device interface for exchanging data between said main terminal device of said information terminal.

5. The information terminal as recited in claim 4, wherein said communication processor is capable of downloading at least one of said voice-synthesizing program, said phonemic data, and said voice-synthesis-subject data from a server device on the network.

6. An information terminal comprising:
a voice synthesizer for synthesizing phonetic sound using voice-synthesis-subject data and phonemic data constructed of phoneme according to a voice-synthesizing program;
a storage unit for storing said voice-synthesizing program;
a memory device interface for exchanging data between a memory device; and
a communication processor for accessing a network,
wherein said memory device comprises:
said phonemic database;
a voice-synthesis-subject-data memory for storing said voice-synthesis-subject data; and
a terminal device interface for exchanging data between said information terminal.

7. An information terminal comprising:
a voice synthesizer for synthesizing phonetic sound using voice-synthesis-subject data and phonemic data constructed of phoneme data, according to a voice-synthesizing program;
a storage unit for storing said voice-synthesizing program and said phonemic data;
a memory device interface for exchanging data between a memory device; and
a communication processor for accessing a network,
wherein said memory device comprises:
a voice-synthesis-subject data memory for storing said voice-synthesis-subject data; and
a terminal device interface for exchanging data with said memory device interface.

8. An information terminal comprising:
a voice synthesizer for synthesizing phonetic sound using voice-synthesis-subject data and phonemic data constructed of phoneme data according to a voice-synthesizing program;
a storage unit for storing said voice-synthesizing program; and
a memory device interface for exchanging data between a memory device,
wherein said memory device comprises:
a phonemic database for storing said phonemic data;
a voice-synthesis-subject data memory for storing said voice-synthesis-subject data;
a terminal device interface for exchanging data between said memory device interface; and
a communication processor for accessing a network.

9. The information terminal as recited in claim 8, further comprising a memory controller for downloading said voice-synthesizing program, said phonemic data, and said voice-synthesis-subject data from a server device on said network through said communication processor, and for transferring said downloaded voice-synthesis-subject data, phonemic data, and voice-synthesizing program to said storage unit via said terminal device interface and said memory device interface.

10. An information terminal comprising:
a storage unit for storing a voice-synthesizing program;
a memory device interface for exchanging data between a memory device; and
a communication processor for accessing a network,
wherein said memory device comprises:
a voice synthesizer for synthesizing phonetic sound using voice-synthesis-subject data and phonemic data constructed of phoneme data according to said voice-synthesizing program, said voice-synthesizer storing said voice-synthesizing program; and
a terminal device interface for exchanging data between said memory device interface.

11. The information terminal as recited in claim 10, wherein said memory device further comprises at least one of a voice-synthesis-subject database for storing said voice-synthesis-subject data, and a phonemic database for storing said phoneme data.

12. The information terminal as recited in claim 1,
wherein one of said main terminal device and said memory device further comprises a voice-recording processor for a user to resister a character voice, and
wherein said voice synthesizer voice-synthesizes said voice-synthesis-subject data with said registered character voice.

13. The information terminal as recited in claim 1,
wherein one of said main terminal device and said memory device further comprises a translation processor for translating said voice-synthesis-subject data into language desired by a user, and
wherein said speech synthesizer voice-synthesis said translated voice-synthesis-subject data.

14. The information terminal as recited in claim 13,
wherein one of said main terminal device and said memory device further comprises a voice registering processor for the user to register character voice, and
wherein said voice synthesizer voice-synthesis said translated voice-synthesis-subject data with said registered character voice.

15. The information terminal as recited in claim 1,
wherein said main terminal device further comprises a communication processor for accessing a network, and for downloading only a part of said voice-synthesis-subject data desired by a user into one of said main terminal device and said memory device from a server device on said network, and said server device includes a download selector and storing said voice-synthesis-subject data.

16. The information terminal as recited in claim 1, wherein said voice-synthesis-subject data comprises text data.

17. The information terminal as recited in claim 1,
wherein said voice-synthesis-subject data comprises music data having musical score data and text data, and
wherein said voice synthesizer synthesize phonetic sound of said music data with predetermined character voice desired by a user when a user specifies said phonemic database and said music data.

18. The information terminal as recited in claim 1, wherein said voice synthesizer voice-synthesizes a certain character string in said voice-synthesis-subject data and outputs phonetic sound in other voice than voice of a character specified by a user.

19. The information terminal as recited in claim 1, wherein said voice-synthesizer voice-synthesize said voice-synthesis-subject data while inserting, in said voice-synthesis-subject data, a sound implying that phonetic sound being output is synthesized sound.

20. The information terminal as recited in claim 1,
wherein one of said main terminal device and said memory device further comprises a phonemic database selector for selecting said phonemic database, and
wherein said voice synthesizer voice-synthesize a portion of said voice-synthesis-subject data with character voice desired for the portion by a user.

21. The information terminal as recited in claim 20,
wherein one of said main terminal device and said memory device further comprises:
a voice registering processor for the user to register character voice;
a phonemic database selector for selecting said voice-synthesis-subject data and said phonemic database applied to said voice-synthesis-subject data; and
a storage unit for storing said voice-synthesis-subject data and an identification code for said selected phonemic database, and
wherein said voice synthesizer distinguishes phonemic database of voice character to be applied according to said identification code.

22. The information terminal as recited in claim 20,
wherein said voice-synthesis-subject data comprises music data having musical score and lyrics, and
wherein said voice synthesizer synthesize phonetic sound of said music data with voice of a predetermined character desired by the user when the user specifies said phonemic database and said music data.

23. The information terminal as recited in claim 1, wherein one of said main terminal device and said memory device further comprises a visual display processor for providing a visual display associated with said voice-synthesis-subject data.

25. The information terminal as recited in claim 1,
wherein said memory device inputs said voice-synthesis-subject data to said main terminal device, and
wherein said main terminal device further comprises at least one of a speaker and an earphone for producing phonetic sound synthesized by said voice synthesizer.

26. The information terminal as recited in claim 1, wherein said memory device comprises one of a memory card, an optical disk, and a magnetic disk.

27. A server device comprising:
a controller having a communication function with a network;
a voice synthesizer for extracting and linking phonemic data which is the most suitable to each of character data in voice-synthesis-subject data, and for delivering said phonemic data to a voice output processor in a terminal device;
a text data memory for storing said voice-synthesis-subject data; and
a phonemic database memory for storing a phonemic database constructed of sampled data of natural voice taken from real human,
wherein, when receiving information indicating a kind of phonemic database and said voice-synthesis-subject data from said terminal device, said voice synthesizer voice-synthesizes said voice-synthesis-subject data specified by the information with said phonemic database of the kind specified by the information, and
said controller transfers the voice-synthesized voice-synthesis-subject data to said terminal device over the network.

28. The server device as recited in claim 27, further comprising:
a musical-score-data memory for storing musical-score data; and
a music synthesizer for reading the musical-score data from said musical-score-data memory, for reading said voice-synthesis-subject data, for linking said musical-score data with synthesized sound as a pair, and for converting said linked musical-score data into a format reproducible by said terminal device.

29. The server device as recited in claim 27, further comprising a phonemic database selector for selecting said phonemic database,
wherein said voice synthesizer voice-synthesis a portion of said voice-synthesis-subject data with voice of character desired for the porton by a user,
wherein said controller transfers said voice-synthesized voice-synthesis-subject data to said terminal device over the network, and
wherein said terminal device receives said voice-synthesized voice-synthesis-subject data and reproduces it into audible sound.

30. The server device as recited in claim 27, further comprising a data registering processor for correlating said voice-synthesis-subject data with user identification information provided by the user,
wherein said voice synthesizer voice-synthesizes said provided voice-synthesis-subject data,
wherein said controller transfers said voice-synthesized voice-synthesis-subject data to said terminal device over the network; and
said terminal device receives said voice-synthesized voice-synthesis-subject data and reproduces it into audible sound.

31. A reading system comprising:
a server device on a network, comprising a voice synthesizer, voice-synthesis-subject data, and phonemic database; and
a terminal device comprising a voice output unit,
wherein, if a user selects said voice-synthesis-subject data through said terminal device, said voice synthesizer voice-synthesizes said selected voice-synthesis-subject data with specified phonemic database,
wherein said server device delivers said synthesized voice-synthesis-subject data to said terminal device over the network, and
wherein said terminal device reproduces said synthesized voice-synthesis-subject data into audible sound.

32. The reading system as recited in claim 31,
wherein said server device further comprises a voice registering processor for the user to register character voice, and
wherein said voice synthesizer voice-synthesizes said voice-synthesis-subject data with said registered character voice.

33. The reading system as recited in claim 31,
wherein said server device further comprises a translation processor for translating said voice-synthesis-subject data into language desired by the user, and
wherein the user selects a phonemic database and a kind of language through said terminal device, and
wherein said voice synthesizer voice-synthesizes said translated voice-synthesis-subject data with said selected phonemic database.

34. The reading system as recited in claim 33,
wherein said server device further comprises a voice registering processor for the user to register a character voice desired be the user, and
wherein said voice synthesizer voice-synthesizes said translated voice-synthesis-subject data with said character voice.

35. The reading system as recited in claim 31,
wherein said voice-synthesis-subject data comprises music data having text data and musical score data, and
wherein said voice synthesizer voice-synthesizes said music data with said phonemic database.

36. The reading system as recited in claim 31, wherein said voice synthesizer voice-synthesizes a certain character string in said voice-synthesis-subject data with other phonetic voice than character voice specified by the user.

37. The reading system as recited in claim 31, wherein said voice synthesizer voice-synthesizes said voice-synthesis-subject data and a sound implying that phonetic sound being output is synthesized sound, said voice synthesizer inserting said sound in said voice-synthesis-subject data.

38. The reading system as recited in claim 31, wherein said server device further comprises a download selector enabling a user to download a part of said voice-synthesis-subject data desired by the user into said terminal device.

39. An information terminal comprising:
a voice output processor for converting digital sound data into analog sound data, and for outputting said data to a speaker after removing an undesired noise from said data;
an operation unit for a user to input a command; and
a system controller for transferring, to a server device, a phonemic database and text data selected by the user through said operation unit, said phonemic database constructed of sampled data of natural voice taken from human,
wherein said server device voice-synthesizes said selected text data with said phonemic database specified by the user, and
wherein said voice output processor outputs said synthesized text data transferred from said server device over a network.
